(19) United States
(12) Patent Application Publication
(10) Pub. No.: US 2010/0042846 A1
(43) Pub. Date: Feb. 18, 2010

(54) TRUSTED CARD SYSTEM USING SECURE EXCHANGE

(76) Inventors: Douglas H. Trotter, Baltimore, MD (US); Ewan S. Macaulay, Suwanee, GA (US); Gregory W. Lloyd, Holland, PA (US); Michael D. Beck, Bethesda, MD (US)

Correspondence Address: Patent Docket Department;Armstrong Teasdale LLP, One Metropolitan Square, Suite 2600, St. Louis, MO, 63102-2740, US

(21) Appl. No.: 12/540,241

(22) Filed: Aug. 12, 2009

Related U.S. Application Data
(60) Provisional application No. 61/188,808, filed on Aug. 13, 2008.
(60) Provisional application No. 61/205,201, filed on Jan. 16, 2009.

(51) Int. Cl. H04L 9/32; G06F 15/16; G06F 21/20; G06F 17/00

(52) U.S. Cl. 713/182; 726/4; 709/203; 235/375

(57) ABSTRACT

A system for secure, role-based exchange of information between a client and providers of services is described. The system includes a client device having a memory that includes a portion of the data relating to the client, a user access component, and an enforcement agent. The system also includes a central server running an authentication methodology and a roles server. The central server includes the data relating to the client. The system further includes an interface device capable of communications with the central server and capable of communicative coupling with the client device. The system is operable to, upon a communicative coupling between the interface device and the client device, activate the user access method, in conjunction with the authentication method, to ensure that the client is the proper holder of the client device. The enforcement agent is operable with the roles server and user interface input from the client to define access rights to the client data for the providers of services, who also have access to the central server.

### CROSS-REFERENCE TO RELATED APPLICATIONS

This application claims the benefit of U.S. Provisional Patent Application Ser. No. 61/188,808, filed Aug. 13, 2008, and U.S. Provisional Patent Application Ser. No. 61/205,201, filed Jan. 16, 2009, both of which are hereby incorporated by reference in their entirety.

### BACKGROUND

This invention relates generally to information distribution including information protection and control and, more particularly, to secure transmission, exchange, and storage of data on a transportable media, authentication of users and transactions, and digital signing and tracking of transactions. As used herein, the term “transaction” refers to sharing of information and related work (e.g., database updating). Such sharing and related work may be viewed as a unit, which is sometimes referred to herein as a transaction.

Sharing information across multiple networks for use in many different contexts presents numerous challenges. For example, certain types of information cannot simply be uploaded or downloaded from one computer to another across a network. Rather, certain types of information may be stored on a disk (i.e., a transportable media) and physically carried from one computer to another. When information on the disk is updated, information stored on a network database or on numerous network databases also should be updated. Ensuring that all appropriate information is up-to-date across a network, particularly when transportable media is utilized, can be a significant challenge.

Also, in some contexts, laws or policies impose strict confidentiality and authentication obligations in connection with enabling sharing of such information. The confidentiality obligations can, for example, pertain to particular types or segments of information. For example, in the medical context, doctors and health care providers generally desire a reliable and secure approach for assembling comprehensive patient records from distributed sources. The sources may include multiple provider facilities, such as clinics and hospitals, each of which maintains their own patient database. Each facility database may change each time the provider is visited by a particular patient. Outright sharing of the data across a network, however, can be difficult due to the security obligations imposed by the Health Insurance Portability and Accountability Act (HIPPA).

Smartcards have been proposed for use in a medical context. One known smartcard based system includes a computer system for storing medical histories and a smartcard to store data. The smartcard is about the size of a credit card, and medical data about the individual can be downloaded, or added, to the smartcard. When the individual is examined by a physician all observations should be added, or downloaded, to the smartcard. Also, each time the patient visits a provider, the entire medical history of the individual can be retrieved from the smartcard. The smartcard makes it possible for an individual's medical history to be “read” by a computer, displayed on the computer's monitor, printed, or transmitted. This allows individuals to carry on their person a medical history of themselves.

Known smartcard technology, however, generally has limited memory storage which constrains the amount of data that can be stored on the smartcard. For example, the known smartcard does not have sufficient memory to store large records such as radiography image files. In addition, with such known smartcards, privacy is attempted to be maintained by encrypting a patient identifier. Once access to a file is granted to a user, the access to the information contained in file may be without limit. The user can, for example, modify the file, copy the file, display the file, print the file, e-mail the file, and/or transfer the file to another information system via a network. Also, after the file is distributed outside of the immediate control of the patient, security for the distributed file is left to the discretion of those who obtain a copy.

### BRIEF DESCRIPTION

In one aspect, a system for secure, role-based exchange of information between a client and at least one provider of services to the client is provided. The system includes a client device comprising a memory, the memory including data relating to the client, at least a portion of the data controlled by the client, a user access component, a queuing application, a routing application, and an enforcement agent stored therein, a central server comprising an authentication method, a queuing application, a routing application, and a roles server running thereon, the central server including the data relating to the client, and an interface device capable of communications with the central server and capable of communicative coupling with the client device. The system is operable to, upon a communicative coupling between the interface device and the client device, activate the user access component, in conjunction with the authentication method, to ensure that the client is the proper holder of the client device, and the enforcement agent is operable with the roles server and user interface input from the client to define and maintain access rights to the data relating to the client for the at least one provider of services to the client, the provider of services to the client having access to the central server, the provider of services able to update the memory of the client device, and the data at the central server, based on the access rights defined by the client and contained within the enforcement agent.

In another aspect, a method for providing controlled access by various providers of services to data related to a client, a portion of the data maintained within a client device, another portion of the data maintained at a central server, the providers of services and the client device communicatively coupled to the central server that includes an authentication method and a roles server running thereon is provided. The method includes authenticating that the holder of the client device is the client using a user access method stored within the client device in conjunction with the authentication method running at the central server, providing a level of access to the data by the client, the level of access based on a role defined for the client within the roles server, the level of access enforced by an enforcement agent running on the client device, and providing a level of access to the data for the various providers, the level of access for each provider based on a role defined for each provider within the roles server, the level of access for each provider enforced by an enforcement agent running on the client device, the client capable of defining, within the enforcement agent, at least a portion of the level of access to the data for at least one of the providers.

In still another aspect, a method for securing communications between a portable memory device and a server is provided. The method includes starting a client application when the portable memory device is connected to an interface capable of capable of communications with a server, establishing a secure channel between the client application and the server, authenticating a user of the portable memory device, and using the sessionID and sequence number in transactions between the portable memory device and the server. Authenticating a user of the portable memory device is accomplished by encrypting, at the server, a sessionID and sequence number using a public key associated with the portable memory device, encrypting, the encrypted sessionID and sequence number using a private key associated with the server to form an authentication transaction, sending, the sessionID and sequence number, encrypted with both the public key and the private key to the client application, decrypting, with the client application, the authentication transaction with a public key associated with the server, and decrypting, with the client application, the sessionID and sequence number using a private key associated with the portable memory device.

In yet another aspect, a portable device for secure storage of personal records is provided. The portable device includes a physical interface for communicative coupling to an external device, and a memory accessible via the physical interface. The memory includes a data section operable for storage of the personal records, a user access component operable to provide an interface to records stored in the data section via the external device, and a security component. The security component is activated upon communicative coupling of the physical interface to an external device, and is operable with a roles server running external to the portable device to provide restricted access to portions of the personal records to a plurality of authorized users. The accessible portions for such authorized users is based on roles for the authorized users as defined within the user access component by a person to whom the portable device has been allocated.

In another aspect, a method for maintaining personal record data on a portable memory device, the device allocated to a first user, the personal record data relating to the first user is provided. The method includes authenticating the first user, authenticating that a second user has access to the personal record data, granting access to the second user, upon authentication, to an application operable to provide a user interface for accessing the personal record data, allocating a role to the second user, the second user role defined by the first user, and providing access and update privileges to the second user, to at least a portion of the personal record data relating to the first user, the privileges restricted based on the role allocated to the second user, the restricted privileges and allocated role enforced by an enforcement agent application resident on the portable memory device.

The features, functions, and advantages that have been discussed can be achieved independently in various embodiments as described herein or may be combined in yet other embodiments further details of which can be seen with reference to the following description and drawings.

### BRIEF DESCRIPTION OF THE DRAWINGS

FIG. 1 is a front view of a trusted card according to one embodiment.

FIG. 2A is a front view of another embodiment of a trusted card operable with a secure exchange system.

FIG. 2B is a back view of the trusted card of FIG. 2A, showing a USB connector embedded therein.

FIG. 2C is another front view of the trusted card of FIG. 2A with the USB connector extended from the trusted card.

FIG. 3 is a diagram illustrating a data hierarchy for the memory associated with the trusted card of FIGS. 1, 2A, 2B, and 2C.

FIG. 4 is a flow chart example illustrating the hierarchical security levels associated with different provider roles related to the memory within the trusted card.

FIG. 5 is a workflow chart illustrating an example admission sequence for a patient based on operation of the trusted card in conjunction with a secure exchange system.

FIG. 6 is a diagram that illustrates the distributed information protection and control system according to one embodiment of the trusted card/secure exchange system.

FIG. 7 is an exemplary policy data table.

FIG. 8 is a representation a trusted card/secure exchange solution with several possible components represented.

FIG. 9 is a flowchart illustrating the processes associated with the trusted card/secure exchange system.

FIG. 10 is a diagram that provides an architectural solution for the trusted card/secure exchange system.

FIG. 10A is a system partitioning diagram that depicts the above described applications within the architectural solution of FIG. 10 as components and further depicts their relationship to one another.

FIG. 11 is a diagram of the security architecture associated with the trusted card/secure exchange system.

FIG. 11A is a diagram depicting a communications channel security process that establishes a secure communications channel between a trusted card and the SES platform.

FIG. 11B is an illustration of transactions sent between the card and server once a secure channel is established and authentication has been completed.

FIG. 12 is a logical depiction of a Trusted Card data storage and access mechanism.

FIG. 12A illustrates storage of data with encrypted metadata in order to identify different records.

FIG. 12B is a diagram illustrating one embodiment of a trusted card logical data model which shows the relationships between the various logical data sources contained on the trusted card.

FIG. 12C depicts the relationships between the various SES data elements that are used for authentication and authorization and is referred to as a SES security database logical data model.

FIG. 13 is an exploded diagram showing the layers of an exemplary image transfer.

FIG. 14 is a block diagram of all necessary process steps for making and applying the above-described transfer

FIG. 15 is a diagram of the components of one embodiment of digital printer.

FIG. 16 illustrates a secure file for a distributed information protection and control system.

FIG. 17 illustrates a manifest record.

FIG. 18 illustrates a typical payload.

FIG. 19 illustrates a security directive.

FIG. 20 illustrates an identity and its relationship to a user and a security directive.

FIG. 21 illustrates a flowchart for creating a secure file in relation to distributed information protection and control system.

FIG. 22 illustrates a flow chart for accessing a secure file in relation to the distributed information protection and control system.

FIG. 23 illustrates an exemplary user interface for the display of the distributed information protection and control system.

### DETAILED DESCRIPTION

In one aspect, a secure exchange and trusted card system is described. Such system includes software implemented methods and a system architecture that facilitates allowing individuals to carry voluminous confidential records in his or her pocket. Such system also facilitates allowing others to have access, at a remote location, to a full set of records via computer, in accordance with a hierarchical permissions policy and allocated roles.

The system is sometimes herein described in the context of a trusted medical record system to enable patients to carry their medical records within a device that is generally shaped like a business card. The medical records context should only be considered as one of many examples of a context in which the system and its components can be utilized. The secure exchange and trusted card system can also be utilized in other applications, such as financial services cards, identity cards, and other portable record storage device applications.

In a medical context, the system enables the transport of critical and confidential information across multiple non-related enterprises. For example, in accordance with one embodiment, medical and other providers employ a patient-carried data card with large-capacity record storage. A client/server network with card-reader capabilities and software maintains a robust security framework for facilitating confidentiality by allowing others to have access to the patient's selective records via computer, in accordance with a hierarchical permissions policy.

The embodiments described herein relate to a secure exchange system that provides a balance between security and versatility. The secure exchange system also allows an individual to carry a data card which facilitates instant access to confidential records, while facilitating avoidance of tampering and invasion of privacy. A card is provided that allows for unique identifiers and/or other identification to match the card to the owner, either manually or electronically, or both. The card, when matched with a similar device, allows for a secure transaction, either locally or over a remote session. In one embodiment, software is included on the card or other device that facilitates the securing of data, locally to the device, and/or to a remote destination. Utilization of the trusted card further provides for a secure exchange of data with third parties, and further provides for the promulgation of roles based on credentials assigned by the holder of the trusted card. Trusted relationships also can be established between parties based on the authentication process associated with the trusted card and secure exchange service. The establishment of the trusted relationship also allows for secure transacting with a third party.

The central management of functions is provided within the described embodiments, including, but not limited to roles, authentication, switching and queuing. Such management ensures that activity, for example, accessing of content, is digitally signed to provide proof of access and any changes made to the data.

More specifically, and in one embodiment, the trusted card and secure exchange system provide a surface to which information and graphics can be written, using one or more of graphic printers, adhesive materials and pens. The system ensures easy access to data of any type such as sound files, images, text files, executable files and transaction records that may be stored on the trusted card using public and/or private key authentication. Each access event to these files is associated with a digital signature. Further, the secure exchange system facilitates secure transmission of any data using one or more of keys, sound files, images, text files, executable files and transaction records, to an intermediately, or end destination.

One aspect of the secure transmission and secure access to the data on the trusted card is based on the roles assigned to the users. Specifically, roles are retrieved based on the credentials provided by the authentication process to determine authorization for various access privileges, for example viewing, editing, printing, e-mailing, securing and transmitting of files. In some instances, two or more of the trusted cards, representing different parties to the transaction, are present to enable certain transactions. In at least one embodiment, by the pairing of two or more unique cards, trusted transactions can be initiated with external services, including, but not limited to, secure storage sites, mediation services, video conferencing facilities, authentication services and transaction processing services. In other embodiments, by providing the appropriate authentication with a single card, transactions via the secure exchange system can be initiated with external services, including but not limited to, secure storage sites, mediation services, video conferencing facilities, authentication services and data vaults.

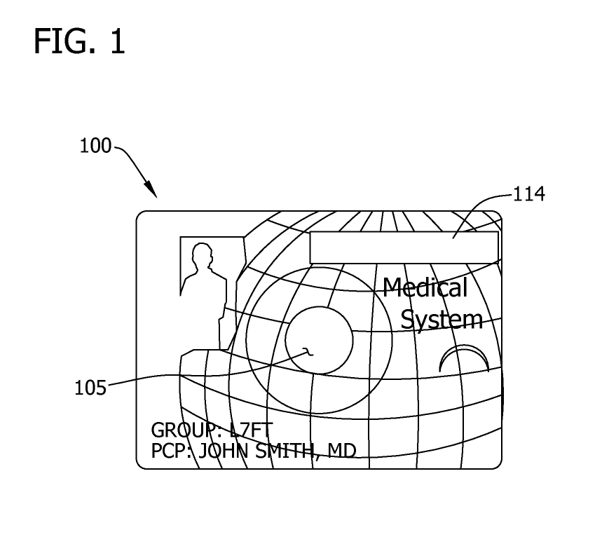

FIG. 1 is a front view and back view, respectively, of the data card 100, which is sometimes referred to herein as a trusted card. In the illustrated embodiment, card 100 is substantially the same size as a standard credit card or identification card and may be carried in a standard wallet. Data card 100 includes a 30-50 Mbyte wallet-sized CDRom and may also include one or both of a magnetic strip or a bar code thereon. The data card 100 is a business-card size rectangular optical disk including a front section (FIG. 1) bearing promotional information, and rear section (not shown) bearing the functional features of the optical disk. The disk is formed from plastic with optical data-recording tracks formed by encased perforated gold foil as is typical of optical discs, the perforations being optically readable from the back. An aperture 105 is provided for a reader spindle.

Data card 100 is flexible and is capable of bearing a magnetic strip 114 or bar code. The magnetic strip 114 contains magnetically encoded patient ID information that can be read by “swiped” current credit card or debit card verification readers at any location and transmitted to a server for authentication. The optically readable portion contains up to 50 Mb of digital information encrypted per permission-based content control software (to be described). In addition to the magnetic strip 114, the card 100 may include a paper strip or a specially coated strip (not shown) like a regular credit card to allow for a patient to sign.

As an addition or alternative to the magnetic strip 114, the disk 100 may be provided with a two- or three-dimensional barcode (not shown) containing the same information. In this case, a two- or three-dimensional barcode can be applied by an image transfer printed by modified large-format digital printer. In one embodiment, the transfer is applied by a selective release transfer process as set forth in U.S. patent application Ser. No. 11/879,744 entitled DIGITAL TRANSFER METHOD FOR PRINTING ON A TARGET SURFACE.

Most general purpose computers and similar devices contain an optical data disk reader (Compact Disk—CD or Digital Versatile Disk—DVD) and/or USB port, and can thereby read and write information to/from a removable optical disk or USB token card. The removable optical disks or USB tokens can be written, read, re-written or erased many times. Business-card shaped CD's or USB tokens are relatively new but commonplace.

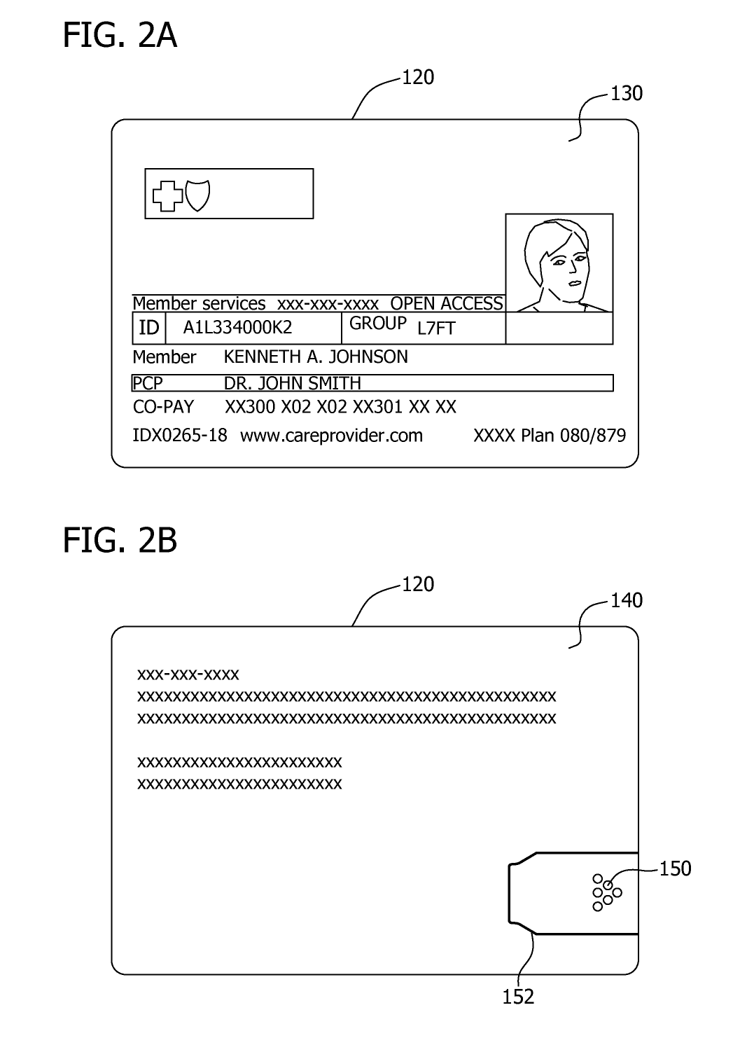

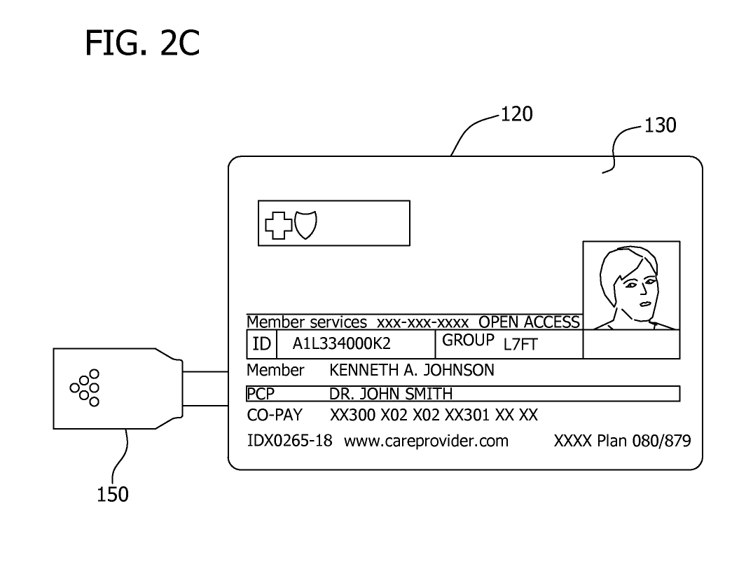

FIGS. 2A, 2B, and 2C are, respectively, a front view, a rear view, and a USB connector extended view of a trusted data card 120, which is substantially the same size as a standard credit card, business card, or identification card. Though the description herein utilizes card 120 as an example, it should be noted that any device capable of communicating with a computer and containing memory sufficient to hold the data desired could be utilized, including, but not limited to, cell phones, PDAs, optical storage devices, and other portable devices that contain such memory.

FIG. 2A illustrates the front side 130 of the card 120 which in various embodiments includes one or more of a graphic representation of an image of the holder, participant, and corporate image identification or logo. The front side 130 may also include descriptive information of holder, participant, company, for example, a name, a surname, a date of birth, a gender, a social security number, an enrollment identification number, contact information and marital status. In addition, the front side 130 may include the rendering of a two dimensional or a three dimensional bar code or any other representation of identification that can be read or recognized by any form of reading or recognition device. Other information or graphics that may be used to identify the card to an individual or company or any other party may be included on the front side of the card 120 as space permits.

FIG. 2B illustrates the back side 140 of the card which may include any of the information described in the preceding paragraph, in addition to any additional information that the card supplier wants printed on the card, including but not limited to, instructions, graphics, controls and advertising collateral. The USB connector 150 housed in an alcove 152 formed in the card 120 which is fabricated to store the connector 150 flush with the overall structure of the card 120.

FIG. 2C is an illustration of the front side 130 of card 120 with the USB connector 150 extended therefrom. Referring generally to trusted card 120, data is stored in memory embedded in the card and is accessible via the USB connector 150. The USB connector 150 is stored simply by sliding the connector 150 into the alcove 152 in the card 120. The USB connector 150 slides flush with the casing defined by alcove 152 to maintain a traditional card form factor. When the contents of the memory within the card 120 are to be accessed or updated, the USB connector 150 is pulled out and can be subsequently plugged into any conventional computer USB port. In one embodiment, the USB connector 150 provides access to an embedded flex-film PC card with on-board memory of various sizes thereon. Through the described embodiments, trusted card 120 includes a capability to store data in a resident memory that is embedded within card 120.

As with card 100 described above, card 120 may also include a substantially flat front side and at least a portion of a substantially flat rear side that accommodates multiple forms of rendering thereon, which is described above. The images that may be placed on the card 130 may include, but are not limited to, one or more two dimensional bar codes, one or more three dimensional bar codes, personal information, one or more photographs, either in color or black and white, one or more signature blocks, printed instructions, and logos.

All data written to the trusted card 120 and its supporting secure exchange system is encrypted and digitally signed, and the retrieval thereof, as described above, is managed via authentication of users and permission based roles that are implemented by the card interacting with a remote authentication and roles server. The secure exchange system includes services rendered from a central location which in various embodiments includes, but is not limited to an enforcement agent that enforces the security policy look-up table in accordance with the identity of each user that attempts to access the record data, a routing agent that allows for the routing of information to designated endpoints, and an authentication methodology, that provides for password, challenge-response, and/or bio-metric authentication of an individual based on data entered into the system in association with trusted card 120.

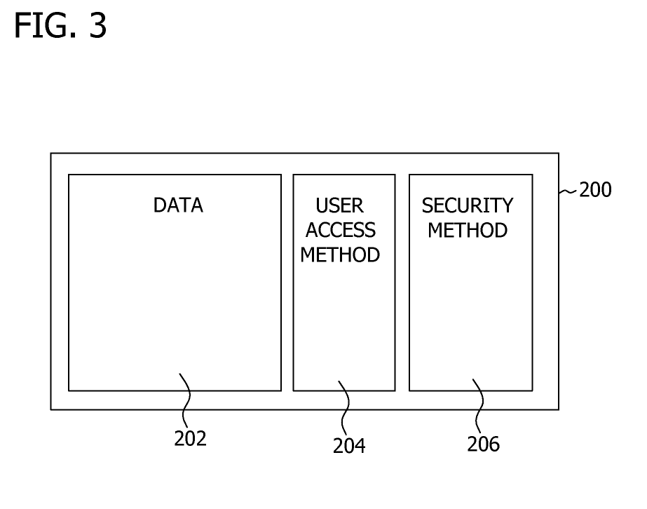

FIG. 3 is a view of the logical structure of security, management and data that may be stored within a memory 200 of the trusted card 120. FIG. 3 is but one embodiment of the components that could be constructed and represented on card 120, however, any particular embodiment may include the addition or removal of certain memory components.

Data section 202 represents data that is stored on the card 120. This data can represent anything that can be stored electronically in any format. The data can be stored in any format within a database, or a file structure or any other manner of organizing of the data. The following description describes one embodiment of the data storage capability and should not be construed to be limiting. For example, access to the data can be controlled by way of rules, roles, and access rights, amongst others that can be initiated by way of physical or logical security and authentication. The data can be encrypted or left in an original format. The data can be compressed using multiple variations of compression algorithms. The data can be set up to be viewed in a generic form or structure, or via an application or viewer. The data can be digitally signed and certified.

A user access component 204 of the memory 200 represents the application component that provides a user or application an interface to the data or logic stored within the card 120. Depending on the application of the card 120, the data or any other logic stored on the card or remote environment as part of the secure exchange, or external to the secure exchange as further described herein, is accessed. However, the access to this area will be achieved in the following manner, in one embodiment. For example, access may be achieved through a web site, a thin client, an application, any editor or file viewer resident on the card 120 giving access to the data or logic. Access may also be achieved through a web site, a thin client, an application, any editor or file viewer resident on any other device which can provide access to the data or logic. Access may also be achieved by using any application to execute any specific logic stored on the card 120. This methodology can be built up in any language including, Java, C++, any tool in the Visual Studio pack, or any other language. A web site, a thin client, an application, any editor or file viewer resident within a secure exchange server, described below, may also provide access to the data stored within the card 120.

Security method 206 represents the security component or enforcement agent of the trusted card 120. The security component of the card 120 controls the overall behavior of the device under any condition. More specifically, the security component of the card 120 is activated once the card is activated and accessed by placing the USB connector 150 in the USB port of a computer. The security component, which may also be referred to herein as an enforcement agent has the following non-limiting functions. Specifically, the security component acts as an authentication agent, to ensure that the user(s) are who they say they are, identify the data that describes any person, application, logic, or any other means by which an attempt could be made to access the data stored within the card 120 outside of the roles allocated by the card holder as further explained herein. The data stored within the card 120 includes any information, byte, anatomical particle, graphical file, compressed file or any other data stored on the device that is requested by someone attempting to access the data 202 maintained on the card 120.

More specifically, the security component 206 determines access rights to “What data” by “Who (as identified by other data)” and allows or blocks, the rights associated to any access to any content or application on the device. These rights can include, but are not limited to the open, save, update, edit, create, delete, rename, move, add, append, concatenate, comment, compile and/or browse functions of anything on the card. The security component interacts with a roles server to provide authentication, and any other service or server required to enforce any role or restriction of access that has been defined. The security component also serves to provide the encryption of the information stored on the card 120 and digitally certify any activity associated with the trusted card.

Keeping with the medical records example used throughout this document, the patient's partial medical records are stored on the card 120, and depending upon user preference, some or all of the patient's complete record is remotely stored on a central server. In some instances the user may elect to only store data on their trusted card. However, for archiving, backup, or other reasons, the card holder may elect to store some or all of their records at the server. The portion of the patient's medical records is limited only by the amount of memory on the card 120 and by the decisions made by the patient. When the patient presents his or her trusted card 120, the provider's office verifies the patient against a photograph of the card holder printed on the card 120, swipes the card to authenticate the user (and preferably verifies the patient's signature), and then inserts the card in an ordinary desktop computer containing a USB port. The desktop computer then asks for a password, and the user (patient) will furnish their password. The desktop computer then asks for a password associated with another user (nurse, physician, resident, or other user) who also provides their password, initiating the role allocation process described throughout this document.

When a password is entered into the desktop computer, in certain embodiments twice for confirmation, the desktop computer sends an electronic “key” to a secure server. If the password has been recorded on the server, the key will be recognized and the secure server will respond by sending another, matching electronic key back to the desktop. When the exchange of matching keys is completed, the user will receive information that is decrypted at the individual user's permitted level of access. The verification process is completed in a matter of a few seconds. It should be apparent that the card 120 offers multiple security measures: 1) passwords assigned locally according to local policy that must be known to gain access; 2) central server-based security where the password must be recognized according to pre-determined rules; 3) a photograph and/or a signature block for visual authentication. In one alternative embodiment, the trusted card may also include a magnetic strip imprinted with a unique identity key to provide an additional level of security.

Information is “locked” at some levels of access and is open at others, based on the user's classification and assigned user-rights. As described by further example below, some users are allowed to read only parts of a record. Some users will be allowed to read all parts of a record. Some users are allowed to make changes to a file. Some are allowed to print and disseminate information. Newly entered information is encrypted and recorded to the trusted card 120 on the spot and may also be sent to a server for permanent storage. When a user reads, changes, or adds to a record, the transaction is recorded and it becomes part of an electronic audit trail on the permanent record. Thus, if a user gives his or her password to an unauthorized party, that person's entry to the system will be recorded and monitored.

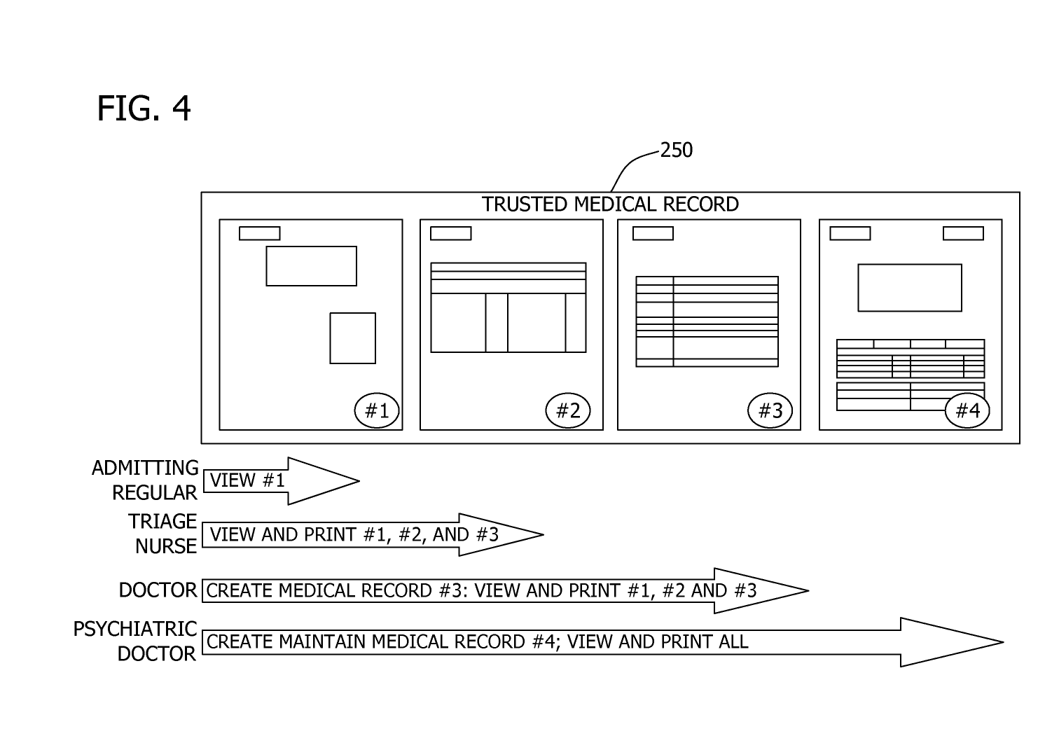

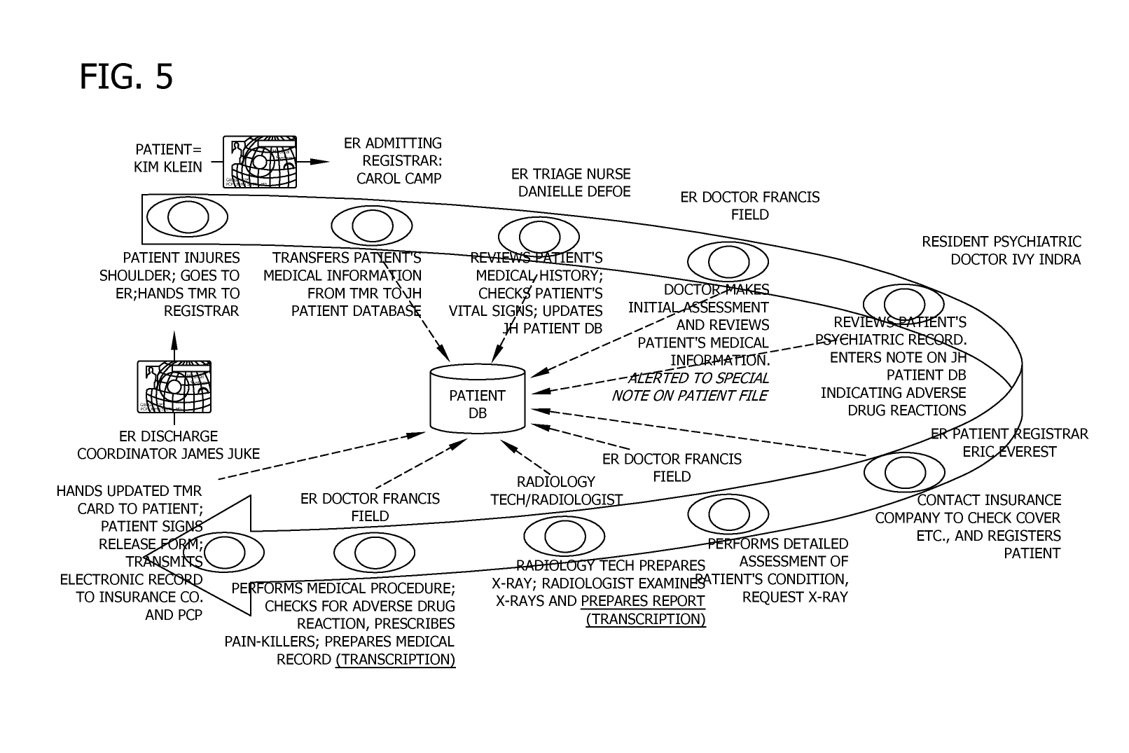

FIG. 4 is a flow chart 250 example illustrating the hierarchical security levels of the present disclosure. FIG. 5 is a workflow chart illustrating an example admission sequence for a patient using the trusted card 120. An example admission sequence will now be described with combined reference to FIGS. 4 and 5. In this example there are four different users: Admitting Registrar, Triage Nurse, Doctor, and Psychiatrist.

Each of these users is permitted different levels of access to the information. Some may be allowed to read only parts of a record, some will be allowed to read everything, some users will be allowed to make changes, and some will be allowed to print and disseminate information. Specifically, the Admitting Registrar has access rights to basic patient information such as contact and insurance information. They are permitted to view data only to this extent as seen at #1. The Triage Nurse has access to basic patient information, admission history, and standard medical records as seen at #2, and has authority to view and print any of these records. The Doctor has access to basic patient information, admission history, and standard as well as restricted psychiatric medical records as seen at #3, and is free to edit, view and print any of the foregoing as shown at #3. Finally, the Psychiatrist only has access to the restricted psychiatric medical records as seen at #4, but can view and print these.

As seen in FIG. 5, patient Kim Klien goes to the emergency room with shoulder injuries. Her first stop is the Admitting Registrar, where Ms. Klien hands her data card 120 to the Registrar. The Registrar verifies the trusted card 120 by checking the signature, verifying a photograph on card 120, swiping the magnetic stripe, and inserting the USB connector 150 into a computer USB port. The Registrar then enters her own password, confirms it, and transfers either the patient's records that are stored on the card 120 and/or the patient's complete medical records from a central server to the on-site provider database. In one embodiment, Kim Klien has to first enter her password prior to password entry by any of the providers. The workflow proceeds to the Triage Nurse, Danielle DeFoe, where Ms. Klien hands her data card 120 to the Triage Nurse. The Triage Nurse again verifies the datacard by checking the signature, swiping the magnetic stripe, and inserting the USB connector 150 into a computer USB port. The Triage Nurse then enters her own password, confirms it, and proceeds to review the patient's Medical History. The Triage Nurse can access to basic patient information, admission history, and standard medical records, and has authority to view and print any of these records.

The Triage Nurse completes her customary duties which include checking the patient's vital signs. This information is keyed into the computer where it updates the provider database and is immediately written to the data card 120. Ms. Klien next visits the ER Doctor Francis Field, who verifies the data card 120 by checking the signature, swiping the magnetic stripe, and inserting the USB connector 150 into a computer USB port. Dr. Field then enters his own password, confirms it, and makes an initial assessment and reviews the patient's medical information. Dr. Field has access to basic patient information, admission history, and standard as well as restricted psychiatric medical records, and is free to edit, view and print any of the foregoing. He is alerted to a special note on the patient's file. Ms. Klien next visits the Psychiatrist Doctor Indra Ivy, who verifies the trusted card 120 by checking the signature, swiping the magnetic stripe, and inserting the USB connector 150 into a computer USB port. Dr. Ivy then enters his own password, confirms it, and makes an initial assessment and reviews the patient's medical information. Dr. Ivy has access to the restricted psychiatric medical records and can view and print these, but not the other records. He enters a new note on the patient's file regarding adverse drug reactions. The workflow continues in this manner through to discharge, from station to station, with each attendant having only the information authority needed to complete their job properly. All along the workflow path an audit trail is being laid revealing who had what access to what data, and when. It should be noted that in one embodiment, the card holder (Kim Klien in this example) has to enter her password before each provider initiates their authentication process.

Thousands of combinations of access policies can be set for the various users as a result of the hierarchical security software described herein. Additionally, the encryption process allows records to be time limited. Records can be programmed to expire or to become locked after the passage of time. Users can be required to log on to the system for updates, thereby lessening the likelihood that a holder of a trusted card or one that has access to the records on a holder's card will mistakenly rely on out of date information.

The details of both the hardware and software will now be described.

Hardware Architecture

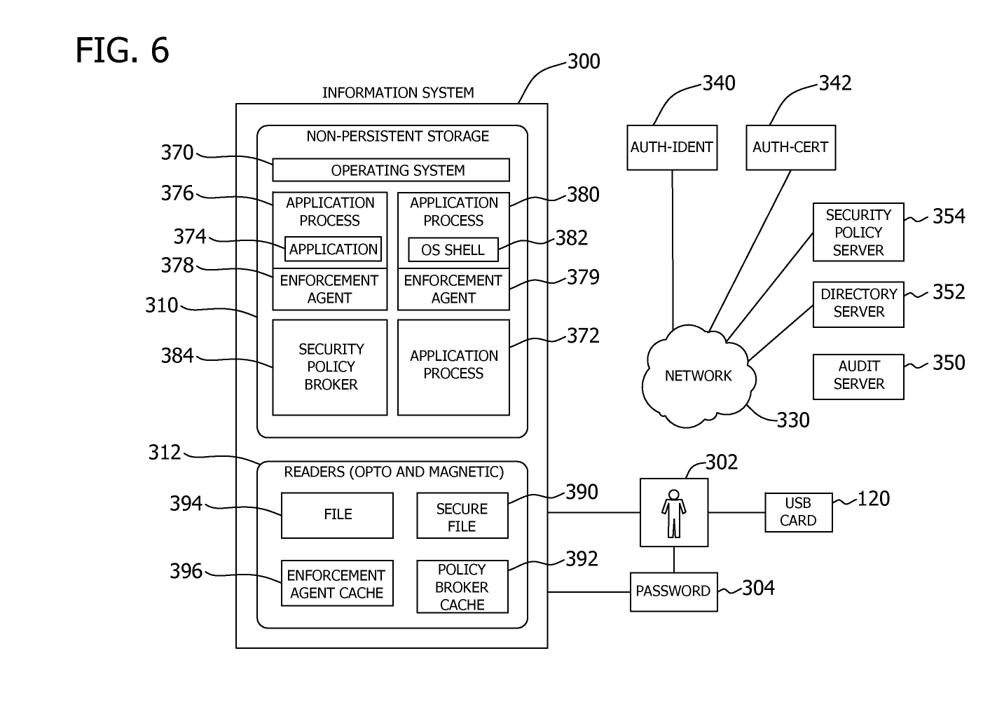

FIG. 6 illustrates one embodiment of a distributed information protection and control system according to the present disclosure. The information protection system includes an information system 300 accessible by a user 302 using a trusted card 120 along with theft password 304 according to one embodiment. The information system 300 may be embodied using any computer apparatus that accepts data, processes the data in accordance with one or more stored software programs, generates results, and typically includes input, output, storage, arithmetic, logic, and control units, inclusive of a desktop computer, notebook computer, supercomputer, mainframe, mini-computer, workstation, server or the like.

The information system 300 includes a number of standard computer components, including: non-persistent storage 310 and data readers 312 (for example a computer USB port plus a magnetic stripe reader). The readers 312 retrieve persistent data storage from the data card 120 to the information system 300. The non-persistent storage 310 comprises one or more storage devices used for volatile data storage accessible by the information system 300. Examples of the non-persistent storage 310 include: random access memory (RAM), non-volatile random access memory (NVRAM), and read-only memory (ROM).

The information system 300 also includes, in one embodiment, one or more information processors (e.g., central processing units, CPU), keyboard, mouse, display and printer, and other standard computer peripherals as desired.

The information system 300 is connected to a network 330 via a communications link. The network 330 comprises a number of computers and associated devices that are connected by communication facilities. The network 330 can involve permanent connections (e.g., cables) or temporary connections (e.g., those made through telephone or other communication links). Examples of a network include: a local area network (LAN); a wide area network (WAN); a satellite link; and a combination of networks, such as an internet and an intranet. The communications link can be established using any combination of well-known communications protocols, for example: X.25, ATM, SSH, SSL, HTTP, SMTP, NetBIOS, and/or TCP/IP.

In accordance with the described embodiments, the network 330 is coupled to an authentication identification system 340, an authentication certification system 342, an audit server 350, a directory service 352, and a policy server 354.

The authentication identification system 340 comprises a system to authenticate the identity of the user 302 and patient to whom the data card 120 was issued. For the user 302, the authentication identification system 340 can be an authentication service-type device capable of one or more types of challenge-response authentication protocols. Examples of challenge-response authentication protocols include: username/password authentication, secret-question/secret-answer type authentication, or any other authentication techniques to verify the identity of user 302. Alternatively, the user 302 may identify themselves by a smartcard, a biometric reader (e.g., fingerprint reader or palm analyzer), or other authentication devices. Any number of conventional authentication devices using any combination of authentication protocols may be used to augment or replace conventional username-password type authentication, as may be provided as part of the capabilities of the information system 300. For the patient, the authentication identification system 340 verifies the identity of the patient as read from the magnetic stripe (or barcode) on data card 120.

The authentication certification system 342 comprises a system to generate, certify, and/or distribute cryptographic information, including cryptographic keys, to perform authentication, signing and/or other cryptological tasks to authenticate the identity of the user 302. Conventional public key cryptosystems are known and have associated cryptographic keys that can be used to encipher and decipher information. One or more cryptographic keys can also be used to authenticate the identity of the user 302.

The audit server 350 comprises a separate information system or storage device or devices accessible via the network 330. The audit server 350 can be used for the collection, storage and analysis of auditing information obtained from one or more information systems, including any of the following exemplary systems: authentication identification 340, authentication certification 342, audit server 350, directory service 352, and policy server 354. Within the prior-art, the audit server 350 may also be referred to as a data logger or a system log.

The directory service 352 comprises a system to share public and semi-public identity information regarding user 302, as well as other known users, with those having access to network 330. Examples of the directory service 352 include: an http server, a lightweight directory access protocol (LDAP) service, a relational database management system, and a Microsoft Exchange Server. The directory service 352 can provide user-specific information, for example: personal information of the user 302, such as name, addresses, telephone numbers, and email addresses and cryptographic keys used by the user.

Referring back to the non-persistent storage 330, this may include an operating system 370, and any number of concurrently running application processes including application process 372, for example, a word processor such as Microsoft Word. The operating system may be a conventional operating system such as Microsoft Windows™ or Linux™, alone or in combination with a virtual operating system/virtual machine. A virtual operating system can host other operating systems. Similarly, a virtual machine is a programming language interpreter (such as Java Virtual Machine™ or Python™. These allow different operating systems to run on the same computer at the same time, and it prevents applications from interfering with each other. Each virtual machine is like a “machine within the machine” and functions as if it owned the entire computer. The operating systems in each virtual machine partition are called “guest operating systems,” and they communicate with the hardware via a virtual machine control program called a “virtual machine monitor” (VMM). The VMM “virtualizes” the hardware for each virtual machine. With a virtual operating system/virtual machine the present software need not be dedicated to the Microsoft operating system.

A program application 374 runs within application process 376 which runs, and enforcement agent 378 is associated with application process 376. Similarly, enforcement agent 379 is associated with application process 380, within which OS shell application 382 runs. Generally, a command line interface or operating system shell or executive may be run as a type of application running in an application process, depicted as OS shell 382, examples of which include: “command.com” and “explorer.exe” for one known operating system 370, and the “bash” command for another known operating system 372. Examples of an application 374 running inside of application process 376 include: Microsoft Word, Adobe Acrobat Reader, Netscape Internet Browser and the GNU Image Manipulation Program.

The enforcement agents 378 and 379 are instances of a software program that modifies the interface between the application process and operating system kernel, and permits additional non-discretionary access controls to be enforced without requiring changes to user application programs. In FIG. 6, enforcement agent 378 is associated with application process 376 within which program application 374 runs, and enforcement agent 379 is associated with application process 380, within which OS shell application 382 runs. Each enforcement agent controls access to the contents of secure files 390 by application 374 running within application process 376. The access is controlled in accordance with a policy model that permits different classes of users different levels of access to the information, depending on predetermined authorization. For example, admission personnel will have access to insurance and selected personal information, however can only copy it to a selected file and nothing else. Nurses, pharmacists and physicians would have policies that grant higher levels of access. Individual users are granted access only to the information that they need for their specific roles in the health care process. The secure exchange system's multi-level policy capability can be custom-tailored to provide the high level of security required under the federal HIPPA laws, while allowing an extraordinary level of versatility and portability. If an unauthorized person tries to enter the system to read, copy or change a medical record, the secure exchange system disallows the action and records the intrusion in an activity log and it notifies the responsible persons automatically. At the Security Policy Server 354, the user name, password and patient identifier are matched to a system-wide policy that is designed to comply with HIPPA. The system-wide policy is maintained as a data table at the Security Policy Server 354.

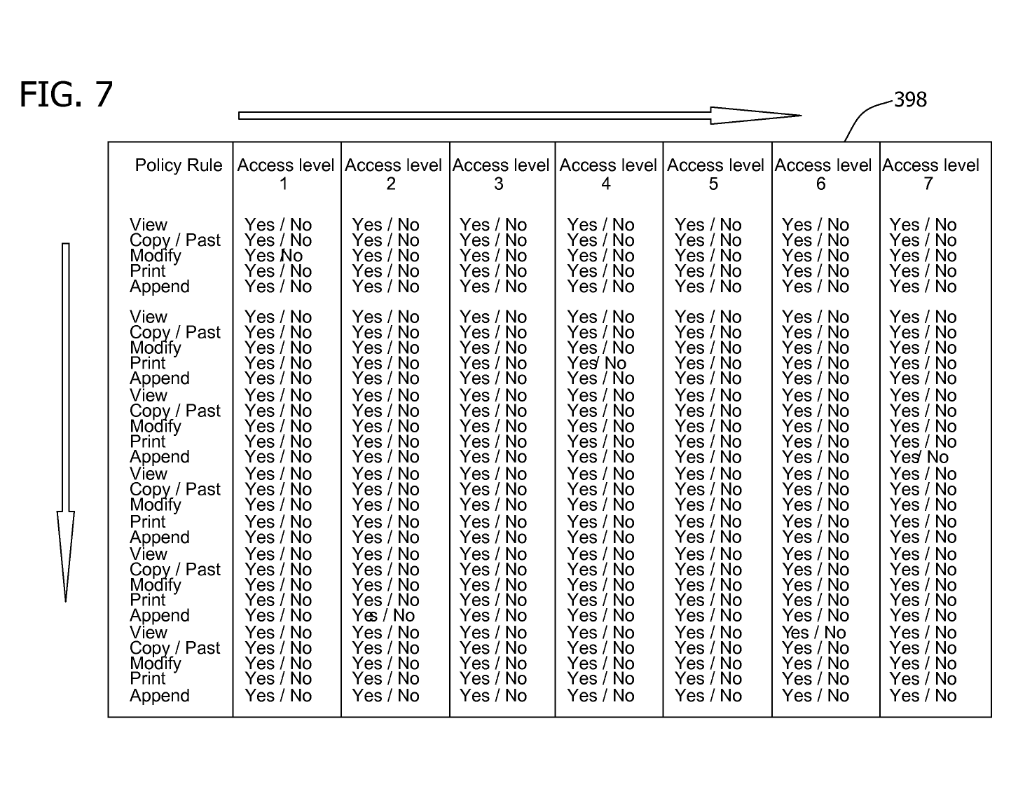

FIG. 7 represents an exemplary policy data table 398. The policy table is a graphical representation of the role allocated to any person, application, device or any other role-player that can execute the following roles, but not limited to the open, save, update, edit, create, delete, rename, move, add, append, concatenate, comment, compile and/or browse functions of anything on the card. Once the necessary authentication has been applied, the roles service user the policy data table to determine levels of authorization. Authorization levels can range from complete access or limit it to restricted access.

As represented by the policy data table 398 example, at any intersection of data category and level of access, the open, save, update, edit, create, delete, rename, move, add, append, concatenate, comment, compile and/or browse functions of any information or application on the card can be managed. The rights associated to any user, device or application is granted once a call is made to the roles logic of the solution, and the necessary authorizations have taken place. In response to a query, the policy service determines whether sufficient authorization exists for the enforcement agent to allow the requested action or actions initiated by any user, application or logic.

The data categories are arranged in rows by type of record/information. In the medical records example, these may include Personal Information, Medical Information, Restricted Medical Information, Medical Records, etc. The policy table is arranged in columns by categorical status with respect to the roles that access the data. Examples of these roles may include Patient, Primary Care Physician, ER Triage Nurse, Resident, Admitting Nurse, Radiologist, Psychiatric, etc. Defined user actions are specified in the second column, and these may include View, Change Policy, Copy/paste, Modify, Print, Append, Set Date Range, etc. The security policy broker 354 implements this pre-defined policy. The security policy broker 354 interprets security policy within the context of information system 300. There may be one or more security policy brokers 354 running in information system 300. Referring back to FIG. 6, one security policy broker 384 is assigned to enforcement agents 378 and 379. The security policy broker 384 and the enforcement agents 378 and 379 run on the same information system 300, and each enforcement agent runs in different application processes.

In response to a query by an enforcement agent, the security policy broker 384 determines whether sufficient authorization exists for the enforcement agent to allow the requested action or actions initiated by user 302. In other words, the enforcement agent communicates with the security policy broker 384 to determine how specific user-actions should be enforced. The security policy broker 384 is also responsible for ensuring compliance with the correct security policy, whether this policy information is carried within the secure file 390, maintained in the policy broker cache 392, or retrieved from the security policy server 354.

Each enforcement agent controls access to the contents of secure files 390 by application 374 running within application process 376. The enforcement agent 378 monitors, intercepts, and as needed, mitigates, the requested actions performed to and with the contents of secure files 390. The enforcement agent 378 intercepts the flow of instructions between the operating system 370 and the application program 374 running in application process 376.

This interception can be accomplished in any number of ways. For example, the interception can use one or more existing application programming interfaces (APIs) and other well-known programmatic conventions implemented by the operating system 370. Information on such interfaces and conventions can be obtained from the published documentation associated with the operating system 370 or obtained from by careful study and analysis of actual programs, or obtained using other conventional techniques.

The specific design and implementation of the enforcement agent depends on the operating system 370, and includes measures to identify, detect, and as necessary, modify, the flow of instructions between the application program 374 and the kernel of the operating system 370. By way of example, the enforcement agent can be implemented on a process-by-process basis for all application processes 372, or possibly as an enhancement to the programs and tools provided with the operating system 370, or possibly even as an extension to the kernel of the operating system 370. Such an extension to the kernel can, for example, be implemented using a pseudo-device driver or other loaded module of the kernel executive of the operating system 370; or by enhancing the capabilities of the existing system-wide library routines, such as “glibc” or kernel32.exe; or by extending the capabilities of existing command level applications, such as bash, ash, or command.com; or by modifying the attributes of each application process 372 as it is created by the operating system 370.

The trusted card 120 includes the data files for a patient which are read into the secure exchange upon insertion of the USB connector 150 into a USB port of a computer and subsequent user authentication. These patient files include data files 394, secure files 390, policy broker caches 392, and enforcement agent caches 396.

Each secure file 390 contains both information to be secured (e.g., from a file 394 or generated by the user 302) and additional information to maintain its security. The contents of a secure file 390 cannot be successfully accessed without the intercession of an enforcement agent and a security policy broker 384 implementing the security policy under which the security policy broker 384 was configured. For example, the secure file 390 can contain a Microsoft Word file, which can be shared with others, but whose content is accessed through the use of a Microsoft Word application running in an application process 376 associated with an enforcement agent 378. The details of the secure file 390 are discussed below.

The policy broker cache 392 is used by the security policy broker 384 to retain and reuse information used to make enforcement decisions. The policy broker cache 392 can store additional information on the security policy, identity information about users of the described embodiments, and/or other information. The policy broker cache 392 can be shared between multiple security policy brokers 384, and/or there may be one policy broker cache 392 for each security policy broker 384.

The enforcement agent cache 396 is used by the enforcement agents to store any temporary information created by applications protected by the enforcement agents. Information in the enforcement agent cache 396 is protected from unauthorized access. Temporary information can include, for example, automated backups, automatically generated revisions, and others types of temporary files. The enforcement agent cache 396 is used to ensure that this temporary information is maintained in a protected state and that no unprotected copies of any temporary files are vulnerable to unauthorized access. The enforcement agent cache 396 may also temporarily store decrypted plaintext blocks of information otherwise contained within protected secure files 390 in an encrypted state. In other embodiments, the enforcement agent cache 396 may be shared between multiple enforcement agents 378 and 379, and/or there may be one enforcement agent cache 396 for each enforcement agent.

The policy broker cache 392 and/or the enforcement agent cache 396 can include a time- to-live (TTL) interval, where the cached information remains authoritative for a specified interval of time. After the time-to-live interval ends, the cached information expires. The TTL interval may vary according to the specific security policy in place, and indeed, different TTL values may be used with different users, for different files, and/or with different information systems.

With regard to FIG. 6, and in addition to the prior art connections via the network 330, the information system is connected via the network 330 to an audit server 350, a directory service 352, and a security policy server 354. The audit server 350 receives the detailed event data from the enforcement agents and the security policy brokers 384 of various information systems coupled to the audit server 350 via network 330. This event data indicates what users attempted what actions under what conditions, along with other security related information collected by enforcement agents and security policy brokers 384. The collection of these events can be directed by the security policy. In various embodiments, there may be one audit server 350, multiple audit servers 350, or no audit servers 350. In the case of no audit server 350, all information that would otherwise be sent to an audit server 350 may be stored in information system 300.

The directory service 352 contains additional information associated with users required for the operation of the information systems utilizing the currently described embodiments. Such additional information includes, for example: identity records and other configuration data for the enforcement agents 378 and 379 and security policy brokers 384 specific to users 302. In various embodiments, there may be one directory service 352, multiple directory service 352, or no directory service 352. In the case of no directory service 352, all information that would otherwise be sent to a directory service 352 may be stored in information system 300.

The security policy server 354 provides updates to the security policy broker 384 on the security policy for the information system 300. Depending on the security policies of a given organization and the privileges of the user 302, the information system 300 may be permitted to function for periods of time without a connection to the security policy server 384, depending on information stored with the policy broker cache 392 and enforcement agent cache 396. If such disconnected operation is permitted, the actions of the user 302 can be further restricted while the information system 300 is in a disconnected state. In addition to the initial activation of the information system 300, the information system 300 at other times can access the security policy server 354 for additional security policy information. For example, the information system 300 can access the security policy server 354 periodically, non-periodically, and/or in response to rules established in the security policy itself. In various embodiments, there may be one security policy server 354, multiple security policy servers 354, or no security policy servers 354. In the case of no security policy server 354, all information that would otherwise be sent to a security policy server 354 may be stored in information system 300.

The security policy obtained from the security policy server 354 may be specific to a given person, a particular information system, or both. Such person-specific information can include, for example: authentication-related credentials (e.g., passwords, cryptography keys, biometric attributes, and authentication tokens); and references to various authenticated-related information located elsewhere via the network 330 (e.g., passwords, cryptography keys, biometric attributes, and authentication tokens). The security policy information obtained from the security policy server 354 can be stored for an indefinite period of time in the policy broker cache 392, a defined period of time in the policy broker cache 392 before needing refreshment by the security policy server 354, or retrieved from the security policy server 354 each time it is required.

In other embodiments, the security policy broker 384 can obtain authentication related information from the security policy server 354, the authentication identification system 340, authentication certification system 342, and/or the directory service 352. The security policy broker 384 can also make use of authentication mechanisms provided in the operating system 370.

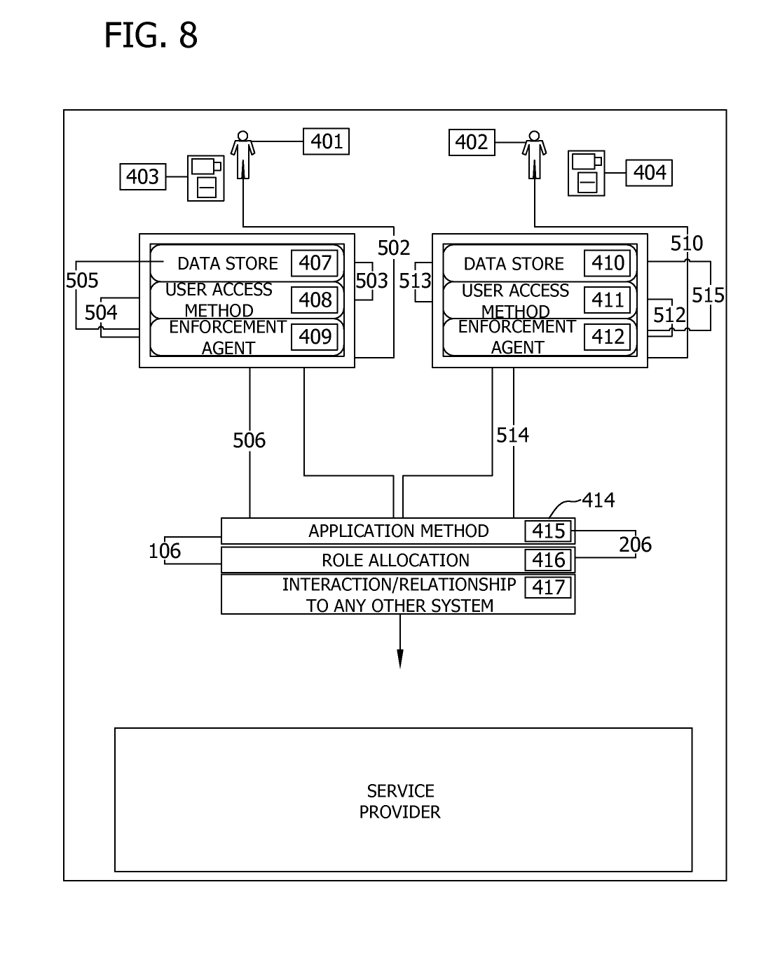

FIG. 8 is a representation of one embodiment of a secure exchange/trusted card solution with several possible components of the secure exchange system represented. It should be noted that any particular deployment, may or may not include all the aspects described with respect to FIG. 8.

A first card holder 401 is the person who has been allocated a trusted card for any reason or application. The trusted card provides a secure, portable mechanism for transporting data. The first card holder 401 can assume any role and use the card for the transportation of any data. The ability to access the data and the role that the person plays when the card is accessed is defined by User Access Method 408, Enforcement Agent 409, Authentication Method 415, Role allocation 416, and user two 402. The first card holder 401 may interface with numerous role-players and require the card to be accessed by numerous devices to complete a transaction.

With respect to a second card holder 402, there are a number of transactions, but not all, that will require the role of a second or third card holder. Specifically, there are a number of scenarios where a second role-player will have rights associated with them to participate or fulfill types of transactions. However these roles will always be managed by the Authentication Method 415, and the Role Server 416.

The trusted card 403 is the physical device described in FIGS. 2A, 2B, and 2C. As further described, trusted card 403 includes the Data Store 407, User Access Method 408, and Enforcement Agent 409 (analogous to FIG. 3) and represents a secure method for the transportation of information. The access to the information of the card, the Data Store 407, is managed and controlled by, User Access Method 408, Enforcement Agent 409, the Authentication server 415, and the Roles Server 416.

A second trusted card 404 is utilized in a number of transactions, but not all transactions require the role of a second or third trusted card 404. The second trusted card 404 is similar to the trusted card 403. The pairing of two or more trusted cards 403 and 404 can be used to activate specific types of transactions. These transactions include, but are not limited to roles allocated by the Roles Server 416 to the Enforcement Agent 409 on card 403 and the enforcement agent 412 on card 404. Trusted card 403 is utilized to issue specific rights to second card holder 402, for either card 403 or card 404. Another transaction includes the pairing of cards 403 and 404, together with the roles allocated by the Roles Server 416, which may result in a transaction to an external system 500 using any gateway service represented as integration service 417, or initiate any other service within the trusted exchange environment 414.

The pairing of the first trusted card 403 and the second trusted card 404, together with the roles allocated by the Roles Server 416, allows either first card holder 401, and/or second card holder 402 to effect one, some, or all of the following functions: open, save, update, edit, create, delete, rename, move, add, append, concatenate, comment, compile and/or browse functions of anything on the card

Together, the various components make up the trusted card 403. Those components include the content (data store 407) which is accessed via user access method 408, however all access, encryption, roles and restrictions are managed by the Enforcement Agent 409 with reference to the Authentication server 415, and the Roles Server 416.

With regard to Data Storage system 407, the Trusted Card 403 is able to store anything that can be converted to a format that can be stored on a memory device. First card holder 401 can, by inserting the USB connector into any device that can execute the User Access Method 408, get access to data stored on the data store 407. The level of access and the role that first card holder 401 assumes is governed by the enforcement agent 409.

With regard to the user access method 408, the content of the card is made available to a user via the user access method 408. Method 408 can be built using any coding language, methodology and logic. The presentation of anything stored on the card 403, as well as the ability to initiate any other transaction, is accomplished via the User Access Method 408. The functionality provided by user access method 408 can be provided via any method that can be developed using any coding method.

Access to any aspect of the card is controlled and managed by way of an enforcement agent 409. The enforcement agent 409 is, amongst other functions, the encryption method, the authentication methodology, and security for all aspects of the content of the trusted card 403. The Enforcement Agent 409, depending on what the system is being used for, will make use of any methodology, cryptology, and security system to authenticate a user or application. Based on the level or authentication required to access any component of the solution, the Enforcement Agent 409 will limit access to the Data Store 407 and enable features and functions in the User Access Method 408. The Enforcement Agent 409 passes user credentials to the Authentication server 415 to authenticate the user if connected to the secure exchange and to the Roles Server 416, for specific roles to be passed to the Enforcement Agent 409, which are filtered down to the User Access Method 408 and the Data Store 407.

With regard to data storage system 410, the second trusted card 404 is able to store anything that can be converted to a format that can be stored on a memory device. As mentioned above, under certain conditions, one, two or multiple cards can form part of the solution. The second, third or multiple cards may or may not have stored information on them, and depending on the application of the solution it may or may not be accessed by second card holder 402, after the relevant authorization by the second enforcement agent 412, and using the appropriate method defined in the second user access method 411.

The content of the trusted cards is made available to a user via the user access method 411, which is used when the multi card solution is being deployed. In the normal application of this solution, the functionality, and methods activated on second trusted card 404, by way of the second user access method 411, is controlled by the second enforcement agent 412.

The second enforcement agent 412 controls and manages access to any aspect of the card 404. The second enforcement agent 412 is, amongst other functions, the encryption method, the authentication methodology and security for all aspects of the content. The second enforcement agent 412 secures all aspects of the Trusted Card 404. When a multi card solution is deployed, the roles that second, third, and fourth, etc. trusted cards provide in the solution are managed by the second enforcement agent 412, after identifying the second card user 402.

The second enforcement agent 412 authenticates the second user 402 locally and also by calling the authentication method 415, then identifying that users role, on the role server 416. After the authentication process has been executed, and the user's role defined, the second user 402, can access data on the second card 404, the Data Store 410, or have access to some, or all data on the first trusted card 403, which is stored in data store 407. In this scenario, second enforcement agent 412 will ship credentials to the Authentication server 415, the Roles Server 416, and the Enforcement Agent 409.

Trusted exchange 414 is a service to authenticate all users and applications of the solution, host and enforce the roles identified and described with respect to FIG. 7, provide the ability to queue messages when necessary, provide the means to integrate to third party or other systems, and provide an audit capability. Components of the Trusted Exchange 414 interact with all parts of the overall solution.

With regard to authentication method 415, any aspect of the trusted solution is managed and executed by the authentication method 415. This role can be fulfilled by any technology executing LDAP type services installed in the Trusted Exchange. More specifically, the authentication method 415 includes an authentication server that interacts with the total solution in different ways and at different times. For example, when first card user 401 inputs the first trusted card 403 into any system, the enforcement agent 409 applies access rights to those user credentials. The enforcement agent 409 may, under certain conditions, initiate a request to the authentication server 415 to get additional rights to engage the user access method 408 and/or the data store 407. The authentication server 415 may also, under certain conditions, accept a request from a second trusted card 404. These requests could take place concurrently, or singularly, and under specific conditions, the rights issued to second card user 402, using second trusted card 404, could depend on the identity of the first card user 40, and their trusted card 403.

The role allocation server 416 manages the roles executed by any component of the solution. Once first card user 401 and trusted card 403 have been identified and authenticated, and the enforcement agent 409 has activated, a request many be issued to the authentication method 415 to authenticate the first card user and first trusted card 403 into the Trusted Exchange 414. Once this transaction has taken place, the credentials will be passed to the role allocation server 416, which will issue the relevant role to the first card user 401, which could include some or all of these functions open, save, update, edit, create, delete, rename, move, add, append, concatenate, comment, compile and/or browse functions of anything on the card.

There are instances where first card user 401 and second card user 402 will be executing a joint or mutual transaction that will require different roles being issued by the role allocation server 416 to trusted card 403 and trusted card 404. In addition, there are instances where with the appropriate authentication and role allocation being issued to the second trusted card 404, and thus second card user 402, will be given access to the data on trusted card 403. Depending on the authentication and role allocation process, the second card user 402 may be issued some or all of these functions open, save, update, edit, create, delete, rename, move, add, append, concatenate, comment, compile and/or browse functions of anything on the first trusted card 403.

With regard to integration with an external system, integration service component 417 of the Trusted Exchange 414 allows the trusted solution to send transactions to and receive transactions from systems external to the trusted solution, in a secure and managed way. The first card holder 401 independently, or in combination with the second card holder 402, can initiate certain transactions. In this scenario a call will be generated by the integration service 417 to an external system to initiate transactions with that external system. The transaction will typically be initiated by first card user 401 inserting first trusted card 403 into a device, being authenticated by the enforcement agent 409, and then being authenticated into the trusted exchange by the Authentication server 415, and an appropriate role being issued by the role allocation server 416. Concurrently, or independently, the second card user 402 inserts the second trusted card 404 into an appropriate device, and second card user 402 is authenticated by the enforcement agent 412 for the second trusted card 404. The second card user 402 is then authenticated into the trusted exchange 414 by the enforcement agent 412 transacting with the authentication method 415 in the Trusted Exchange 414 via the Authentication server, and an appropriate role being issued with respect to the first card holder 401 and the first trusted card 403 by the role allocation server 416. The matching of the two appropriately authenticated cards and users, will allow for a unique set of transactions which could include any type of transaction to an external system such as a financial institution of clearing agent.

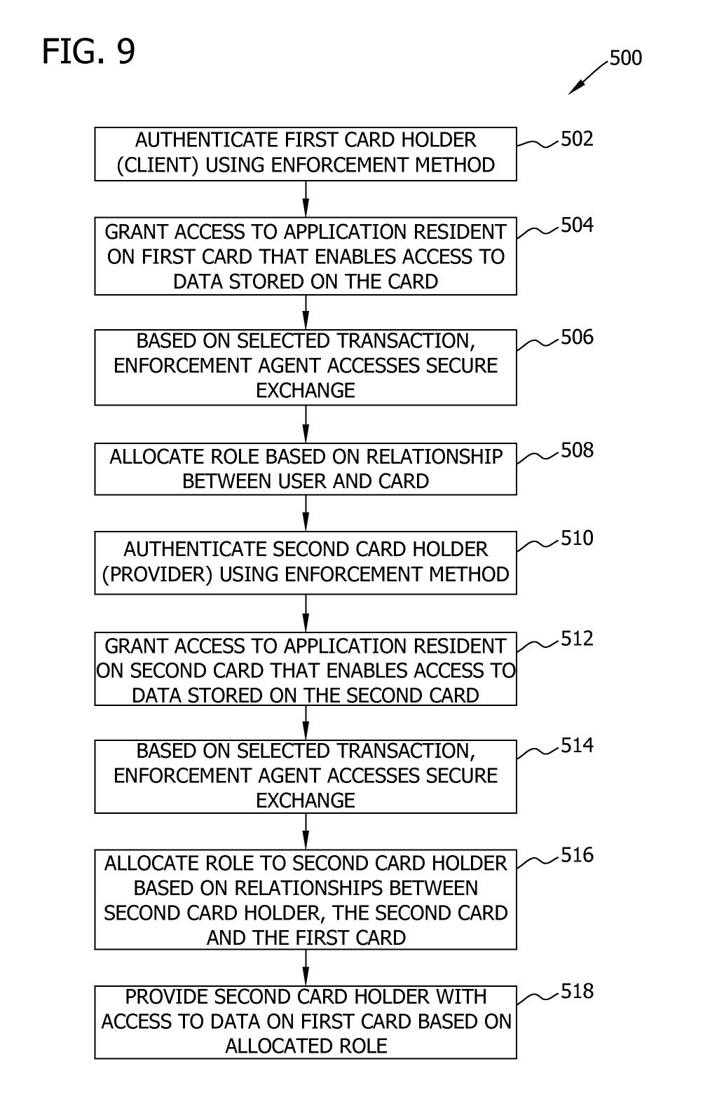

FIG. 9 is a flowchart 500 further illustrating the processes associated with the trusted card/secure exchange system described herein. Some of the reference numerals used in FIG. 9 are also shown in FIG. 8 to provide additional context to the processes described with respect to FIG. 9. Specifically, the first card user 401, after inserting the card into an appropriate device, is authenticated 502 by the enforcement method, using any appropriate methodology. After the user is authenticated 502 appropriately, access is granted 504 to the application resident on the card that enables a user interface to the data stored on the card.

The first card user 401 is able to gain access 503 to the contents on the card 403, based on the level of access granted by the enforcement agent including the allocation of the appropriate role from the role server. The user can open, save, update, edit, create, delete, rename, move, add, append, concatenate, comment, compile and/or browse the contents of the card. Depending on the application, the access right granted 505 to the data to open, save, update, edit, create, delete, rename, move, add, append, concatenate, comment, compile and/or browse, can be administered to the byte level.

Depending on the nature of the transaction required, the enforcement agent will access 506 the secure exchange, where the card user and card will be authenticated to the secure exchange, and a role will be allocated 508 to the relationship of user and card. Once a card and user has been authenticated by the enforcement agent, a call can be made to the role server, to allocate a role to that user. That role is then passed to the enforcement agent associated with that trusted card.

The second card user 402, after inserting the card 403 into an appropriate device, is authenticated 510 by the enforcement method, using any appropriate methodology. After the second card user 402 is authenticated appropriately, access is granted 512 to the application resident on the card that enables user interface to the data stored on the second card as well to the contents on the card 403. Based on the level of access granted 513 by the enforcement agent (a provider's defined role), the user can open, save, update, edit, create, delete, rename, move, add, append, concatenate, comment, compile and/or browse the content of either card 403 and 404. Depending on the application the access right granted 515 to the data to open, save, update, edit, create, delete, rename, move, add, append, concatenate, comment, compile and/or browse, can be to the byte level.

Depending on the nature of the transaction required, the enforcement agent will access 514 the trusted exchange, where the user and card will be authenticated to the secure exchange and a role will be allocated 516 to the relationship of user and card. Once a card and user have been authenticated by the enforcement agent, a call can be made to the role server, to allocate 516 a role to that user. That role is then passed to the cards enforcement agent. Under certain conditions, the transactions may result in a transaction where the combination of two cards results in the holder of one card getting access 518 to the content of the other card once the appropriate authentication and role allocation has been done, this will allow the appropriately authenticated user to open, save, update, edit, create, delete, rename, move, add, append, concatenate, comment, compile and/or browse the content.

Trusted Card/Secure Exchange Example

The following example will be used to illustrate the functionality of the trusted card/secure exchange system described herein. Though the example is provided in the medical records context, the disclosure should not be construed to be so limited.

The context of the example is a health care insurance company wants to deploy a solution to provide a secure portable mechanism for their members to record and store all appropriate medical information, make sure that all relevant practitioners have appropriate rights to information that is required as part of the health care process, ensure that collection and accuracy of insurance claims, processing of information with little or no time delay, reduce the instances of fraud through the system, and implement a system to speed up the settlement of practitioners claims.

In the example, a health care insurance company issues, by way of the secure exchange company a series of trusted cards. There are two distinct cards, the one is for the client base, and the other is for the service providers.

For the client's card, the health insurance company issues a card specifically for its clients. The card may be printed with an image of the card owner, for example, in color and at the right hand top corner of the card. This card is also printed with a 3D barcode that represents all relevant information of the client, that can be scanned via a static or hand held bar code reader. The card is further printed with all information required to identify the card to the client and to the health insurance company, including name, plan, coverage date, client number, etc.

The card, in preferred embodiments also includes certain logical features. Specifically, the trusted card is issued with a storage system where any data written to the card is stored in a logical, secure manner. In the described example, the data is stored as a database. In addition, the trusted card is issued with an embedded application that renders a web based application local to the card, which is initiated every time the card is inserted into a computer and allows the user to interact with the content.

The card may further include a firewall application that authenticates any access to the application as well as the data stored on the card. The firewall application in this instance also digitally signs any access to any content on the card providing a detailed audit trail of all activity. The startup page on the embedded website contains attributes that can be used to link ownership of the card to the client presenting it this includes an image of the client. The database is pre-populated with a patient detail transcript, a prescription form, a diagnosis form and a claim submission form. Also embedded in the cards logic is a unique identifier, which identifies, systematically, the card and user to the secure exchange, and the health insurance company. This identifier cannot be changed, to provide a new number to a client, requires issuance of a new card.

The health insurance company issues a card specifically for its registered practitioners. The card is printed with all information required to identify the card to the practitioner and to the health insurance company, including name, practice number, issue date, etc. The card is printed with a 3D barcode that represents all relevant information of the practitioner, that can be scanned via a static or hand held bar code reader.

Logical features included in the practitioner's card include an embedded application that manages authentication of the practitioner, establishes a session with the secure exchange, and issues appropriate credentials of the user to the secure exchange for authentication purposes, as well as role allocation.

For the sake of this example, the patient is seeing a doctor for the treatment of flu. The patient makes an appointment to see a general practitioner located near the local hospital, as the patient's house doctor is unavailable for the day. The patient arrives at the practice at the agreed time. Upon arrival, the administrative assistant requests the name of the health insurance company that will be covering the cost of the visit. The patient produces the trusted card, and hands it to the administrative assistant. The administrator takes the card from the patient, uses the graphic image embedded on the card to verify the card belongs to the patient and then verifies the other details.

The administrator starts the engagement by inserting the USB Connector of the doctor/practice's card into a USB port on the PC in the practice. The enforcement agent embedded on the card requests immediate password authentication, the administrator enters the appropriate password which then initiates a call to the secure exchange. The patient may also have to enter a password in certain embodiments. The data transmitted to the secure exchange includes the practice identification data and the authentication parameters generated when the administrator entered the password requested by the embedded system on the card. The data handed to the secure exchange is passed to an LDAP server, which authenticates the doctor based on the credentials received from the embedded application on the doctors trusted card. The secure exchange generates a “logon successful” message which is displayed on the screen of the PC.

Once this process has been completed the administrator extends the USB connector from the patient's card. This USB connector is then also inserted in to the practice's PC. The embedded Web Site auto initiates, and presents the administrator with a number of options. These options include, in one specific embodiment, print a medical history of the patient, print a practice admittance form, prepopulated with all required information, update records, export data in a file format to import into the practice's system, and backup the data on the card.

However, before any transaction can be processed, the application that was initiated from the doctor's card, which is still resident in the PC's memory, queries the enforcement agent on the patient's card and extracts the information that identifies both the card and the patient. This data includes the card's unique identification number and the patient's identification number. This data is then sent to the secure exchange system.

These data points, “card and patient id” are also authenticated by the LDAP server. The LDAP server will then verify the patient credentials and validate the patient's membership with the health insurance company.

Once the dual validation process has completed, the credentials are passed to the roles server within the secure exchange. The role server uses the credentials that have been passed to it via the LDAP server to reference the policy data table on the roles server. Based on the doctor's function, as well as a number of other criteria a role will be issued by the roles server to the enforcement agent on the patient's card. The enforcement agent will use the credentials that have been passed to it from the roles server to assign privileges to the administrator to execute certain functions on the patients trusted card.

By virtue of the access that has been granted, the administrator selects the option to print the patient's medical history, patient detail transcript, a diagnosis form and a claim submission form. Each one of these actions is recorded in an audit file on the patients trusted card. The administrator places the patients detail transcript in a file and places the patient's medical history and diagnosis form on a clip board for the doctor.

The patient sees the doctor, undergoes an examination, and the doctor diagnoses the patient with the flu. The doctor reviews the patient history record that has been printed from the patients trusted card to identify whether the patient is on any other treatment, or has any other condition that may affect the doctor's decision on a course of treatments. Once the doctor has identified the treatment that the patient should received, he completes the diagnosis form with the diagnosis, treatment prescribed and all relevant HIPPA codes. The doctor also makes out a prescription for the patient.

The patient then returns to the administrator with the completed forms. The administrator then re-inserts the patients trusted card's USB connector into the PC's USB port. The enforcement agent re-authenticates with the doctors credentials, and grants the administrator access to the relevant aspects of the patients trusted card. In this case, the administrator has been granted edit and updates rights, and accordingly is able to enter the information as documented by the doctor into the trusted card via the update information template; the administrator also captures the content of the prescription onto the patients trusted card prescription template, which writes the data to the database on the card. This data is all digitally certified, and any activity is certified for audit purposes.

Once the administrator has updated the medical history database on the card, a transaction is generated to the secure exchange, which includes, doctor's credentials, patient credentials, diagnosis and treatment code. The transaction is again authenticated by the LDAP server, and then routed to the broker service within the secure exchange. The broker service is configured to route the compete transaction which includes, health insurance company routing address, practitioners details specific to that health insurance company, patients details as well as relevant treatment codes to the health insurance company. On receipt of this transaction, the health insurance company's gateway responds with a transaction successful message that is rendered to the PC in the practice.

The health insurance company has all the information it requires for an immediate settlement of the transaction with the doctor. On receiving the “transaction successful” message, the administrator in the practice removes the patients trusted card and returns it to the patient. The patient then proceeds to the pharmacy where the patient presents their trusted card to the pharmacist.

The pharmacist starts the engagement by inserting the USB Connector of the pharmacy's card into a USB port on the PC in the practice. The enforcement agent embedded on the card requests immediate password authentication, the pharmacist enters the appropriate password which then initiates a call to the secure exchange. The data transmitted to the secure exchange includes, the pharmacist identification data and the authentication parameters generated when the pharmacist entered the password requested by the embedded system on the card. The data handed to the secure exchange is passed to an LDAP server, which authenticates the pharmacist based on the credentials received from the embedded application on the pharmacist trusted card. The secure exchange generates a “logon successful” message which is displayed on the screen of the PC.

Once this process has been completed the pharmacist extends the USB connector from the patient's card. This USB connector is then also inserted in to the pharmacist PC. The embedded Web Site auto initiates, and presents the pharmacist with a number of options. These options include print a medical history of the patient, print prescription, and backup the data on the card.

However, before any transaction can be processed, the application that was initiated from the pharmacist card, which is still resident in the PC's memory, queries the enforcement agent on the patient's card and extracts the information that identifies both the card and the patient. This data includes the cards unique identification number and the patient's identification number. This data is then sent to the secure exchange system.

These data points, “card and patient id” are also authenticated by the LDAP server. The LDAP server will then verify the patient credentials and validate the patient's membership with the health insurance company.

Once the dual validation process has completed, the credentials are passed to the roles server within the secure exchange. The role server uses the credentials that have been passed to it via the LDAP server to reference the policy data table on the roles server. The pharmacist has a standard function defined on the role server, this role will be issued by the roles server to the enforcement agent on the patient's card. The enforcement agent will use the credentials that have been passed to it from the roles server to assign privileges to the pharmacist to execute certain functions on the patients trusted card.

The pharmacist then prints the prescription as made out by the doctor and fills it. Once he has completed these steps, he updates the prescription file on the patients trusted card, which is digitally signed, and a transaction is generated to the secure exchange, which includes, pharmacist credentials, patient credentials and medication. At least one effect of these steps is to prevent the patient from securing multiple prescriptions from multiple doctors and multiple pharmacists. The transaction is again authenticated by the LDAP server, and then routed to the broker service within the secure exchange. The broker service is configured to route the compete transaction which includes, health insurance company routing address, pharmacist details specific to that health insurance company, patients details as well as relevant medication codes to the health insurance company. On receipt of this transaction, the health insurance company's gateway responds with a transaction successful message that is rendered to the pharmacist PC. The health insurance company has all the information it requires for an immediate settlement of the transaction with the pharmacist.

As described repeatedly herein, security is a core requirement of the Secure Exchange Solution (SES) and Trusted Card. As such, the Trusted Card must authenticate any user that requests access to any data that is secured as part of the SES platform. Various options for achieving such authentication include validation of card credentials are identify the card owner, local (card-based) authentication against a set of credentials stored on the card, and online authentication against a server-based credential store.

In one embodiment, the authentication mechanism is accomplished online against an LDAP service that is hosted and controlled as part of the SES platform. Every user must also be linked to a public/private key pair certificate that will identify the user and card uniquely on the SES platform. Hashed or encrypted information on the card must allow the SES platform to identify whether the user authenticating on the platform is the card owner or not.

The authentication mechanism is managed in the SES controlled environment so that the user directory is not exposed thereby preventing unknown or inactive users from gaining access to the SES platform and eases the management of issuing and revoking credentials. The card itself does also not provide the basis to assume that the user is a valid user or the card owner, so authentication must always take place to use the card.

Any user that is authenticated must be provided with only those rights and roles that have been granted by SES and by the card owner (if the user is not the card owner). The authentication credentials include a unique user identifier, user password and access role so that the server can identify what type of access requested and whether the user authenticating is the card owner or another user that is trusted and has the permissions to access the card data and the SES platform. The level of access must then restrict what actions the user can perform and what data the user can access.

Roles-based access to the Trusted Card is managed by the software application (User Access Method). Specifically, user roles are configured in the database on the card that manages what data can be accessed in the database. User roles are also configured on the SES platform back-end and linked to roles stored in the LDAP service.

The role that a user can assume is determined by the SES platform back-end LDAP service. When a user is authenticated, the user credentials determine whether the user is the card owner or a guest user. A card owner is authorized to perform specific actions that no other user can. If a guest user (any other user accessing a card that does not belong to them) wants to access information on the card, the guest user's credentials (card) must first be paired with the card owner's card. The pairing of cards creates facilitates the granting of access rights by a data owner to a requester. Both parties authenticate themselves on the SES platform to perform the card pairing process and rights are determined based on the pairing configuration in terms of the roles of each of the card holders and the data that the data owner wants to make available.

The access to data is controlled through the partitioning of data for different roles. The reliance on a software component to filter the access poses a threat and can be manipulated to expose data or allow actions that the card owner never intended. Leaving the data authorization of a user's access to data to the database engine on the card is also susceptible as the database would be accessible to any authenticated user and be exposed to attacks where an authenticated user may attempt to elevate his rights or gain access to the database data in other ways.

Access to data on the card cannot be determined by the software components or restricted Java database that resides on the card because both would be vulnerable as the Trusted Card operates in a hostile environment. The Trusted Cards is paired to exchange security information that allows an entity that is requesting data to be given the correct access rights by the entity that is the data owner. This requestor and grantor roles can be reversed in scenarios where both parties can be given rights on each others cards.

Encryption must protect the data that is stored or transmitted using the Trusted Card and SES platform. Options include software-based encryption, and hardware-based encryption (encryption device or embedded encryption). In one embodiment, software-based encryption is used to encrypt data stored on the Trusted Card, on the SES platform back-end and during transmission. A mixture of asymmetric and symmetric encryption algorithms are used with random numbers that have a high level of randomization and are sufficiently large. Embodiments of the Trusted Card hardware have already been standardized without any hardware-based encryption. Should hardware-based encryption become available then the software encryption will still be used as it is often stronger and more versatile than the hard-based encryption options.

Trusted cards operate over the internet so the communications channel must be secure and encrypt all data that travels “over the wire” to prevent tampering and disclosure or data. A channel is created between the Trusted Card and the SES platform to facilitate all communications.

The channel is established before any communication takes place as the first communication with the SES platform will typically be the credentials of a user requesting authentication. Transport Layer Security (TLS) is used to establish and maintain a secure and encrypted communications channel for the duration of an active user session. OpenSSL may be used to provide this channel with the use of encrypted user information on the card. Messages transmitted over the secure channel will also make user of message digests (symmetric algorithms) to prevent tampering with the content of the message.

If the communications channel is not secure and both ends of the channel cannot establish a trusted connection then there is no way to protect the data “over the wire” and ensure that the parties at either end can trust that the data will not be tampered with and is destined for the intended party. TLS/SSL is also a widely used standard and can be trusted to secure the data adequately from any browser or hardware platform.

The Enforcement Agent, User Access Method and Data Storage system must be capable of functioning on Windows, Linux and Macintosh operating systems. The technologies used for these components must operate on all three environments. The major technologies and standards used in any software on the Trusted Card include JavaSE—The Java Virtual Machine operates on the Windows, Linux and Macintosh operating systems and Java Standard Edition libraries will be used. No operating system dependent libraries are permitted for development of software on the Card.

HTML is a ubiquitous technology that can be executed on many different browsers and application software. Related technologies such as JavaScript, Cascading Style Sheets and Dynamic HTML are also permitted.

XML—The use of XML for data structure definition and possible reporting when combined with XSLT are allowed. Certain industry-specific XML libraries will be permitted for compliance, data import, data export or integration.

JavaDB—All structured data are stored in a database on the Trusted Card. The database engine is a multi-user relational database with a small footprint that runs on JavaSE and JavaEE. Other important features are that the database can operate in an embedded mode or in a stand-alone mode and is fully ACID compliant. It also supports database encryption and crash recovery.

TrueCrypt—TrueCrypt is a software component for establishing and maintaining an on-the-fly-encrypted volume (data storage device). The software is used to create an encrypted file container on the Trusted Card that will contain the Data Storage system and primary User Access Method. It forms part of the Enforcement Agent system by providing a secure storage area that can only be accessed once the Enforcement Agent activates the TrueCrypt decryption routines on authentication and authorization has been successful. The TrueCrypt software will be shipped with the Trusted Card, in one embodiment, and will run on all required operating systems without requiring any installation.

The Secure Exchange Solution is highly scalable when accessing the central Authentication Method and Role Allocation as well as when managing Secure Online Transactions. Secure Online Transactions will often exchange data with third-party service providers using system integration. The central Authentication Method and Role Allocation may be hosted by a set of synchronous web services that can be scaled out in a web farm configuration. The Secure Online Transactions are scaled by using a messaging system to queue messages for processing to manage system resources and provide a high level of transaction management and fault recovery.

The Secure Exchange Solution back-end provides an integration mechanism to third-party service providers or in-house services that are available to the Trusted Cardholder. Integration is implemented using an integration service that can manage message storage, queuing, routing, transformation, rules and multi-channel and multi-format message and data integration.

The Trusted Card User Access Method also provides a framework for standard authentication and authorization but is also flexible to accommodate different user interfaces for different applications. For example, unique applets can be created for each scenario (e.g. Health scenario, Digital document signing scenario, etc.). In addition, an applet can be created that can run dynamic user interfaces. This is highly flexible but also more complex to build and manage.

Finally, the Trusted Card has a software update component that is able to download new versions of application software for the Trusted Card. The update component ensures that the software on the Trusted Card is always the latest when executing a Secure Online Transaction.

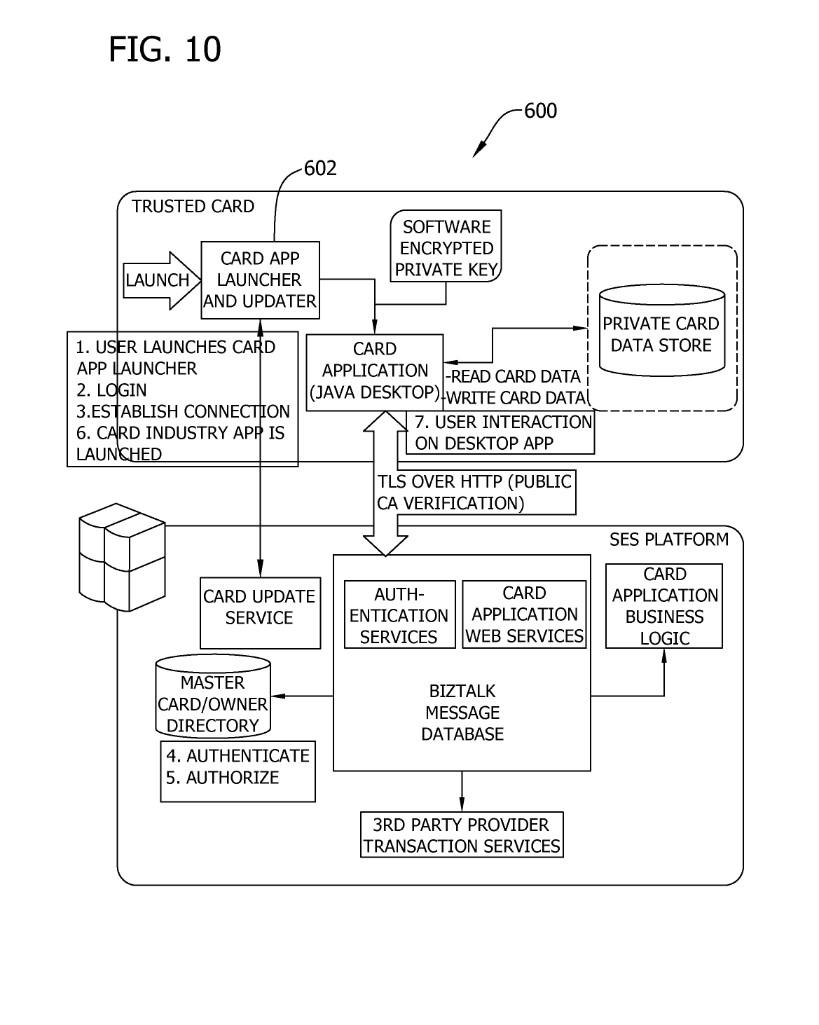

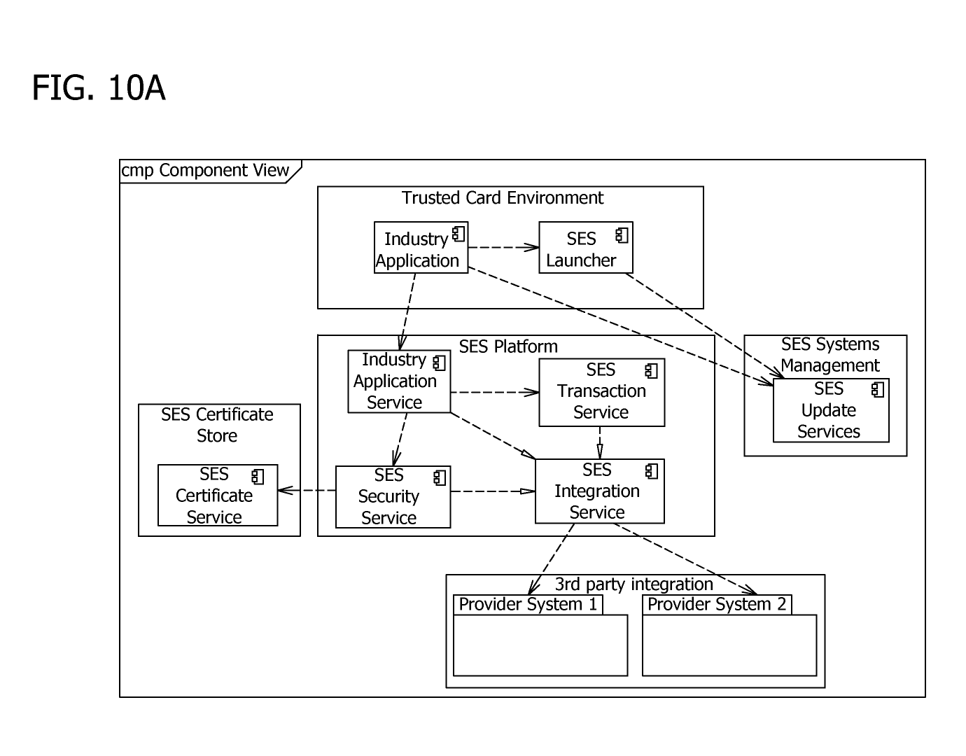

FIG. 10 is a diagram 600 that provides one possible architectural solution for the trusted card/secure exchange system. The card application 602 provides functionality for login, running a user interface, reading and writing the data stored on the trusted cards.

An SES launcher is a trusted card application that provides the initially capability to launch the SES Update Service and any Industry Application on the Trusted Card. The SES launcher application is responsible for identifying the platform that the Trusted Card is running on, calling the appropriate versions of applications for a given platform, and calling the SES Update Service to download application updates.

A SES Update Service is a service that maintains the versions of the SES and Application software components. The Update service initiates a software component update on a Trusted Card if any software components on the card are outdated when the card is used. The service is responsible for storing major and minor release versions of the software components, detecting the versions of software components installed on a Trusted Card, and initiating the necessary software updates to the Trusted Card.

A SES security service is a service that maintains the users and roles for the system, including any trust relationships that have been formed between Trusted Cards. The SES security service is responsible for, authenticating Users/Cards, authorizing Users, linking and unlinking Cards (Trust Relationships), maintaining all Users and Roles, and maintaining a link to the SES Certificate Store.

A SES Certificate Service is a service that maintains the master repository for the security certificates that are used to identify each card and user of the SES system. The SES Certificate Service is responsible for storing all security certificates, providing access to create and maintain the security certificates, encrypting and decrypting data using private and public keys stored in the Certificate Store.

A SES transaction service validates and signs all transactions and data updates to Trusted Cards. The service is responsible for determining transaction validity, determining transaction authorization, signing transactions, and storing transactions or routing transactions for processing by other external or internal interfaces.

A SES Integration Service is an infrastructure service in the form of an enterprise service bus (ESB) that provides a platform for other SES Services and for integration with third party service providers. It is responsible for maintaining a service registry, maintaining service on and off ramps, message transformation, message routing and implement service itineraries, and message persistence.

The Trusted Card Application is an industry implementation that runs on the SES platform. The application will execute a user interface on the Trusted Card that can perform specific transactions and will overlay the SES functionality. The Trusted Card Application interacts with an Industry Application Services that are hosted by SES. The Industry Application Services are specific services that service an Industry Application running on a Trusted Card. The services provide specific industry-based functionality and conform to the SES platform requirements in terms of security, transactions and data storage.

FIG. 10A is a system partitioning diagram that depicts the above described applications as components and their relationship to each other. The infrastructure services have not been depicted and the data stores are considered to be part of the applications, so are not depicted separately.

A Certificate Authority (CA) is an entity trusted by all parties involved that for the purpose of authentication issues a certificate to a user or a computer whose identity it has already verified so that other users and computers can rely on the authenticity of the certificate holder's identity. Digital certificates contain information about the holder's public key, its expiration date, and the digital signature of the certification authority.

A Transport Layer Security (TLS) Mechanism is a protocol that is used for establishing a secure connection between a client and a server. TLS is able to authenticate both the client and the server while it creates an encrypted connection between them both. The TLS protocol is extensible which means that new algorithms can be added as long as both the server and the client know about the new algorithms.

An OpenSSL Mechanism refers to an open source implementation of the SSL and TLS protocols that is available as a library and can be integrated into a custom system.

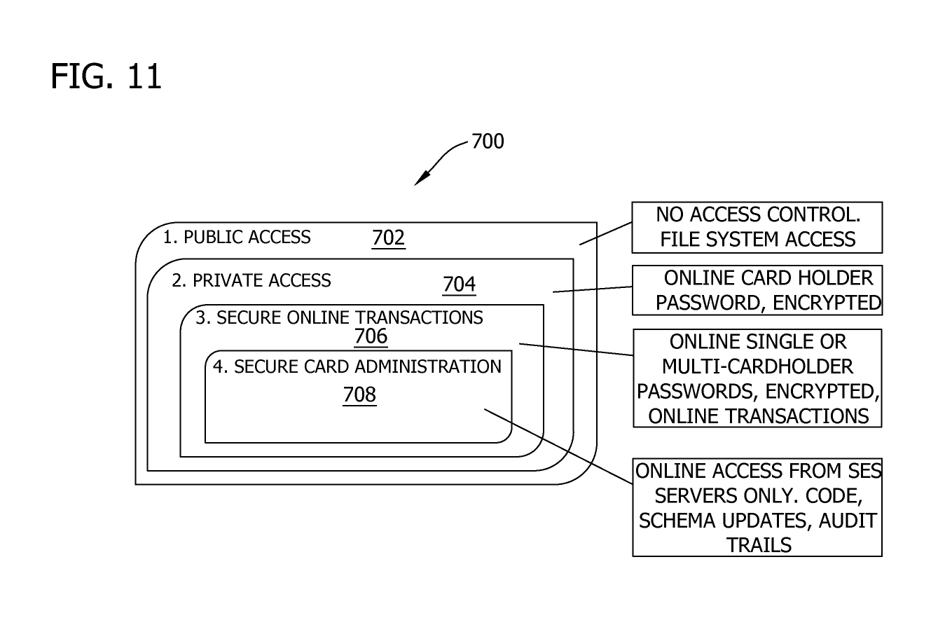

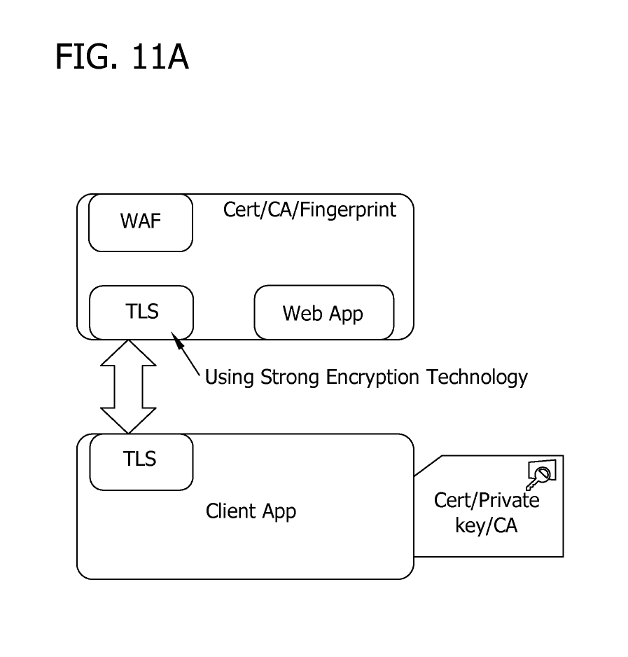

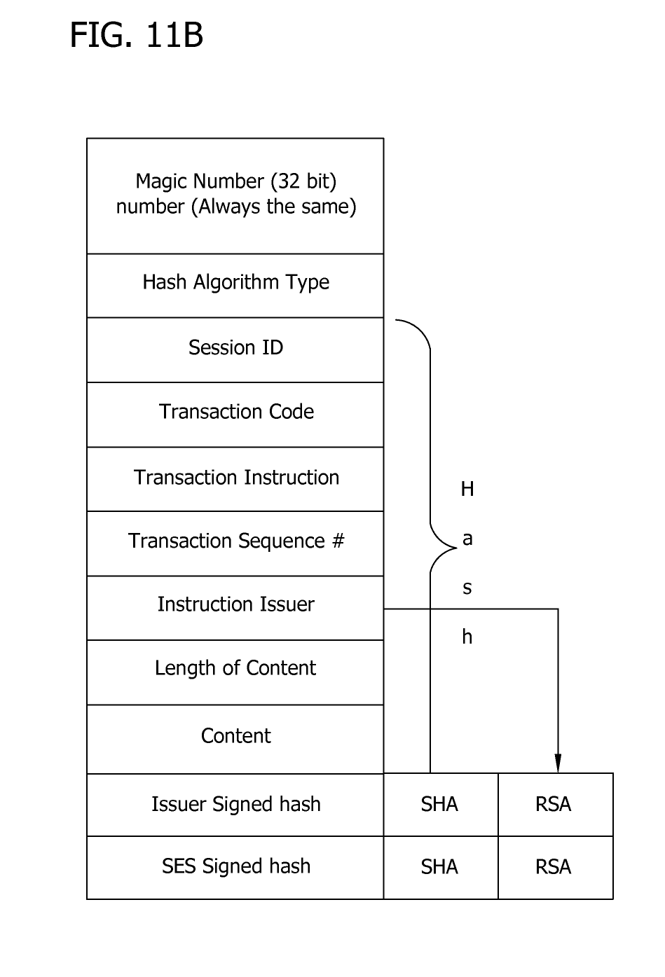

FIG. 11 is a diagram of the security architecture 700. The Secure Exchange Solution with the Trusted Card is primarily an enabler of secure transactions. As such the security of the Trusted Card has been layered to provide a public access layer 702, a private access layer 704, a secure online transactions layer 706, and a secure card administration layer 708.

The public access layer 702 is not controlled by the Trusted Card. Files can also be stored in this space as part of the Trusted Card flash drive file system. The User Access Method will challenge the user for credentials to launch if any actions are requested that require further access.

In order to gain access to the Private Access layer 704, the card user has to be authenticated online with the Secure Exchange. The User Access Method establishes a secure channel for communication to the SES platform and authenticates the user credentials. It is important to note at this stage that the card user is not necessarily the card owner. This data area is encrypted. Personal data that identifies the Cardholder or the forms part of the SES authentication cannot be edited by the Cardholder. The Cardholder password can publish this data into the Public Access area if desired.

The Secure Online Transactions layer 706 is accessible when the Cardholder is authenticated online using the Secure Exchange and will also allow read and write access to additional cards with the required access rights that have been authorized by the Secure Exchange in a multi-card scenario. Note that the additional cards must be linked to the card being accessed before any access can be granted to this data area. Secure authorized transactions can be written to this data area and Secure Exchange integration transactions will be initiated where necessary.

The Secure Card Administration layer 708 is reserved for administration purposes. The Secure Exchange software and database components may be updated at this level and card-based audit trails, access logs and error logs will be kept in this data area for compliance and security reporting.

FIG. 11A is a depiction of communications channel security which is a process that deals with the establishment of a secure communications channel between a trusted card and the SES platform.

The web server has a Web Application Firewall (WAF) installed. Web Application Firewalls are often called Deep Packet Inspection Firewalls because they look at every request and response within the HTTP/HTTPS/SOAP/XML-RPC/Web Service layers. Some Web Application Firewalls look for certain attack signatures to try to identify a specific attack that an intruder may be sending, while others look for abnormal behavior that doesn't fit the websites normal traffic patterns. Web Application Firewalls can be either software, or hardware appliances based and are installed in front of a web server in an effort to try and shield it from incoming attacks.

When the trusted card 120 is connected to the USB device of the computer, the client application will start. The client application will then access the SES server environment using OPENSSL, configured for using TLS 1.2, via the web. The server will recognize the request and send its public certificate to the client application. The client application will verify this certificate against the Certificate Authority (CA) stored on the smartcard, confirming whether the server is a trusted entity. The client application will also send the card's public certificate to the server where the server will authorize the certificate against the CA on the server to establish if the card is a trusted card.

Once all these checks are completed a trusted and secure channel will be established between the client app and the SES server. Encryption technology will be configured in OPENSSL and SHA512 will be used as the hashing algorithm and RSA1024 bit will be used for encryption.

A smart chip will be programmed to write private and public keys once, read public key many times, and will have no read functionality of private keys. Without the Smart Card chip, the system maintains a private key and protects it via software encryption. The private key will be transmitted over the secure channel to the card application once the user has been authenticated.

Authentication will happen once the trusted channel has been established. The session id and sequence number will be used to do the authentication. The steps for authentication include the server encrypting the SessionID and Sequence number with the user's public key stored in the key store, encrypting the result of the above encryption with the SES private key and sending it to the client application. The client then decrypts the authentication transaction with the SES public key and the SessionID and sequence number are then decrypted with the user's private key.

The SessionID and sequence number are used in each transaction sent from the card to the server and vice versa. The sequence number is a number generated by the SES system to track all sessions and to check if “replays” happen.

In regard to authorization, the SES Platform will maintain a database of all paired “linked” cards and the rights that card owners have granted. This configuration can be maintained by a card owner at any time after authenticating and authorizing against SES.

A secure transaction is any transaction or record update that affects the card owner's data store and can also initiate a transaction to third party service providers. Once the secure channel is established and the authentication has completed, all transactions sent between the card and server will have the make up shown in FIG. 11B.

A magic number is a 32 bit number assigned by SES to use with all transactions. The number is the same for all transactions and is used by the system to identify if the transaction packet is a SES transaction. The magic number is an early checkpoint to check if the transaction is a valid SES transaction. If the magic number is not a SES number the transaction will be ignored.

The hash algorithm type is an identifier of which algorithm type was used when hashing the file. The hash algorithm gives SES the ability to change the hash algorithm over time and still have the ability to compare hash codes using the specified algorithm type.

The SessionID is the identifier of the established secure session between the client and server. If transactions are received with different SessionID's than the current established session, the transaction will be identified as an unsafe transaction and ignored.

All transactions have a transaction code. The transaction code is used to group transactions together and is not to be confused with a transaction identifier.

Different transaction types used by SES have a unique transaction instruction type identifier. This identifier code is used by the system to know what type of transaction it is expecting and how to handle it.

Transaction Sequence Number: Each transaction has a sequence number. Sequence numbers are incremented per transaction, per transaction code, thereby ensuring that all transaction packets for a specific code are received and received in sequence. The application will pick up gaps and or duplicate transactions early in the process by validating the sequence number.

Instruction Issuer: Transactions must be signed by the issuer and the system will need to know the identity of the signatory. The system can then get the signatory's public key from the key store and use this key to decrypt the signed hash code.

Length of content is the expected number of bytes of the expected content, protecting the system from buffer overruns when receiving transactions. If the length of the received content is more than the specified length, the transaction will be identified as unsafe and ignored.

The content packet is the metadata that is sent between the client and the application and contains the actual data of the transaction.

Issuer Signed Hash: Transaction segments, as per FIG. 11B, are hashed by using SHA512 or MD6. Hashing is the ability to mathematically reduce a variable length of data into a reproducible fixed length “digest” of that message. The hash string is then encrypted using the issuer's private key and is added to the transaction packet. This encryption acts as the signature of the transaction and cannot be decrypted by anyone other than the issuer.

SES Signed Hash is an additional hash stringed signed by the issuer using SES's public key. This hash string will then be decrypted by SES, using the SES private key, and the validity of transaction content will be checked using the SES Signed hash.

The architecture in terms of data storage is to create multiple containers of data that are related to a trusted relationship between the card owner and any other user with which the card owner interacts. The concept is that each trusted user will have a container that holds transactions and data updates (documents) generated by that trusted user. Containers records can only be appended, never edited or deleted so each record will be treated as immutable (unalterable) providing verifiable, trusted and reputable proof of a transaction. A master container which is only editable by SES will consolidate specific data updates and transactions to create a view of the data that is applicable to the software application that is being used by the Trusted Card.

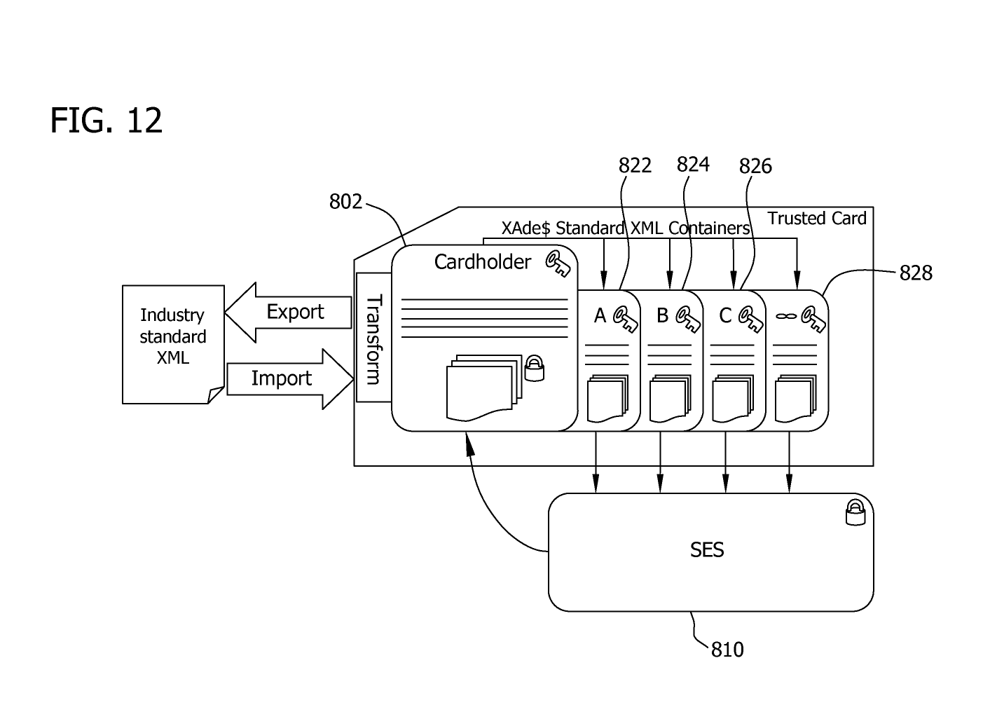

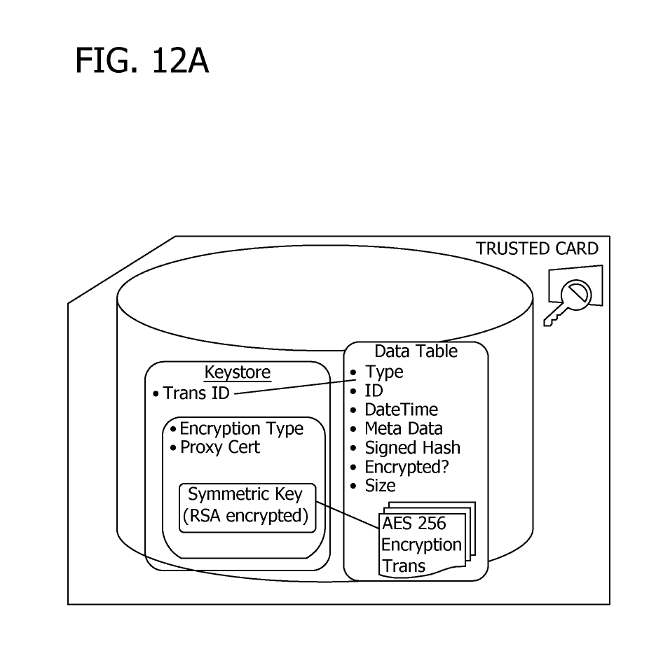

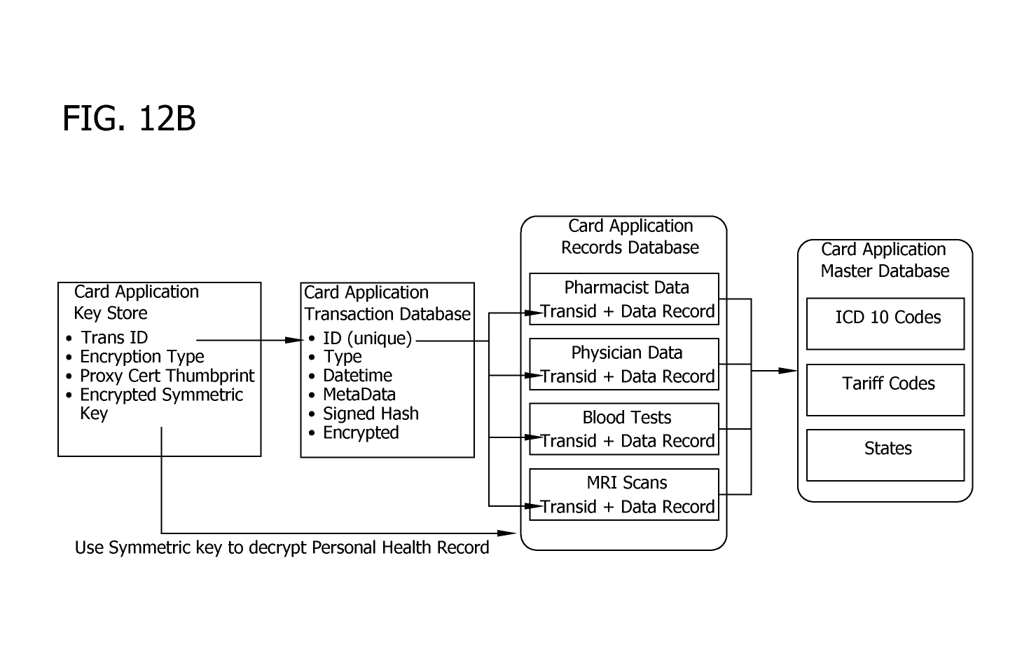

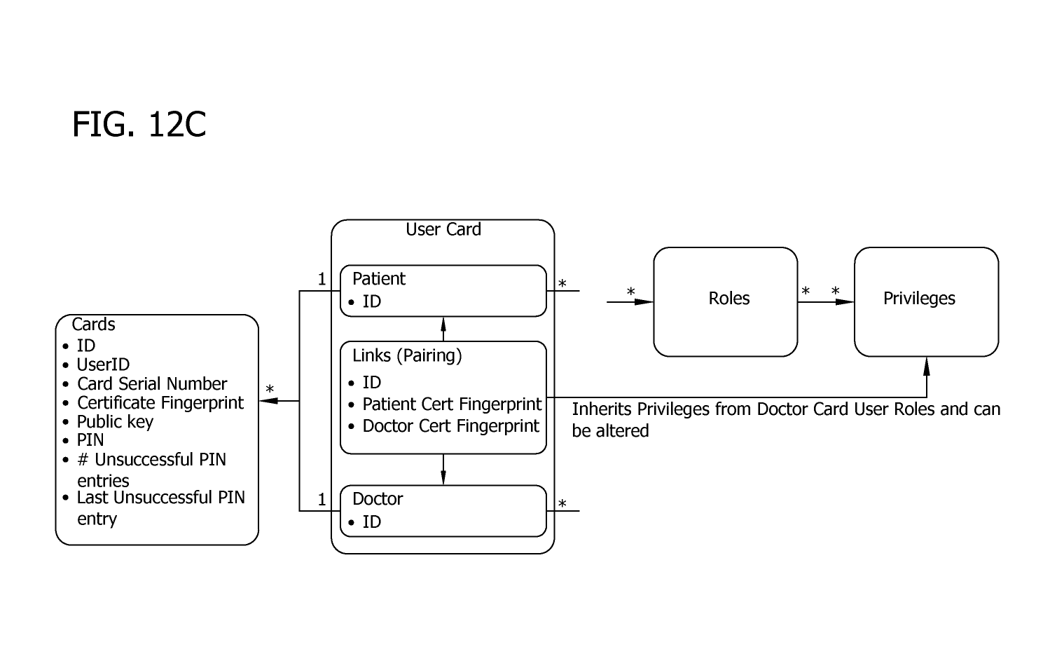

The Trusted Card data storage and access mechanism is depicted logically in FIG. 12. There is a single Master container (Cardholder container 802) that can only be updated by the SES platform and contains all available data elements. The card owner is the only user that can access all information in the Master container and the SES user is the only “user” (key) that can write data to the Master container.

When Trusted Cards are linked, the card owner forms a trust relationship with another trusted cardholders. The card owner determines what data can be read. The access rights that a card owner provides to another trusted card is stored and configured on the SES platform back-end 810. A separate protected and trusted container 822, 824, 826, and 828 is created for each trusted card user and allows only that user to write to the container and therefore created verifiable and digitally signed records.

All records written to a secure container are published to the SES platform back-end 810. The SES platform determines whether the record must be written to the Cardholder store to form part of the card owner's master data and/or execute a third-party service (like billing, claims, etc.). The SES platform also creates required cryptographic hashes to allow the necessary users to read the data from the Cardholder master container and sign all records that have been entered with the SES platform key. The SES platform maintains the cryptographic hashes of all containers to detect tampering with any of the containers but will not store any data other than transaction data that must be audited.

The containers also contain images and media files that are signed by the trusted user to verify authenticity. Media files will not be copied into the Master container and will always be referenced from the Master container using a media index. This ensures that the flash memory space is not wasted and that media files can be accessed quickly through the index. The index can be maintained in a database.

In one embodiment, the W3C XAdES standard is used to form the containers and store the documents in a standards-based format. Each record or transaction that is enacted will result in a document that will form the record for that transaction. The standard provides the basis for digitally signing each document and ensuring non-repudiation of the document transaction.

Data on the trusted card are stored encrypted using a symmetric key generated by both the SES key generator and a client key generator. Additional data are stored with the encrypted metadata in order to identify the different records as shown in FIG. 12A.

For each record in the data table there will be at least one corresponding record in the key store table. These records are linked using the unique transaction id. The record in the key store contains the encryption type, proxy certificate fingerprint and the encrypted symmetric key that was used to encrypt the transaction in the data table. The encryption type field is used to know which encryption to use when decrypting the symmetric key. The proxy certificate fingerprint is the public key fingerprint of the entity that can decrypt the symmetric key. The symmetric key is encrypted using the proxy's public key and stored in the key store. Only an entity with that specific public/private key can decrypt the symmetric key which in turn will be used for decrypting the transaction.

If the card owner wants to give an entity (proxy) access to a specific record the system uses the card owner's public key to decrypt the saved symmetric key. This symmetric key is then be encrypted using the proxy's public key. A new record will be added to the key store with the transaction id and the relevant details of the proxy as well as the newly encrypted symmetric key. When the proxy reads the data he can use his own private key to decrypt the transaction and thus he can read the transaction.

This configuration provides the basis for digitally signing each document and ensuring non-repudiation of the document transaction. Additional standards such as XAdES for data storage can be applied but are not necessary to achieve digital signing.

With regard to data architecture, the above described solution contains several data sources that must be managed on the trusted card and on the back-end SES platform. The data sources are listed in Table 1 with a short description of each

TABLE 1

| | | SES/Industry | |
|---|---|---|---|
| | | Application | |
| Data Source | Description | specific | Location |
| Card Application Records | Data records and media stored | Application | Card |
| Database | specifically by the Industry | | |
| (Structured/Unstructured) | Application, such as personal | | |
| | data, images, videos. | | |
| Card Application | Metadata for all encrypted | SES | Card |
| Transaction Database | data and a pointer to the data | | |
| | record or data item (if | | |
| | unstructured) | | |
| Card Application Key | Stores encrypted symmetric | SES | Card |
| Store | keys that act as pointers to the | | |
| | Card Application Transaction | | |
| | Database. | | |
| Card Application Master | Master Data that is used by | Application | Card |
| Database | the Industry Application on the | | |
| | Trusted Card (e.g. | | |
| | ICD10/Tariff, etc.) | | |
| SES Integration | Transactions that are | Application | SES |
| Transaction Database | generated by SES and routed | | |
| | to 3^{rd} party providers for | | |
| | processing. | | |
| SES Transaction Metadata | Records all metadata for | SES | SES |
| Database | transactions that are processed | | |
| | through SES. | | |
| SES Master Database | Master Data database stored | SES | SES |
| | at SES and drives business | | |
| | rules, integration and acts as a | | |
| | source for synchronizing the | | |
| | Card Application Master | | |
| | Database. | | |
| SES Audit Database | An audit database that records | SES | SES |
| | all auditable data items and | | |
| | stores them for further | | |
| | investigation. | | |
| SES Synchronization | Versions/Release Packages. | SES | SES |
| Database | May also retain interim data | | |
| | for master data | | |
| | synchronization. | | |
| SES Certificate Database | Database for private and | SES | SES |
| | public key certificate pairs | | |
| | and any | | |
| SES Security Database | Stores all users, groups, roles | SES | SES |
| | and privileges. It also stores | | |
| | the trusted relationships | | |
| | (paired cards) with their | | |
| | relevant privileges. | | |

FIG. 12B is a diagram illustrating one embodiment of a trusted card logical data model which illustrates the relationships between the various logical data sources contained on the Trusted Card 120. The example data used is that of a Personal Health Record (PHR). The sources depicted in FIG. 12B include a card application key store, a card application transaction database, a card application records database, and a card application master database.

The card application key store and contains records of certificates that are capable of decrypting the protected card application records. The certificate thumbprint is used to uniquely identify the certificate, and thus the card user, that can decrypt the data. The key store record is related to the transaction by the unique TransId.

The card application transaction database includes records that contain metadata for a specific entry into the card application records database. The metadata stored in the transaction data store are used for identifying, filtering and searching of entries in the card application records database without decrypting the records. Metadata that must be searchable from the application must be promoted to the metadata level. Every record in the card applications records database will be linked to a transaction by using the unique TransId.

The card application records database contains the content records for any structured or unstructured data that is stored on the trusted card. The content is encrypted and linked to the card application transaction database via the TransId.

The card application master database contains master data that is used to run the card application. Master data references can be stored as part of records stored in the card application records database. This database is synchronized with master data from SES.

The key data elements are described in Table 2 which follows:

TABLE 2

| Data Source | Data Element | Description |
|---|---|---|
| Card Application Key Store | TransId | Transaction id of the record. Linked to |
| | | the Transaction table. |
| Card Application Key | Encryption Type | Type of encryption used to encrypt the |
| Store | | record. |
| Card Application Key | Proxy Certificate | Thumbprint of the certificate used to |
| Store | Thumbprint | encrypt the symmetric key. This is to |
| | | identify the certificate. |
| Card Application Key | Encrypted | This contains the symmetric key used |
| Store | Symmetric Key | to encrypt the record content. The |
| | | symmetric key is encrypted using the |
| | | proxy entity's certificate. |
| Card Application | Id | Unique transaction id used to identify |
| Transaction Database | | transactions and links to PHR data |
| | | records. |
| Card Application | Type | This is used to filtering and searching |
| Transaction Database | | of PHR records. It contains the |
| | | transaction type e.g. Doctor Visit. |
| Card Application | DateTime | Date and time at which the transaction |
| Transaction Database | | occurred |
| Card Application | MetaData | Metadata used to search and filter the |
| Transaction Database | | records. |
| Card Application | Signed Hash | Hash of the transaction signed by SES. |
| Transaction Database | | This will be used to identify if a record |
| | | has been tampered with. |
| Card Application | Encrypted? | Boolean to identify if the transaction is |
| Transaction Database | | encrypted. |
| Card Application | TransId | Transaction id of the PHR transaction. |
| Records Database | | Linked to the Transaction table. |
| Card Application | Data Record | Content relevant to the specific PHR |
| Record Database | | element. This will be elaborated on in |
| | | the database design phase. |
| Card Application | Data Record | Content relevant to the specific Meta |
| Master Database | | Data element. This will be elaborated |
| | | on in the database design phase. |

FIG. 12C depicts the relationships between the various SES data elements that are used for authentication and authorization and is referred to as a SES security database logical data model. These elements form part of the SES security service that is maintained centrally. The elements depicted in FIG. 12C include cards, user cards, links, roles, and privileges. A card is a record containing the details of a physical card. A user card can be a patient card or a doctor (provider card. The patient card represents the records of a patient and is linked to roles associated with the specific user type. The doctor card includes the record of a doctor and is linked to roles associated to the specific user type. Links are the specific privileges that are granted to a proxy user. These can be via roles or specific privileges. Roles are a hierarchal grouping of privileges and are linked to a user type. Privileges are the lowest level functions a user can perform on the card application.

The relationships between these logical data elements, in the medical context utilized herein are described. With respect to cards, and user cards, every card is associated to a user. A user can be registered to more than one card. A card can only be registered to one or no users. With respect to patient and doctor, when a trusted relationship has been setup between cards, and therefore the users that holds the card, a set of privileges will be associated to the link. These privileges determine the functions that can be performed on the patient card by the proxy user. The privileges are inherited from the privileges assigned to roles of the proxy user. The patient card holder can then alter these privileges if required.

The Physical Trusted Card

The above-described secure USB business and/or personal ID card (trusted card 120) bears full-color external text and/or graphics, including a unique two- or three-dimensional barcode applied by an image transfer printed by modified large-format digital printer. The transfer is applied by a selective release transfer process in which the adhesive layer attaches only in the image area to the target surface and the adhesive layer is peeled off except for the image area which is left attached to the target surface. This produces a high-resolution four color graphic inclusive of white, which is used to apply the three-dimensional barcodes at potential volumes of upward of 200,000 per day. It is envisioned that the USB business and/or personal ID card may contain any combination of: the name or logo of the company; office address, individual name, telephone numbers, fax, and email address. The opposite side of the card could contain pertinent information concerning its use or other promotion materials. This card could be used as an identity card, driver license, insurance card, financial services card, credit card, prescription drug cards, Medicaid card, and Internet transaction card. The outside of the card could contain: a bar code, including two and three dimensional codes; a photograph; and other biometric information that can be printed on the outside of the card.

As such the present disclosure includes the digitally-printed transfer bearing a digitally created image that can be heat and/or pressure-applied to a target surface, and a method for transferring the digitally created images from film to a target surface via digital printing and heat and/or pressure transfer. The process employs a modified digital printer (converted from a double sided fusing printing process to a back fusing web printing process) to create an image on transfer film subsequently coated with adhesive that is then heat and/or pressure-applied to a substrate to yield a high-resolution four color graphic with white. The basic fabrication steps comprise 1) coating one side of a disposable base transfer film (or carrier) with a releasable coating; 2) digitally printing one or more images overtop the base transfer film in reverse-image format; and 3) applying an adhesive coating over the image.

The result is a roll of pre-printed transfers. In accordance with the present method for transferring the digitally created images from film to a target surface, 4) the base transfer film is indexed over a target substrate (image down and showing through the film) and heat and/or pressure is applied to the base transfer film to adhere the image to the target substrate. The base transfer film is peeled from the target substrate and is discarded, leaving a high-resolution color graphic image on the target substrate.

The method is described in detail below with various options, and in all cases the method is unique because when the image is transferred there is “selective release”, meaning that there is transfer to the target substrate only in a pre-determined area (most commonly in the specific area of the print image, though for some applications it may be desirable to have a release that includes non-imaged areas), despite the adhesive coating which may, and indeed, usually exceeds the borders of the printed image. This selective release improves the quality of the transfer because there are no unsightly borders or margins around the image, and holes and gaps in fairly complex images are not filled in.

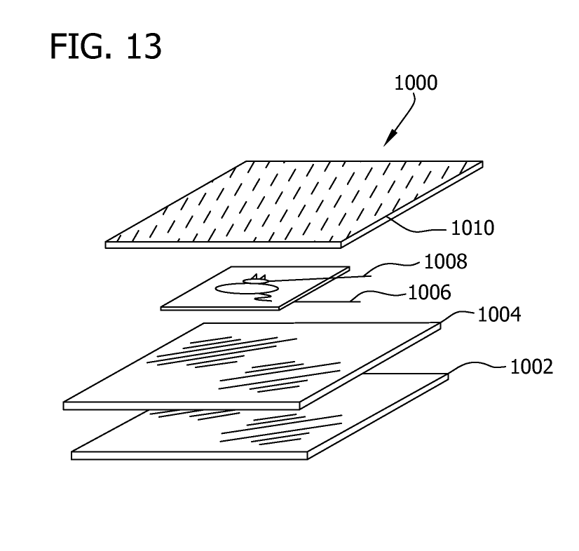

FIG. 13 is an exploded diagram showing the layers of an exemplary image transfer 1000. The image transfer 1000 includes a disposable base transfer film 1002. T his can be any suitable transfer carrier formed of plastic or non-woven material and that is capable of being passed as a web through the production machinery. For example, the presently preferred transfer film 1002 is polyester teraphthlate (PET). In accordance with one optional feature, the transfer film 1002 may be preformed with distinct surface patterns or texture to give the final transfer a textured aesthetic.

An image release layer 1004 is uniformly applied onto the base transfer film 1002. Image release layer 1004 may be, for example, a wax, lacquer, or combination of wax and lacquer, with or without specific additives. The application of the image release layer 1004 may be attained by applying the wax and/or lacquer onto the base transfer film II in individual coats from either solvent or waterborne solutions or suspensions. It is known from experience that the final parameters of the coating can be adapted to any requirement by the changing coating weights, the addition or substitution of resins, waxes and wax solutions, and there are many conventional coating methods that can be used to achieving a desired coat weight. The appearance of the final coating can be full gloss or be matted down to the required level by the addition of matting agents. When applied the release layer 1004 must be uniform, and free from all coating defects and application patterns (except where a coating pattern is an intended aspect). The presently-preferred release layer 1004 comprises a lacquer mixture of commercially available polymethyl methacrylate resin with a commercially available wax suspension (BYK 151 ex-Samual Banner). The ratio of resin to wax is on the order of 80% to 95% resin to 5% to 20% wax. These two components are provided in a 5% to 15% solid solution (depending on method of application) in a butanone and toluene solvent blend (of which toluene is around 10% of the total solvent). The release layer coating is then forced air-dried giving a dry coat weight coat weight of 1.15 to 1.35 grams per square meter.

The image 1006 itself is then digitally printed with a four color graphic (as will be described) on the transfer film 1002 (overtop release layer 1004). The digital printer may employ either electro-ink or dry powder toner, and otherwise conventional print techniques. Preferably, a registration mark is printed at this same time, and when desired the four-color image 1006 (and registration mark) is then overprinted with a white background 1008.

Finally, a pressure and/or heat activated adhesive layer 1010 may be applied evenly over the whole of the web, both where there is image and no image, or may be selectively applied only in the image area. Presently, the adhesive layer 1010 is applied in line directly after the printing step using a 3.5% to 4% solution of commercially available polyamide (Lioseal V 7036 ex-Henkel) in a solvent system, which is predominately Isopropyl alcohol. This solution is then coated onto the image 1006 and/or transfer film 1002 by a wire wound rod at a dry coating weight of 0.2 to 0:3 grams per square meter, the applied coating being forced air-dried.

To then transfer the digitally created image from the transfer film 1002 to a target surface, the base transfer film 1002 is placed on a target substrate and is indexed in position using the index lines (image down and showing through the film). The adhesive layer is then heat and/or pressure-fused to a subject material and the image itself 1006 adheres more strongly to the material than does the image release layer 1004. Thus, when the image transfer film 1006 is applied image-down to a target substrate by application of pressure and/or heat (as will be described), the dried adhesive layer 1010 attaches to the target substrate only in the image 1006 area but is otherwise retained by the transfer film 1004 (“selective release”). To then apply the transfer 1000, the image transfer film 1002 is peeled off the target substrate together with the dried adhesive layer 1010 except for the image area which is left attached to the target substrate by the pressure and/or heat activated adhesive layer 1010. For this to happen, the thickness of the non-printed areas of release layer 1004 and adhesive layer 1010 must be thinner than printed areas containing the release layer 1004, image 1006 and adhesive layer 1010 such that more pressure is exerted where there is image to the target substrate than where there is no image. The characteristics of the image release layer 1006, the adhesive layer 1010 and the image layers 1006, 1008 are selected so as to work with a wide variety of target substrates, including textured and porous materials such as leather to give this selectivity.

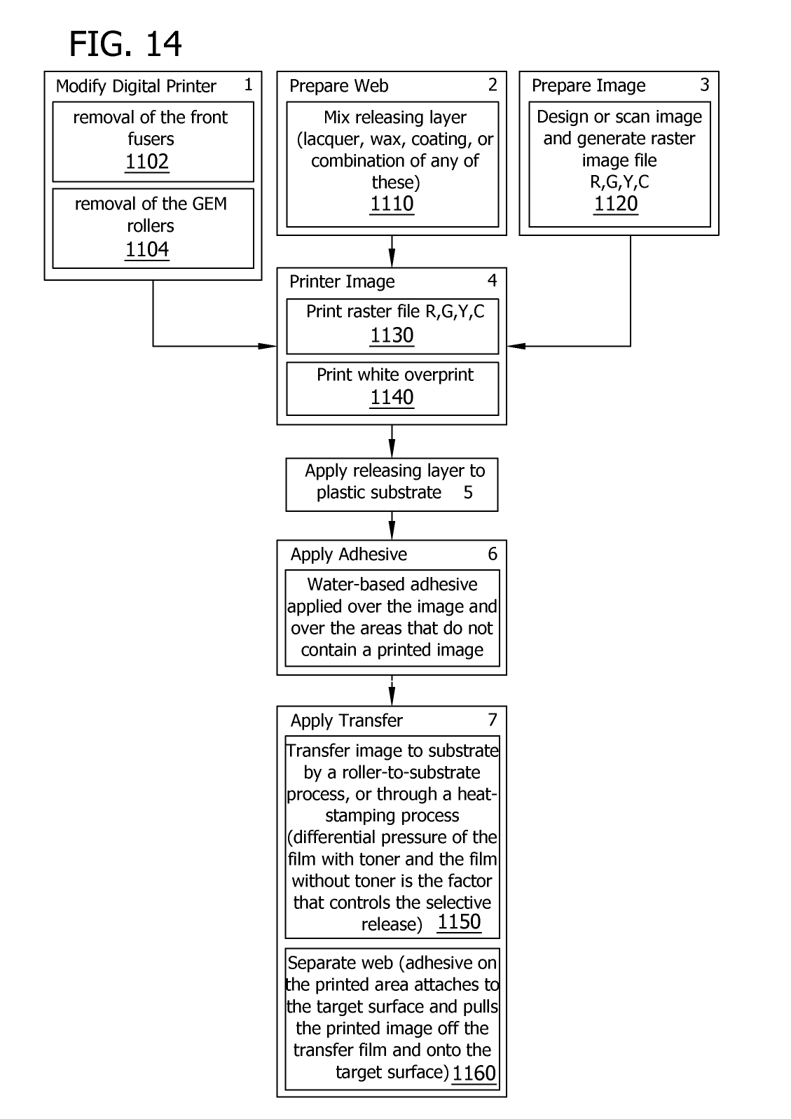

FIG. 14 is a block diagram of all necessary process steps for making and applying the above-described transfer 1000.

Step 1: Modify Digital Printer

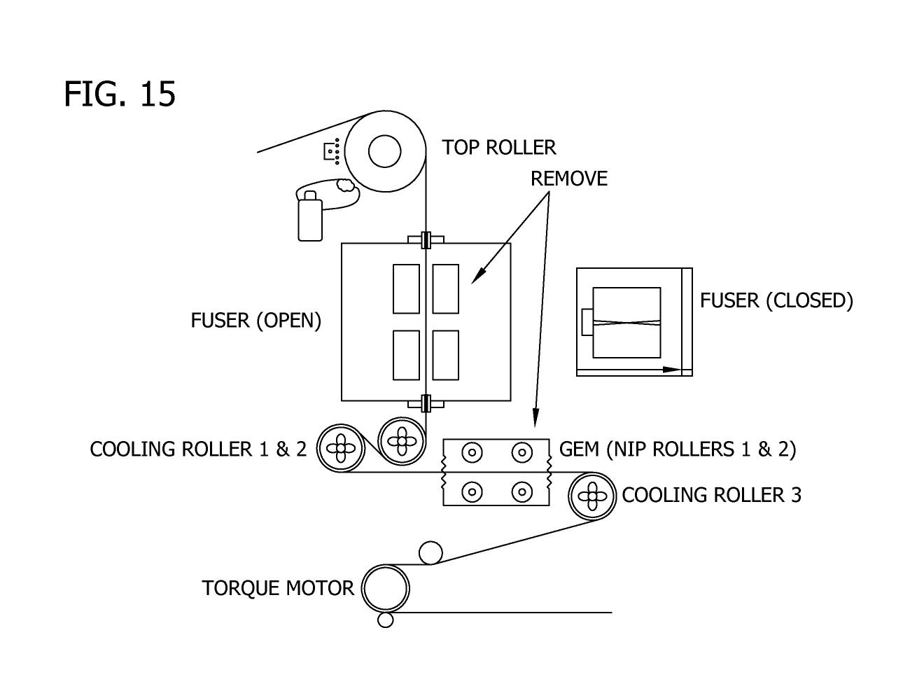

This printer can be any conventional digital printer that uses either Electrolnk™ or dry powder toner, or other conventional print techniques. For example, a Xeikon™ large format digital printer is suitable. This and most other large format digital printers employ heater roller assemblies and fusers generally contained within a protective housing. A toner image is transferred to a sheet or web and is then fixed to the web by heat and/or pressure. Typically the paper is transported in a nip between the fuser and pressure roller, which are rotating. Thermal radiation from a lamp heats the fuser roller, causing the toner on the web to melt and press into—the web fibers. In accordance with one embodiment, the printer is modified to essentially convert it from a front and back fuser system to a back fusing web printing process. The modification initially entails disabling the heaters in the infeed module removal of the front fusers (substep 1102) and removal of the GEM rollers 1104. Specifically, for a Xeikon digital printer, the front fusers and part nos. CNS-1262-01 5208 32D (Gem Roller) would be removed as seen in FIG. 15. In addition, the print color order is changed from the conventional CMYK to KMCY.

Step 2: Prepare Web

The current process uses a plastic web in roll form for the base transfer film 1002 of FIG. 13 and pre-coats this with the release layer 1004 which may be a releasing lacquer, a wax, a release coating, or a combination of any of these as described above. At substep 1110 it is necessary to mix the releasing layer (lacquer, wax, coating, or combination of any of these). The lacquer, wax and release coating are custom-mixed to create the correct release factor for a range of heat and pressure used. A suitable wax release can be mixed with a combined acrylic nitrocellulose overlacquer for this purpose.

If desired, the release layer 1004 may be texturized or mixed with specific additives, such as UV absorbers or biocides, to give the release layer specific properties.

For example, the release layer 1004 may be texturized with a distinct carrier surface pattern (matte or scratch). Since the image is printed onto the release layer 1004 and is then transferred, the net effect is to impart the surface pattern onto the surface of the transfer. Most any texture or pattern that can be made to the surface of the release layer 1004, for example, embossing, etching or addition of a solid component, e.g. silica. In each case this is transferred when it is applied to the target substrate. These changes can be aesthetic for example, matte, brushed effect, geometric pattern, regular pattern or random pattern. The effect can also be subtle such as wording, images or patterns that are only visible with light shining on the surface at a particular angle, thereby serving as a simple security device.

As another example, the release layer 1004 may contain a functional additive that confers a property to the transfer 1000 that is not present in the transfer without the additive. For example the addition of 1% of an anti-microbial additive such the transfer surface as applied to a target will inhibit bacteria. Inorganic, silver-based antimicrobials are generally recognized as safe and are well suited for this purpose.

The addition of a small percentage (less than 10%) of a UV absorber will protect the toner image from degradation in color intensity due to prolonged exposure to direct sunlight.

The addition of a phosphorescent or fluorescent additive will make the transfer “glow” when UV light is shined onto it. This addition can be used in conjunction with the above-described surface pattern, making the effect easier to detect.

Step 3: Prepare Image

The image is designed into a vector image file, or scanned into a raster image file, in both cases using four color CMYK pixilation. As seen at substep 1120, the emblem graphic design may be generated using computer drawing software. This is generally accomplished using graphics programs such as well-known Adobe Illustrator™, Photoshop™, etc. Such software is capable of calculating the image dimensions from the design, and colors are chosen from a selectable palette. Photoshop software developed by Adobe uses a palette technique in which the image data is coded and compressed to a prescribed number of colors (a range of from 256 to 16M colors depending on the selected palette). The image file can be manipulated as desired to resize/rescale, redraw or alter the coloration. The final image is then saved as a CMYK raster image file.

Step 4: Print Image

Given a prepared image, at substep 1130 the image is printed directly from the raster image file and at substep 1140 an additional toner drum of white toner (W) is used to print a white overprint. The process imprints electrostatically charged toner or inkjet images onto the base transfer film 1002. The process prints the desired image, laying on colors in registration patterns in the order Black, Magenta, Cyan, Yellow (KMCY), and finally White, instead of the CMYK patterns that are applied by an unmodified Xeikon. The printing of a white layer of color at substep 1140 is unique to the disclosed embodiments and this improves contrast by filling in blank areas. When working on the design computer white is seen as black. White cannot be seen on the screen. The black image (the part we want to be white) is given a specific reference, for example, pantone. This specific reference number is added as a 5th color that the Xeikon combines with the normal CMYK colors of the design, and yet printing this reference color as white as it has been programmed to do.

Step 5: Apply Release Layer

Next, at step 5, the mixed release layer 1004 is applied to the plastic transfer film 1002. The release layer 1004 is applied over the whole surface of the base transfer film 1002 using a conventional coating machine.

Step 6: Apply Adhesive

At step 6 a water or solvent based adhesive is applied over both the image (with nor without white) and the areas that do not contain a printed image. These areas may include parts of the image that have intentionally been left clear of print for example between numbers, backgrounds to let the substrate be seen through the print, etc. The transfer 1000 is now complete.

Step 7: Apply Finished Transfer 1000

Finally, at step 7, the image transfer 1000 may be applied to a wide variety of materials including rough and/or porous materials such as leather. At substep 1150, the image 1006 may be transferred to the substrate material by a roller-to-substrate process, or through a heat-stamping process, in both cases using conventional presses. In both cases the differential pressure of the transfer film 1002 with toner versus the transfer film 1002 without toner is the factor that controls the selective release according to the described embodiments. More specifically, at substep 1160 the dried adhesive on the printed area of the image 1006 encounters more pressure due to the additional thickness added by the toner, and thus the printed areas of image 1006 attach to the target material. After the transfer film 1002 contacts the target substrate, the transfer film 1002 may be peeled away. The printed image 1006 transfers to the target substrate as the web separates. The adhesive on the printed area attaches to the target surface and pulls the printed image off the transfer film 1002 and onto the target substrate. The process does not leave a “lacquer halo” around the printed images as in conventional transfer processes.

Where a heat-stamping process is used, the stamping press may be used a second time directly onto the transferred image to imbed the printed image into the selected substrate.

This differential pressure is obtained by the difference in thickness between the areas of the film that are imprinted with the image 1006 and areas where there is no image. Although it is imperceptible to the naked eye, the transfer 100 is thicker in the areas where the toner has been applied. The image is transferred selectively through the interaction of the release layer, image and adhesive and the target substrate. The release layer and adhesives being specifically formulated to exploit this differential pressure.

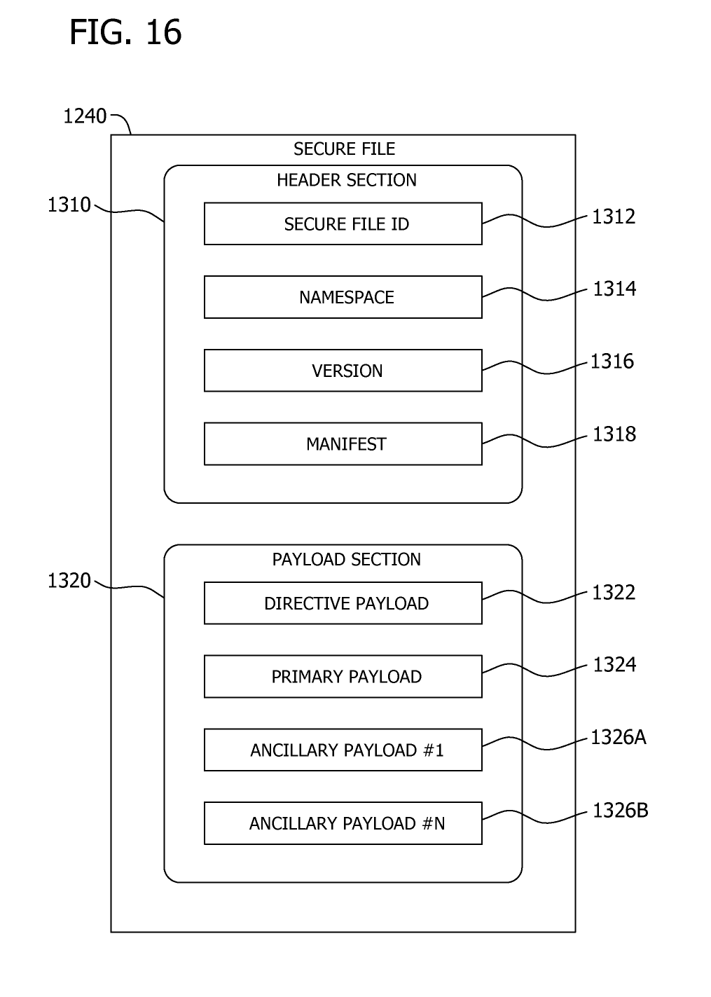

FIGS. 16-23 are provided to describe alternative embodiments for providing the trusted card/secure exchange system whose functionality has been described herein. Specifically, FIG. 16 illustrates a secure file 1240 that could be utilized with the distributed information protection and control system of FIG. 6. For purposes of the following paragraphs, secure file 1240 is equivalent to secure file 390 described with respect to FIG. 6. The secure file 1240 includes a header section 1310 and a payload section 1320. Conceptually, the secure file 1240 is a container in which files are placed for safekeeping, where the header section 1310 contains the information describing how the secure file 1240 is assembled, and the payload section 1320 contains the actual information being protected.

The header section 1310 includes a secure file identification 1312, a security policy namespace 1314, a version 1316, and a manifest 1318. The secure file identification 1312 includes a quasi-unique identifier to identify the secure file 1240 without relying upon any operating system specific attributes (e.g., file name). Conventional techniques to generate a quasi-unique identifier include, for example, generating a sufficiently large pseudo random number which may be used as a quasi-unique identifier; issuing sequentially numbered identifiers from some agreed upon location; and generating identifiers in a relational database.

The security policy namespace 1314 includes an identifier specific to the security policy tinder which the secure file 1240 is being managed. Conventional techniques to assign such an identifier include, for example, using the fully qualified domain name of security policy server 354, expressed as a string of ASCII characters; and the distinguished name (DN) of an LDAP entry within the directory service 352.

The version 1316 identifies the revision level of the format for the secure file 1240. Conventional techniques to identify the revision level include, for example: a pair of numerical values expressing a major and minor revision number; and the URL of a formal extensible markup language (XML) data type definition (DTD) describing the format of the secure file 1240.

The manifest 1318 provides details of the payload section 1320 and includes one or more manifest records 1330, where each manifest record 1330 further describes a payload 1340 present in the payload section 1320. Each manifest record 1330 in the manifest 1318 corresponds to a specific payload 1340 in payload section 1320. For the exemplary secure file 1240, the manifest 1318 includes four manifest records 1330, where the first manifest record 1330 corresponds to the directive payload 1322, the second manifest record 1330 corresponds to the primary payload 1324, the third manifest record 1330 corresponds to the ancillary payload 1326A, and the fourth manifest record 1330 corresponds to the ancillary payload 1326B.

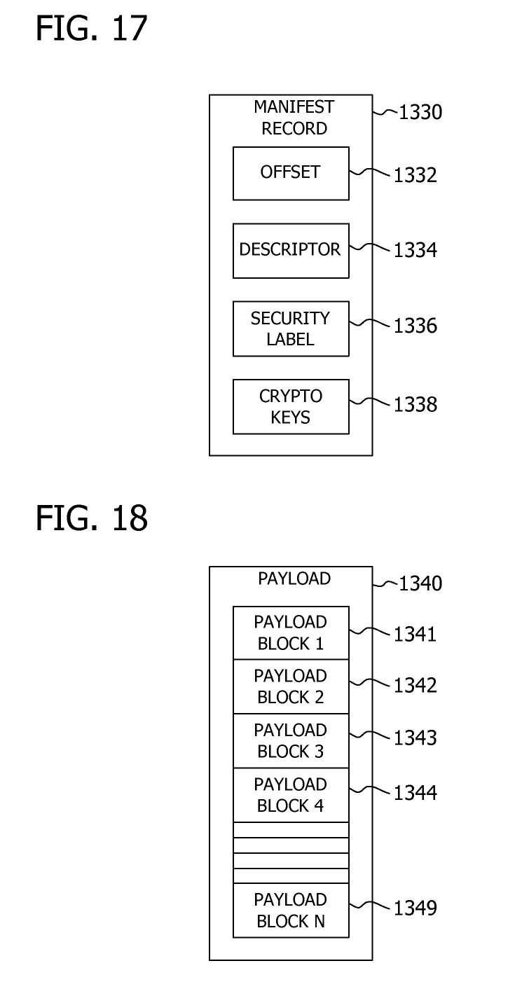

FIG. 17 illustrates a manifest record 1330. There is one manifest record 1330 for each payload 1340 in the payload section 1320 of a secure file 1240. Each manifest record 1330 includes an offset 1332, a descriptor 1334, a security label 1336, and one or more crypto keys 1338.

The offset 1332 includes offset pointers and other bookkeeping attributes useful for randomly accessing individual blocks of information the payload section 1320 associated with the manifest record 1330. Information maintained within offset 1332 may be advantageously used with information maintained within the crypto-keys 1338, thus permitting this same random access to encrypted payloads 1340 in the payload section 1320.

The descriptor 1334 is used to at least differentiate between different types of payloads 1340 in the payload section 1320 (e.g., a directive payload 1322, a primary payload 1324, and an ancillary payload 1326A, 1326B), and may also include additional descriptive information specific to the payload 1340. The descriptor 1334 can include, for example, the same types of file-type information that are conventionally associated with files, or other types of file-system specific information were associated in the file from which the payload 1340 originated at the time when the secure file 1240 was created. Such file-type information can include, for example: a file name, a file extension type, a creation date, size of the file, and a character encoding method (e.g., unicode, utf/8, iso latin 1).

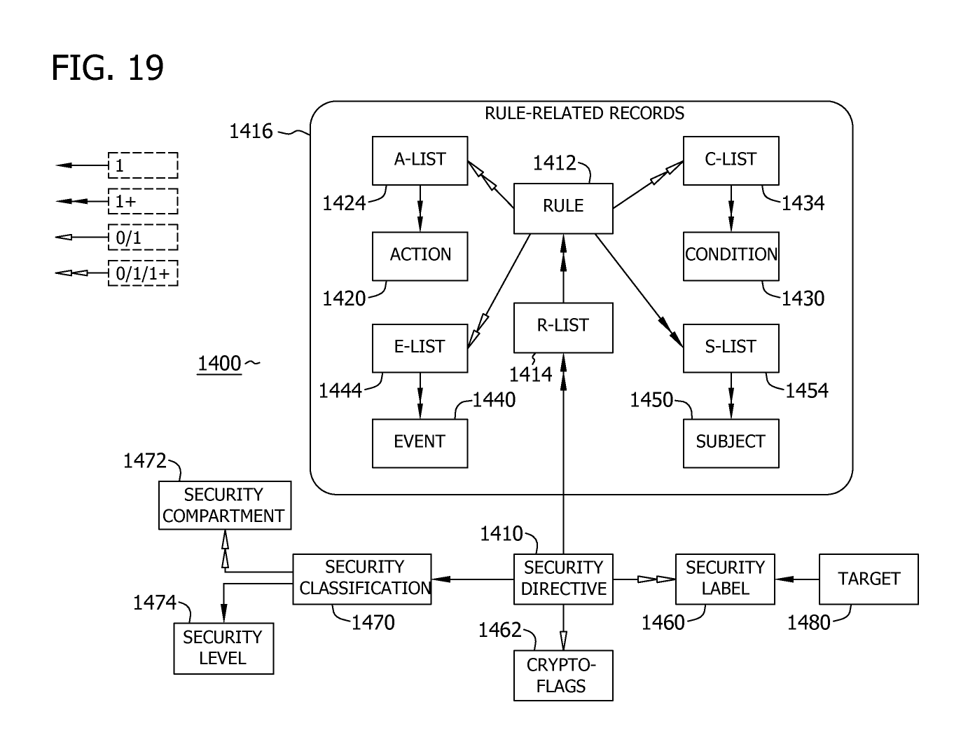

The security label 1336 includes an encoded representation of a security label 1460 (in FIG. 19) associated with the corresponding payload 1340 in the payload section 1320. The security label 1336 can be cryptographically protected (e.g., digitally signed and/or encrypted).

The crypto keys 1338 include the cryptographic information used to encrypt the secure file 1240. Examples of information contained in the crypto keys 1338 include: cipher modes, cipher keys, public keys, private keys, and PKI certificates. In various embodiments, some or all of the cryptographic information may be advantageously stored in other locations (e.g., a smartcard or FIPS-140 type device connected to information system 200), and the crypto keys 1338 contain one or more pointers or references to this remotely stored information. Crypto keys 1338 may themselves also be encrypted and protected, using any number of conventional ways used to protect similar types of cryptographic information.

A frequent problem associated with many prior art cryptographic implementations is the requirement to decrypt the entire cipher text of a file in order to access just a small section of the plaintext. Just as most operating systems permit quasi-random access to a block within a given file, the described embodiments advantageously provide a technique for the enforcement agent 378 to access and decipher any arbitrary payload block (e.g., 1341, 1342, 1343, 1344, or 1349) of a payload 1340 in the payload section 1320 that may be encrypted. More specifically, the use of blocks cipher modes that allow cryptographic operations to be performed on arbitrary blocks within a secure file 1240 is permitted, thus permitting random-access cryptologic operations to the underlying clear text in each payload 1340 within payload section 1320. This capability is the so-called random-access property associated with some block cipher modes. For example, cipher block chaining mode (CBC) ciphers permit parallelizable decryption, thus permitting random-access read operations to a file, and electronic code book (ECB) mode ciphers permit parallelizable encryption and decryption, thus permitting random-access read and write operations to a file.

Referring back to FIG. 16, the payload section 1320 includes zero or more directive payloads 1322, a primary payload 1324, and zero or more ancillary payloads 1326 (illustrated as ancillary payload #11326A, . . . , ancillary payload #N 1326B).

The directive payload 1322 can include a security directive record 1410 (FIG. 19) associated with a security label 1460 (FIG. 19). The security label 1460 can be, but need not be, the security label 1336 associated with the manifest record 1330 of payload 1340. The directive payload 1322 can be cryptographically protected. To facilitate the enforcement of the security policy, the enforcement agent 262 provides the contents of the directive payload 1322 to the security policy broker 384. The security policy broker 384 can obtain information directly from other authoritative sources (for example, the security policy server 354 and/or the directory service 352) to ascertain if the directive payload 1322 remains current, and to verify the accuracy of any digital signature(s) associated with directive payload 1332, if present. The payload section 1320 can include multiple directive payloads 1322 in various embodiments, for example, one directive payload 1332 for primary payload 1324 and all ancillary payloads 1326, one directive payload 1332 corresponding to each primary payload 1324 and ancillary payload 1326, and zero or more directive payloads 332 corresponding to one or more primary payloads 1324 and any ancillary payloads 1326.

The primary payload 1324 contains the exact same information contained in file 394 to be protected and controlled. The primary payload 1324 can also contain information generated by the user to be protected and controlled. The primary payload 1324, as with the directive payload 1322 and ancillary payloads 1326, may be cryptographically protected (e.g., digitally signed and/or encrypted).

The ancillary payloads 1326 contain other types of information associated with the file 394, or other information, to be protected and controlled. Each ancillary payload 1326 is composed of an ordered sequence of bytes, characters, or other atomic elements of storage in a fashion similar to that of the primary payload 1324 and utilizes the same storage semantics dictated by the underlying file system. Ancillary payloads 1326 can also be used to distribute the information to be protected across multiple payloads, thus permitting different security directives to be associated with different sections of the secure file 1240. For example, if a file 394 to be protected is composed of both text and images, the text can be placed in the primary payload 1324 and assigned one security label 1336, and the images can be placed in one or more ancillary payloads 1326 and assigned the same and/or other security labels 1336. By way of example, this flexibility permits the invention to protect the contents of a complex HTML file composed of multiple MIME blocks by distributing each of the MIME blocks into their own ancillary payloads 1326 within the secure file 1240.

Advantageously, this capability could also be used to apply security labels 1336 and security directives to elements of information more granular than that of an entire file 394, allowing each element to be protected and controlled differently. Examples of such information elements include subsections of files, linked or embedded objects within a file, storage allocation within databases (e.g., tables, rows, columns, and cells), or any other addressable element of digital or digitized information. This capability permits, for example, having a single version of a file, but different users having different views of it, based on which elements they were authorized to access.

FIG. 18 illustrates a typical payload 1340 (e.g., a directive payload 1322, a primary payload 1324, or an ancillary payload 1326) in the payload section 1320. Each payload 1340 is an ordered set of logical blocks. For example, the payload 1340 includes payload block 1 1341, payload block 2 1342, payload block 3 1343, payload block 4 1344, and payload block N 1349 as the last logical block.

To ensure ongoing compliance with the security directives associated with the contents of secure file 1240, it is important that the information contained within the secure file 1240 cannot be accessed through some means other than via the enforcement agent and security policy broker. However, it is still be possible to use other programs and utilities to act upon the secure file 1240 as a whole, without explicitly taking action on its contents. For example, secure files 1240 may be backed up to archival media, copied to floppy diskettes, and/or distributed by email.

Cryptography is utilized in one embodiment to maintain the confidentiality and integrity of the information within secure files 1240, while still permitting these secure files 1240 to be handled by the operating system 370. Thus, while a user may still use any “discretionary” abilities afforded to them by their information system 200 and distribute secure files 1240 to others, the information within these secure files 1240 still remains sacrosanct and the cipher text within cannot be successfully be decrypted without proper authorization. Further still, since proper authorization and decryption takes place under the supervision of the enforcement agent and security policy broker, the information contained within this redistributed secure file 1240 remains under the protection and control of the security policy being enforced by the enforcement agent and security policy broker. Any conventional cryptographic techniques can be used to digitally sign and/or encrypt the contents of secure file 1240, or any portion thereof. Examples of conventional encryption techniques include: public key cryptosystems; symmetric key cryptosystems, such as block ciphers and stream ciphers; cryptographic hash algorithms, such as SIIA-1, MDS, and HMAC algorithms; and digital signing and verification. The cryptographic keys are stored and protected using conventional techniques. Examples of conventional cryptographic key techniques include: passwords and passphrases for the protection of cryptographic keys; and FIPS-140 type storage devices.

In various embodiments, any of the data structures used can be encrypted and/or digitally signed. For example, if security label 1336 is digitally signed by the security policy server 354, the security policy broker 384 verifies the validity of this digital signature before attempting to look up the corresponding security directive record 1410.

FIG. 19 illustrates a security directive 1400. The enforcement agent and security policy broker use security directive records 1410 associated with each secure file 1240 to determine how the security of each such secure file 1240 is to be maintained. More specifically, security directive record 1410 is associated with a specific payload 340 within a secure file 1240, and different payloads 1340 may be associated with different security directive records 1410. The security label 1336, 1460 is the mechanism through which a security directive record 1410 is associated with the object it protects. However, in addition to protecting secure files 1240, the embodiments may also be used to protect different types of resources, including both hardware components within the information system (e.g., printer 150, communication interface 154) and software constructs within the information system (e.g., files 130, directories, named-pipes, communications protocols).

Target 1480 identifies a component of the information system 200, and represents any hardware or software element within an information system 200 that the security policy broker has been configured to protect. Each target 1480 has an associated security label 1460, which directs the security policy broker 384 to the security directive record 1410 associated with the target. For example, the target 1480 can identify, for example, a secure file 1240, a communications interface, a printer, optical reader, and a folder, a directory, or other file organization structure within an optical reader.

The security label 1460 is an electronically encoded representation of a humanly readable artifact (e.g., a text string, symbol, glyph, or other marking) which can be made apparent to user 101 in any number of ways. For example, the security label can be made apparent to user 101 by being: shown on the display, rendered on hardcopy by the printer, or captured as part of the name of the secure file 1240 placed in the optical reader. The security label 1460 is not limited to simple text and may include any marking or indicia. This flexibility allows, for example, security labels 1460 to be encoded in different languages, allowing meaningful country-specific word choices; without incurring the administrative overhead of having to maintain a large number of identical security directives.

For targets 1480 that are within secure files 1240, security labels 1460 and security directive records 1410 are used to apply non-discretionary access controls to each payload 1340 contained within the payload section 1320 of secure file 1240. The enforcement agent accessing the specific manifest record 1330 associated with each payload 1340 passes the security label 1336 contained within manifest record 1330 to a security policy broker. The security policy broker is then able to determine the security directive record 1410 associated with that security label 1336 under the current security policy.

The mechanism used to associate a security directive records 1410 with non-file targets varies depending upon the specific architecture of each operating system (or virtual operating system virtual machine), and the manner in which an enforcement agent is configured. For example, UNIX and UNIX-type operating systems represent hardware devices and software constructs as file-like devices (e.g.,/dev,/proc/), and a pseudo-device driver can be used to associate an enforcement agent with these components.

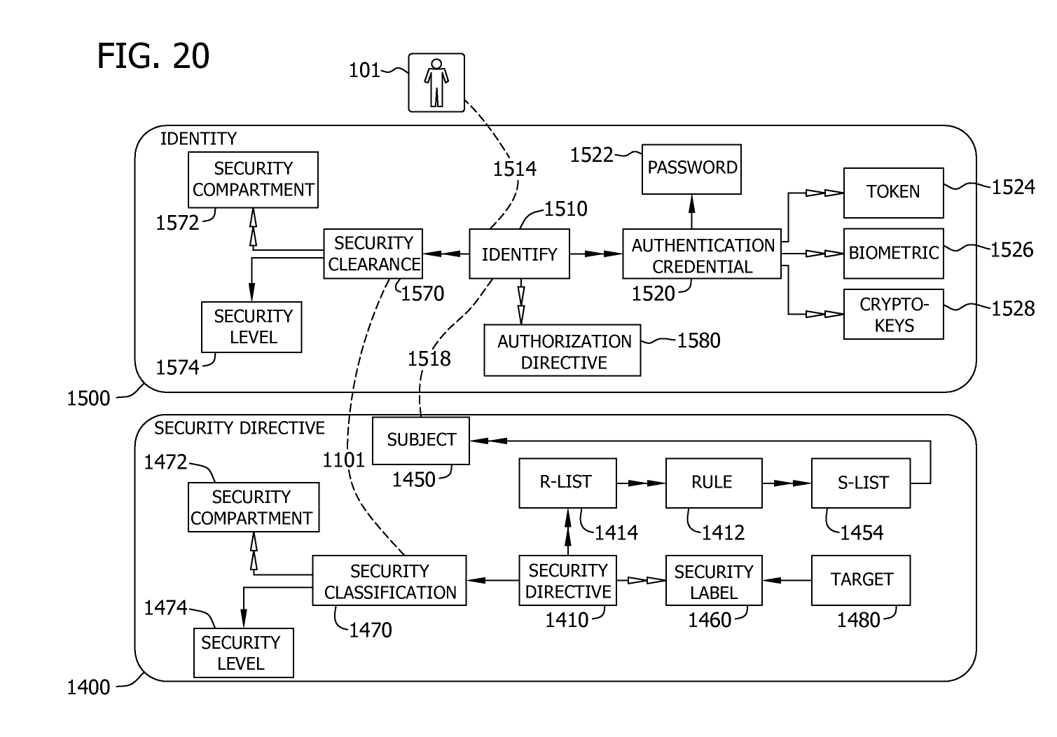

The security directive 1400 is formed as a data structure and the relationships between the components of the data structure are illustrated in FIG. 16. The arrowheads in FIG. 19 (and in FIG. 20) do not refer to directionality, but instead indicate the type of relationships between components. A single black arrowhead (e.g., between security directive record 1410 and security classification record 1470) indicates exactly one, and can be read as: “security directive record 1410 has exactly one security classification 1470.” A double black arrowhead (e.g., between security directive record 1410 and security label 1460) indicates one or more (1+), and can be read as: “security directive record 1410 has one or more security labels 1460.” A double outline arrowhead (e.g., between rule record 1412 and c-list record 1434) indicates zero or more (0+ or 0/1/1+), and can be read as: “rule record 1412 has zero or more c-lists 1434.” A single outline arrowhead (e.g., between security directive record 1410 and crypto-flags 1462) indicates zero or exactly one (0/1), and can be read as: “security directive record 1410 has zero or one crypto-flags 1462.”

The logical structure of security directive 1400 begins with the security directive record 1410. The various components of the security directive record 1410 can be referred to as records, although other types of data structures and/or formats can be used to implement this logical structure. For example, the logical structure can be implemented using: arrays, linked lists, data sets, b-trees, queues, and lookup tables.

The security directive record 1410 includes one or more rule-related records 1416, a security classification 1470, zero or more security labels 1460, and zero or one crypto-flags 1462. In other embodiments, instead of having both rule-related records 1416 and a security classification 1470, the security directive record 1410 includes one or more rules-related records 1416 and zero or one security classification 1470, or the security directive record 1410 includes zero or more rule-related records 1416, and a security classification 1470.

The rule-related records 1416 include rules that specify how specific actions and conditions are to be handled with respect to the payload 1340 of a secure file 1240 or other target 1480. Any specified conditions must be satisfied before the application is permitted to perform the specified actions. The rule-related records 1416 include r-list records 1414, rule records 1412, a-list records 1424, c-list records 1434, e-list records 1444, s-list records 1454, action records 1420, condition records 1430, event records 1440, and subject records 1450. Each r-list record 1414 includes one or more rule records 1412. Each rule record 1412 includes zero or more a-list records 1424, zero or more c-list records 1434, zero or more e-list records 1444, and at least one s-list record 1454. Each a-list record 1424 includes at least one action record 1420. Each c-list record 1434 includes at least one condition record 1430. Each e-list record 1444 includes at least one event record 1440. Each s-list record 1454 includes at least one subject record 1450.

The rule-related records 1416 include elements referred to as lists, although other types of data structures and/or formats can be used, for example: arrays, linked lists, data sets, b-trees, queues, and lookup tables.

An action record 1420 comprises any activity performed upon the target 1480 of a security directive record 1410. Examples of actions include: opening and closing a payload 1340 of a secure file 1240; making changes to a payload 1340 of a secure file 1240; making a copy of a payload 1340 of a secure file 1240; making a copy of secure file 1240; deleting a secure file 1240; creating a new secure file 1240; printing a payload 1340 of a secure file 1240; printing a screen capture of display 148 while payload 1340 is visible; unauthorized printing of unsecured files to secured printers; transmitting a copy of a secure file 1240 to another party through email or the network 330; transmitting unsecured files through a secured communications device to a destination outside of the local area network; and placing copies of unsecured files on secured diskette drive.

A condition record 1430 comprises any condition or conditional expression that can be measured or evaluated within the context of the information system 200. Examples of conditions include: restrictions on time of day a payload 1340 within a secure file 1240 can be accessed; the availability of a low-latency network connection to the network 190; and bow the identity of a subject in the subject record 1450 must be authenticated.

An event record 1440 (also referred to as an auditing event record) comprises an auditing-related activity associated with a given rule and causes an audit record to be written, depending upon the specifics of the event. Examples of events include: the creation of auditable records when a given rule is evaluated by the security policy broker (i.e., a rule-evaluated event); when an action associated with a given rule is permitted to take place by the security policy broker (i.e., a rule-allowed event); and when a given action associated with a given action is not permitted to take place by the security policy broker (i.e., a rule-denied event).

A subject record 1450 comprises one or more users and/or processes against which the rule record 1412 applies. Examples of a subject record include: Joe B. Smith; and all employees.

Different types of action records 1420, condition records 1430, and event records 1440 can be applicable to different types of secure files 1240, depending on, for example, the nature of the secure file 1240, the format of the secure file 1240, the application being used to manipulate the secure file 1240, or how the secure file 1240 is used. For example, a secure file 1240 having auditory information can have an associated action record 1420 of “play-through-speaker,” while this same action has no meaningful semantic equivalent for a secure file 1240 having JPEG information. Conversely, a secure file 1240 having JPEG information can have an associated condition record 1430 of “black-and-while image,” while this same condition has no meaningful semantic equivalent for a secure file 1240 having auditory information.

The security classification record 1470 advantageously allows security classification of large numbers of targets 1480 into compartments or categories in a manner that simplifies the management of the protections afforded by the invention. The security classification record 1470 is a category or compartment to which confidential information is assigned to denote the degree of damage that unauthorized disclosure might cause. Depending upon the specific security policy, any number of such categories can be defined. The security classification record 1470 includes a security level 1474 and zero or more security compartments 1472.

The security level 1474 comprises a hierarchical representation of the relative confidentiality associated with the security directive 1400, as exemplified by the policy table 398 of FIG. 7. One or more security levels can be determined for the security policy. For example, a company or government agency may desire that information be hierarchically organized according three security levels of classified, secret, and top-secret. In some embodiments, security level 1474 can be represented as a numerical value, where lower-valued security levels represent less confidential information, and higher-valued security levels represent more confidential information.

Each security compartment 1472 is a non-hierarchical attribute of the security directive 1400. The security compartments 1472 permit further compartmentalization (which may also be referred to as compartmentalization) for a security level 1474. Compartmentalization provides a technique to add additional security-related categories that allow information to be managed and shared between users only to the extent required for the performance of their individually assigned duties. In other words, compartmentalization may be conceptually thought of as a mechanism of dividing information into categories so that some users may be granted permission to access information in one category, and not another. The use of compartmentalization techniques provides a mechanism for implementing the “need to know” principle common to many secure environments.

The crypto-flags 1462 specify what cryptographic techniques, if any, are associated with the security directive record 1410. If no cryptographic techniques are to be used, the crypto-flags may indicate this condition, or the crypto-flags may be omitted. The crypto-flags 1462 dictate the type of cryptography, if any, that the security policy requires for target 1480. Examples of crypto-flags 1462 include, specific algorithms that can or must be used, allowed cryptographic key lengths, specific requirements for crypto-key storage (e.g., only use FIP-140 type device), and other crypto-related requirements or specifications. The crypto-flags 1462 do not necessarily include a specific cryptographic state, such as an actual cryptographic cipher key but specify the mandated cryptographic techniques.

The data structure of the security directive 1400 can be stored in a variety of locations, including, for example, the policy server 354, the directory service 352, the policy broker cache 392, and a secure file 1240. In most cases, however, the canonical copy of any given security directive record 1410 associated with security directive 1400 is maintained by the security policy server 354 with copies of these records temporarily stored in other locations for the convenience of processing without always requiring a networked connection to the policy server 354.

For example, a copy of the rule-related records 1416 associated with the security directive record 1410 can be part of the directive payload 1322 of the secure file 1240. The rule-related records 1416 can then be loaded and temporarily maintained within the policy broker cache 392 In another embodiment, the rule-related records 1416 can be retrieved as needed from the policy server 354. In another embodiment, a portion of the rule-related records 1416 can be stored as part of the directive payload 1322 of the secure file 1240, and another portion of the rule-related records 1416 can be retrieved as needed from the policy server 354. By requiring retrieval from the policy server 354, the security policy can be updated for secure files 1240 that have previously been distributed to information systems.

In other circumstances, for example for non-file targets 1480, the security directive record 1410 associated with a target 1480 may be implicitly specified as part of the initialization of the security policy broker 384 for the information system 200.

The security directive 1400 can be dynamic. Any of the components of the security directive 1400 can be modified in any way, at any time, by an authorized party or process, and the resulting changes are honored by all subsequent enforcement decisions rendered by the security policy broker 384. For example, if the rules-related records 1416 are modified, upon retrieving the updated security directive record 1410, security policy broker 384 determines policy for targets 1480 associated with security label 1460 according to the modification. If a large number of secure files 1240 have the same security label 1460, all of the secure files 1240 are protected and controlled according to the modified rules of the security directive 1400.

FIG. 20 illustrates an identity 1500 and its relationship to a user 101 and a security directive 1400. The security directive 400 of FIG. 20 is the same as the security directive 1400 of FIG. 19 but is not depicted with all components for the sake of clarity.

The identity 1500 can be associated with a user 101. Examples of a user include: a person or persons; a role or position; an automated process (e.g., a software daemon, agent, or process); a physical automated agent (e.g., as a robot or an unmanned aerial vehicle); “batch-type” programs that run with other periodic interaction with real persons; various system services which run in process context specific (e.g., “mail daemon” running under the pseudo-identity of “mail”); and programs the run on behalf of the system itself (e.g., “telnet” or “sshd”).

The identities 1500 are stored within the security policy server 354 and/or the directory service 352. The identity 1500 specifies the manner by which the security policy broker can authenticate user 101 and the security clearance that user 101 is authorized to hold. An identity 1500 is created for user 101 by a competent authority. The relationship between the user 101 and the identity 1500 is illustrated with a user-identity relationship 1514. The user-identity relationship 1514 is verified via the authentication credentials 1520. Any number of prior art authentication methods and protocols can be utilized to validate and verify the identity 1500 of user 101, and thus validate the user-identity relationship 1514.

The logical structure of identity 1500 begins with the identity record 1510, and the relationships between the components of the data structure are illustrated using the same relationship notations used in FIG. 5. The various components of the identity record 1510 can be referred to as records, although other types of data structures and/or formats can be used to implement this logical structure. For example, the logical structure can be implemented with: arrays, linked lists, data sets, b-trees, queues, and lookup tables.

The identity 1510 includes one or more authentication credentials 1520, one or more security clearances 1570, and zero or more authorization directives 1580.

Each authentication credential 1520 includes a password 1522, zero or more token 1524, zero or more biometric 1526, and zero or more crypto-keys 1528. In other embodiments, the authentication credential 1520 can includes at least one of a password 1522, a token 1524, a biometric 1526, and crypto-keys 1528, or any combination of them. Other prior art identity verification techniques can also be employed.

The password 1522 is a shared secret, known to both the authentication identification system 340 and the user 101. The password 1522 can be a conventional text string (e.g., alphanumeric) or can be any information type determined by the user 101 as secret information to obtain access to the information system 200. Other embodiments may utilize any type of secret information that can be shared between user 101 and the security policy server 354 and readily provided by user 101 when requested.

The token 1524 contains information specific to the hardware authentication token permitted to be used to authenticate the identity of user 101. Examples of the token 1524 include: the type of hardware authentication protocol being used, the location of the authentication identification system 340 to be used, and other types of hardware-specific authentication information that may necessary.

The biometric 1526 contains information specific to the biometric authentication device permitted to be used to authenticate the identity of user 101. Examples of the biometric 1526 include: the type of hardware authentication protocol being used; the location of the authentication identification system 340 to be used; and other types of biometric hardware-specific authentication information that may necessary.

The crypto-keys 1528 contain cryptologic information necessary to authenticate the identity of user 101 based on one or more cryptographic keys. For example, if PKI-based authentication is being used, crypto-keys may contain the public key of user 101 signed by a recognized certificate authority.

All of the authentication credentials 1520, including password 1522, token 1524, biometric 1526, and crypto-keys 1528 are based on well known and well established prior art authentication techniques and protocols. Different embodiments may implement these various authentication credential records 1520 in different ways. In some embodiments, the security policy broker may also rely upon any authentication mechanisms provided as part of the operating system 370 in information system 200.

Each clearance record 1570 provides the security clearance authority given to the user 101. Each classification record 1570 includes a security level 1574 and zero or more security compartments 1572. The security clearance is a property associated with users, and the security classification is a property associated with targets. Thus, the security compartments 1572 and the security level 1574 of the identity record 1510 mirror the security compartments 1472 and the security level 1474, respectively, in the security directive record 1410.

The authorization directive 1580 constrains what protections and controls user 101 may apply to information. The authorization directive 1580 is used to apply non-discretionary controls that user 101 may be mandated to apply with regards to targets 1480 of security directives 1400. The authorization directive 1580 specifies what elements of the security policy (e.g., security labels 1460 and security directives records 1410) must and/or may be applied by user 101. Each authorization directive 1580 has the same form as a security directive record 1410, can contain all of the information contained in a security directive record 1410, and further specifies the circumstances and conditions under which the included security directive record 1410 applies.

To determine if the user 101 can perform the requested action to a secure file 1240 (or other target 1480), the security policy broker 384 performs a clearance-classification check 1516 and an identity-subject check 1518. To perform the clearance-classification check 1516, the security clearances 1570 of the identity record 1510 and the security classification 1470 of the security directive record 1410 are compared. More specifically, the security compartments 1572 and the security compartments 1472 are compared, and the security level 1574 and the security level 1474 are compared. To pass the clearance-classification check 1516, the security clearances 1570 of the identity record 1510 must dominate (e.g., via the Bell-LaPadula domination rule) the security classification 1470 of the security directive record 1410.

For this embodiment, to pass the clearance-classification check 1516, the security compartments 1572 must include (or be as large as) the security compartments 1472, and the security level 1574 must be at least as great as the security level 1574. To perform the identity-subject check 1518, the subject 1450 associated with the security directive record 1410 is used. The security policy broker authenticates the identity 1500 of user 101 using one or more of the authentication credentials 1520 associated with the identity record 1510. Based on the strength of the results from the identity-subject check 1514, the security policy broker ascertains if user 101 satisfies the rule 1412. The identity-subject check 1518 is performed when a subject record 1450 is present in the security directive record 1410.

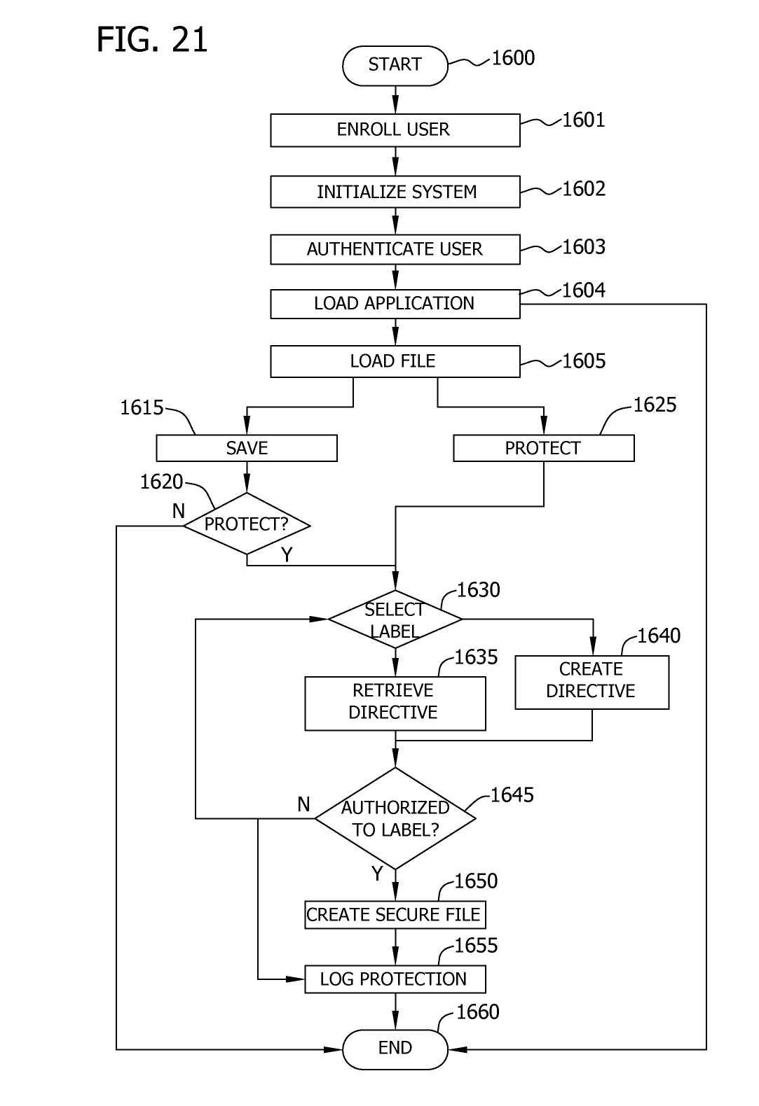

FIG. 21 illustrates a flowchart for creating a secure file 1240 in relation to the described system embodiments. In block 1601, the user 101 is enrolled in the distributed information protection and control system. An identity record 1510 is created by/for the user 101 and stored in directory service 352.

The creation of the identity record 1510 may require additional identity records 1510, a subset of such records, and/or appending additional data to existing records in the directory service 352. In block 1602, the user 101 initializes the information system 200. As part of the information system 200 initialization, the enforcement agent 379 can be associated with operating system shell 382 in application process 380. Additionally, the security policy broker can be initiated to work with enforcement agent 379.

In block 1603, the user 101 is authenticated. The information system 200 matches the user 101 with the identity 1500 and associated identity records 1510. The matching is accomplished with the authentication credentials 1520. The user 101 may be required to reply correctly to authentication challenges by the information system 200. If the user 101 provides the appropriate response(s) based on the authentication credentials 1520, the user 101 is matched with the identity 1500 and associated identity records 1510. In other embodiments, the matching can occur using any conventional techniques. For example, the information system can match the user 101 based on authentication techniques implemented by the operating system 370. Once authenticated, the information system 200 matches the user 101 with identity 1500, and this user-identity relationship is illustrated with the dotted line 1514.

In block 1604, an application is loaded. The user 101 starts up the application 374 within the application process 376. In some embodiments, the invention is in either an active state or an inactive state. For the active state, when the operating system 370 loads application program 374 into non-persistent storage 310, enforcement agent 378 is associated with the application process 376. The enforcement agent 379 associated with the operating system shell 382 monitors the application processes that the operating system shell 382 loads into the non-persistent storage 370. When the operating system shell 382 loads the application process 114C into the non-persistent storage 370, the enforcement agent 378 assigns the enforcement agent 378 to the application process (transforming it to application process 376). For the inactive state, enforcement agent 379 does not assign enforcement agent 379 to application process, in which case secure files 1240 can neither be created nor accessed by application 374 in application process 114C. In other embodiments, various actions within this flow could cause enforcement agent 378 to be assigned to application process 114C.

In block 1605, user 101 loads a file 394 using the application 374. Loading a file 394 can include, for example: creating content; opening an existing file 394; and manipulating the application 374 (e.g., a file manager), which does not open and load a file 394 in the same manner as an application normally used to create and manipulate that type of file 394, but which may take certain actions on the file 394.

In block 1615, the user 101 requests to save the file. Enforcement agent 378 intercepts the resulting data-saving request made by the application process to the operating system 370.

In block 1620, the security policy broker determines, based upon the authorization directive 1580, that the user 101 must protect the file 394 and proceed on to block 1630. If authorization directive 1580 does not require that user 101 protect file 394 or if an authorization directive 1580 does not exist, the user 101 has an option to choose whether to protect the file 394. If the user 101 chooses not to protect the file 394, the flow ends at block 1660, and the application 374 conventionally saves the file 394.

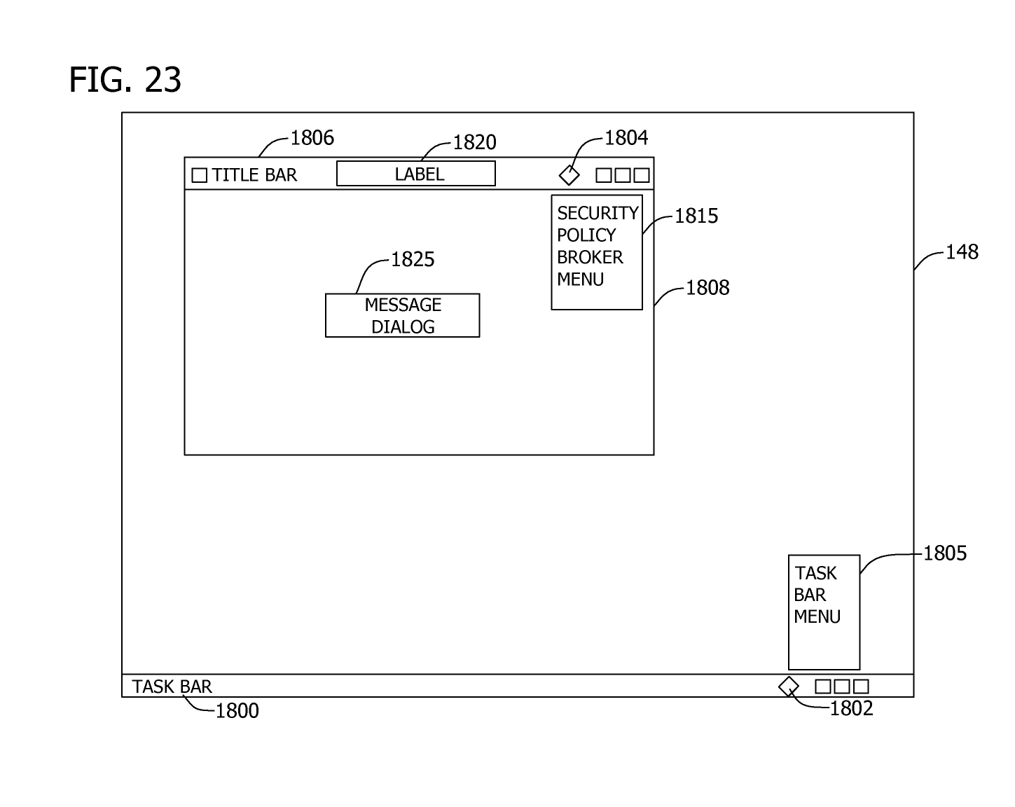

In block 1625, the user 101 requests to protect the file. In some embodiments, this request can originate from the user 101 selecting this action via the title bar icon 1804 (FIG. 23). In other embodiments, this request can be initiated through a separate application program or utility.

In block 1630, user 101 selects a security label 1460 to be associated with the secure file. The security label 1460 is assigned as security label 1336 with the manifest record(s) 1330 of the payload(s) 1340 within which the information contained in file 394 is to be stored. If the user 101 selects to assign a previously defined security label 1460, flow proceeds to block 1635. If the user 101 selects to create a new security directive 1400, flow proceeds to block 1640. Only the security labels 1460 that the user 101 is authorized to assign (including the option to create a new security label 1460), as specified in authorization directive 1580, are offered to the user 101 for selection in block 1630.

In block 1635, the security policy broker 384 retrieves the security directive record 1410 corresponding to the selected security label 1460. The security policy broker 384 can retrieve security directive records 1410 from, for example: the policy broker cache 392 and/or the security policy server 354.

In block 1640, user 101 creates a new security directive 1400. Creating a new security directive 1400 entails creating a security directive record 1410.

In block 1645, the security policy broker 384 validates that the user 101 is authorized to apply the selected security label 1460 as the security label 1336 of the manifest record 1330 for the secure file 1240. If user 101 created a new security directive in block 1640, the new security directive is validated. The validation can include verification of the authentication credentials 1520, if required by security directive record 1410. If user 101 is authorized to apply security label 1460, flow proceeds to block 1650. If the user 101 is not authorized to apply the selected security label, flow returns back to block 1630 or continues to block 1655. If, at block 1620, the user 101 was required to protect the file, but user 101 does not select an authorized security label 1460, user 101 is unable to save the file 394 as secure file 1240. In some embodiments, if in active state, user 101 is prohibited from saving file 394.

In block 1650, the enforcement agent 378 generates the secure file 1240, with file 394 becoming the primary payload 1324, and applies the cryptographic techniques as required by the crypto-flags 1462 of the security directive record 1410. The manifest record 1330 of primary payload 1322 contains security label 1336, as selected via blocks 1630, 1635, 1640, and 1645. The security policy broker 384 can require the user 101 to present authentication credentials 1520 to perform acts of cryptographically signing one or more parts of the secure file 1240. The enforcement agent 378 and the security policy broker 384 can communicate with the directory service 352 to determine various identity information related to potential recipients of the file 394, such as identity group resolution, contact details, and crypto-keys. If desired, enforcement agent 378 can securely delete file 394 at step 650.

In block 1655, if required, the security policy broker 384 logs the creation of the new secure file 1240 to the audit server 350. If, at block 1645, user 101 was denied authorization to apply desired security label, security policy broker 384 may log the attempted security label to audit server 350. Logging may be required by the security directive record 1410 associated with the selected security label 1336, as specified within the e-list 1444.

In block 1660 the flow ends, when the user 101 closes the file 394, or when the user 101 closes the file 394 without saving or protecting the file 394. In another embodiment, secure file 1240 may not be physically created in an optical reader until user 101 chooses to save file 394.

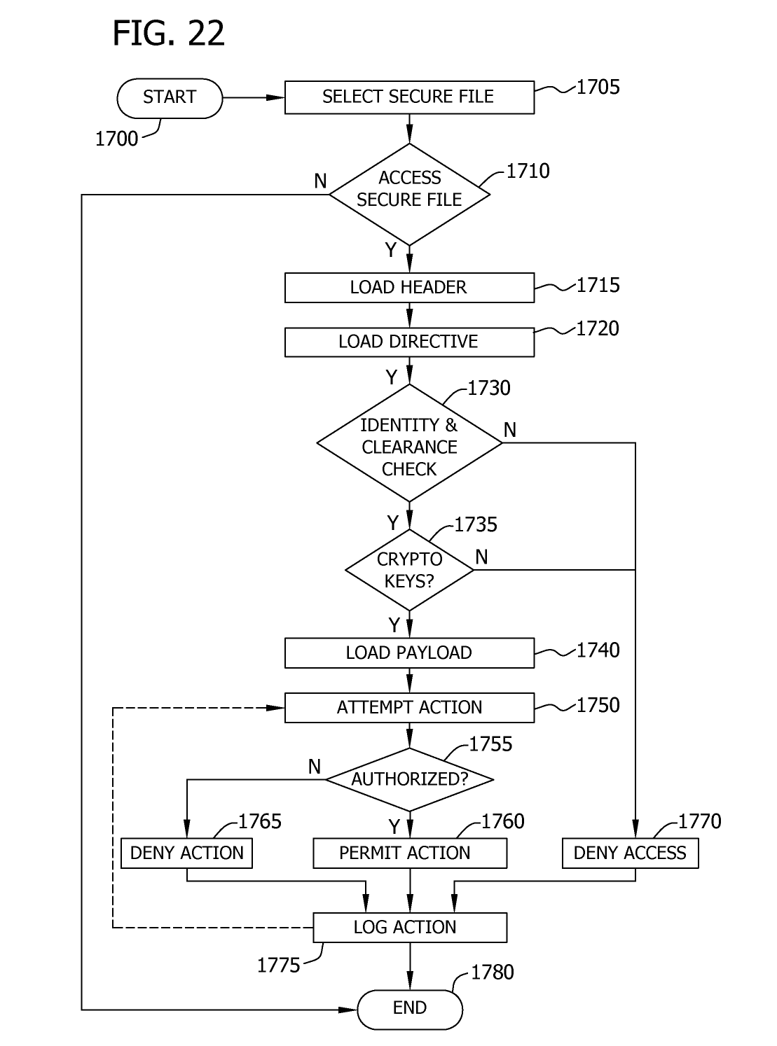

FIG. 22 illustrates a flow chart for accessing a secure file 1240. In block 1700, the information system 1240 is running properly, and blocks 1601-1604 have been performed.

In block 1705, the user 101 requests to access a secure file 1240 via application 374 in application process 376. Enforcement agent 378 intercepts the request made to the operating system 370 by the application process 376 accessing the secure file 1240.

In block 1710, the enforcement agent 378 determines if the selected secure file 1240 can be accessed. The enforcement agent 378 checks the user-identity relationship 1514 using the authentication credentials 1520. If the user 101 passes the check, the secure file 1240 is accessed, and flow proceeds to block 1715. If the enforcement agent 378 and security policy broker 384 are not available, the operating system 370 can start the enforcement agent 378 and the security policy broker 384. If the enforcement agent 378 or the security policy broker 384 cannot be found or started, or if user 101 fails the check (i.e., cannot provide the required authentication credentials 1520 to validate the user-identity relationship 1514), flow proceeds to and ends at block 1780, and the user 101 cannot access the secure file 1240.

In block 1715, the enforcement agent 378 provides the security policy broker 384 with header section 1310 of the secure file 1240.

In block 1720, the security policy broker 384 obtains the security directive record 1410 associated with the security label 1336 for the primary payload 1324. The security directive record 1410 can be contained, for example, within the directive payload 1322 of the secure file 1240, within the policy broker cache 392, and/or retrieved from the security policy server 354. If the security directive record 1410 is located within the directive payload 1322, the enforcement agent 378 forwards the security directive record 1410 to the security policy broker 384. In other embodiments, the enforcement agent 378 can provide callback functions to the security policy broker 384 to retrieve the directive payload 1322.

In block 1730, the security policy broker 384 performs a clearance-classification check 1516 and an identity-subject check 1518. To perform the checks, the security policy broker 384 accesses the security classification record 1470 and the subject records 1450 for the security directive record 1410. As discussed above, the clearance-classification check 1516 is performed using the security clearance records 1570 of the identity record 1510 associated the user 101 and the security classification records 1470 of the security directive record 1410 associated with the security label 1336. As discussed above, the identity-subject check 1518 is performed using the identity record 1510 and the subject record 1450. If user 101 passes, flow passes to block 1735. If user 101 fails either the clearance-classification check 1516 or the identity-subject check 1518, user 101 is denied access to the payload 1340 of secure file 1240, and flow proceeds to block 1770.

In block 1735, the enforcement agent 378 determines whether the crypto-keys 1338 from the manifest record 1330 corresponding to the payload(s) 1340 being accessed within the secure tile 1240 can be accessed. The crypto-keys 1338 of the secure file are accessed via the crypto-keys 1528 for the identity record 1510. Crypto-keys 1338 may be required in order to decrypt a payload 1340, but crypto-keys 1338 may also be encrypted. In various embodiments, various mechanisms may be employed to provide enforcement agent 378 with access to crypto-keys 1338 to decrypt payload 1340 of secure file 1240. For example, enforcement agent 378 may communicate with to have crypto-keys 1338 decrypted and re-encrypted in such a manner that crypto-keys 1528 are able to access crypto-keys 1338. As another example, enforcement agent 378 may retrieve crypto-keys 1338, which are stored on security policy server 354 rather than within manifest record 1333. As a further example, payload 1340 may not be encrypted. If the crypto-keys 1528 for the identity record 1510 decrypt crypto-keys 1338, flow proceeds to block 1740. If the crypto-keys 1528 cannot decrypt crypto-keys 1338, user 101 is not permitted access to payload 1340, and the flow proceeds to block 1770.

In block 1740, the enforcement agent 378 loads one or more payloads 1340 from the payload section 1320 of the secure file 1240 into non-persistent storage associated with application process 376, provided that user 101 has the required authorization to access the desired payload blocks 1341, 1342, 1343, etc. It is possible that different payloads 1340 (e.g., primary payload 1324 and each ancillary payload 1326) have different security labels 1336 and, hence, different associated security directive records 1410, such that user 101 may be authorized to access one payload 1340 but not another. Any encrypted blocks can be decrypted by the enforcement agent 378 using the accessed crypto-keys 1338. Thus, application 374 within application process 376 is able to reference primary payload 324, just as if it were the original file 394.

In block 1750, the user 101 requests an action on the information in a payload 1340 of the secure file 1240. The enforcement agent 378 intercepts the request from the application 374 in application process 376 to the operating system 370.

In block 1755, the security policy broker 384 evaluates the requested action by checking rule-related records 1416 of the security directive records 1410 to determine if the user 101 is permitted to perform the requested action. Additionally, as an option, the security policy broker 384 can again verify the user-identity relationship 1514. For example, the user 101 can be required to provide and/or revalidate authentication credentials 1520 prior to being authorized for the action.

If the rule-related records 1416 of the security directive records 1410 has action records 1420, the security policy broker 384 notifies the enforcement agent 378 that the user 101 is authorized for and/or prohibited from the actions of the action records 1420. If rule-related records 1416 has condition records 1430, the security policy broker 384 determines if the condition records 1430 are satisfied, and notifies the enforcement agent 378 whether or not the association action should be permitted. If the action is permitted, flow proceeds to block 1760; otherwise if the action is not permitted, flow proceeds to block 1765.

In block 1760, user 101 is authorized, and the security policy broker 384 notifies the enforcement agent 378 that the user 101 can continue with the request. Enforcement agent 378 passes the request made by application 374 to the operating system 370.

In block 1765, user 101 is not authorized, and the security policy broker 384 notifies the enforcement agent 378 that the user 101 cannot continue with the request. The enforcement agent 378 prevents the action from occurring by not permitting the intercepted request made by the application process 376 to proceed to the operating system 370, and providing an appropriate response to the application 374 within application process 376. In other embodiments, this response may emulate operating system request-return values. In other embodiments, this response may include request-return values. The enforcement agent 378 can also present an error message 1825 (see FIG. 23) to the user 101 via the display 148.

In block 1770, the user 101 is denied access to the contents of secure file 1240, as a result of decisions made in blocks 1730 or 1735.

In block 1775, the result of previous block steps 1760, 1765, and 1770 are audited, if required by security directive records 1410. If the security directive record 1410 has event records 1440, the security policy broker 384 and/or the enforcement agent 378 supplies a record audit of the events to the audit server 350. Such audit logs may, for example, contain information such as: the secure file identifier 1312 of the secure file 1240; the identity record 1510 of the user 101; identification of the information system 200; the security label 1460; the application 116; the action attempted; the conditions, relating to condition records 1430; and the success or failure of the requested action. In other embodiments, the enforcement agent 378 can access the audit server 350 periodically, non-periodically and/or “on demand” when an event occurs. In some embodiments, auditable events may be temporarily stored in the enforcement agent cache 268 by enforcement agent 378, and in the policy broker cache 392 by the security policy broker 384, prior to their being transmitted to audit server 350.

As long as the user 101 continues to access secure file 1240, flow proceeds from block 1775 to block 1750. The enforcement agent 262 continues to intercept requested actions, and the security policy broker 384 continues to intercept these actions in the manner so described (blocks 1750-1775). Any additional files created in persistent storage by application 374 that are associated with the contents of secure file 1240 (e.g., temporary files, earlier revisions of the file, and backups of the file) are stored either within enforcement agent cache 396 or as other secure files. If the crypto-flags record 1462 of security directive record 1410 specifies that such information is to be encrypted, all such additional and/or temporary files are encrypted appropriately.

The presence of the invention in the information system 200 can be indicated to the user I/O in a variety of ways (e.g., visual and/or audio). For example, for operating systems 370 with a graphical user interface (“GUI”), such as Microsoft Windows or X-Windows, the presence can be shown visually, and user 101 can be provided with various GUI elements for interacting with the invention. Sound, and other acoustic indications, can also be used to facilitate user interaction in a manner appropriate to the operating system and user-interface. FIG. 23 illustrates an exemplary user interface for the display 148 of the information system 200. As an example, if the operating system 370 is Microsoft Windows, a task bar icon 1802 can be displayed within the task bar 1800 as a visual GUI-based indication of the presence of the invention. This task bar icon 1802 can also provide pictorial representations of the state of the enforcement agents 379, 378 running within the application process 376, 380. The user may “click on” or otherwise select this task bar icon 1802 to further reveal a task bar menu with additional choices. With the menu, the user 101 can, for example: change the state of existing enforcement agents; change the state of all enforcement agents; and access other command and control functions provided. The task bar icon 1802 and task bar menu 1805 may be managed by the security policy broker 384 or by an independent software process created solely to provide these user-interface constructs.

Continuing with this example, if an enforcement agent is assigned to an application process having GUI elements, a title bar icon 1804 in the title bar 1806 in the window 1808 for the application process can be provided. The title bar icon 1804 indicates whether the information displayed in window 1808 is contained in a secure file 1240, and displays the associated security label 1460 (i.e., determined by the security label 1336 associated with the manifest record 1330 of the payload 1340 containing the displayed information) as application window label 1820. If information is being displayed from multiple payloads (e.g., both primary and ancillary payloads), the label 1820 of title bar 1806 of the application window 1808 is updated appropriately. If an application process has multiple application windows 1808, each title bar icon 1804 and application window label 1820 will reflect the security label associated with the information specific to that window.

The title bar icon 1804 of window 1808 can further be selected to reveal a security policy broker menu 1815. For example, the user 101 can, if authorized: convert a file 394 to a secure file 1240; view currently authorized actions on the payload 1320 of secure file 1240; and modify security directive records 1410. Selecting one or more of these options may cause the security policy broker 384 to launch additional dialogs for user input and/or output, as required by the information being manipulated. Within some application processes, such as a file manager, menu 1815 may be appended to a context menu, often associated with a secondary mouse button click, such that user 101 may select a file 394 and display security policy broker menu 1815.

Other informational messages 1825 may be displayed as needed, in a fashion common to GUI display, by the enforcement agent or security policy broker 384.

In some embodiments, the graphical elements of the invention (e.g., title bar icon 1804, application window label 1820, menu 1815, and message 1825) are implemented using conventional GUI constructs provided by the operating system 370 that are outside of the direct control of application 116 displaying information within window 1808 (e.g., within the window manager itself, and not the application). Thus, the graphical elements associated with the invention are unapparent to and exist outside the knowledge and control of application 374.

In general, an operating system graphical user interface (e.g., the desktop in Microsoft Windows) is used for the operating system 370, and an application graphical user interface (e.g., a window in Microsoft Windows) is used for an application 374. The operating system graphical user interface and/or the application graphical user interface can be adorned with additional elements to identify the enforcement agent and/or the security policy broker 384. Further, a task bar icon 1802 or equivalent of the operating system graphical user interface and/or a title bar icon 1804 or equivalent of the application graphical user interface can be used to identify the enforcement agent and/or the security policy broker 384.

Other embodiments for operating systems 370 utilizing a GUI may use similar techniques to allow the user to control and interact with the invention. In other embodiments without a conventional GUI, other exemplary forms of interacting with the user may be used, depending upon the capabilities provided in the operating system.

To illustrate the operation of the invention outside the medical records context, another example is provided. Consider a company that establishes an information classification scheme with five security levels (with values 0 to 4) and four security compartments (called UR, FA, SM, and SM). The five levels, in ascending order of confidentiality, along with their corresponding semantics are: public (level 0), official-use only (level 1), internal-use only (level 2), company confidential (level 3), and restricted (level 4). The four compartments are associate with various aspects of the companies business units: human resources (HR), finance and accounting (FA), sales and marketing (SM), and product development (PD). The company's security directives 1400 stipulate that in the absence of file-specific rules, a user may have read-only access to the payload 1320 of a secure file 1240 only if their individual security clearance level (i.e., security level 1574) is greater than or equal to the classification level (i.e., security level 1474) associated with the information contained in a secure file 1240.

Example users in the company include: Bob, the Vice-President of Sales and Marketing, with a non-compartmentalized security clearance 1570 of “restricted” (level 4), as well as security clearances 1570 of SM-4 and FA-3; Marie, Bob's assistant, with a non-compartmentalized security clearance 1570 of level 2; and Alice, a human resources manager with a non-compartmentalized security clearance 1570 level 3, as well as security clearances 1570 of HR-3 and FA-2.

A security directive 1400 of the company requires that only senior human resources personnel may create and share information related to employee salaries. An increasing number of regulations also require that the company protect personal and private data. The invention implements this security policy to ensure that an employee's salary, which is deemed private, is not released to unauthorized individuals.

To meet this security directive 1400, the company defines security directive record 1410 with a security label 1460, SALARY, which has a security classification record 1470 of HR-3 (i.e., a security level 1474 of 3 and a security compartment 1472 of HR). Additionally, the security directive record 1410 has a security classification record 1470 of HR-3 for actions other than read via an action record 1420. In other words, users with a general clearance record 1570 having a security level 1574 of 3 or higher can only read SALARY labeled secure files, unless the user also has a clearance record 1570 having a security compartment 1572 of HR at a security level 1574 of 3 or higher. Further, the rules 1416 in the security directive record 1410 for SALARY also permit only users who are members of the human resources department identified via a subject record 1450 to label files as SALARY via an action record 1420 and that any denied actions be audited via an event record 1430.

Alice creates a salary report for the company as a secure file 1240 using, for example, Microsoft Excel and selects the security label 1460 for the secure file 1240, which is incorporated as the security label 1336 in the secure file 1240. Alice sends the secure file 1240 with the salary report as an email attachment to a distribution list via, for example, Microsoft Outlook. Bob receives the secure file 1240 and is permitted to open it, since he has a security level 1574 of 4. However, when Bob attempts to print the report or to copy its content to another document, the enforcement agent prevents him from doing so, as he does not have a clearance record of HR-3. Due to the enforcement agent of Marie's information system 200, Marie, who has access to Bob's e-mail, is unable to open the secure file 1240 because she has only a security level of 2. Bob's denied attempt to print the secure file and Marie's denied attempt to read the secure file are captured in the audit logs of the audit server 350 for the company. On the other hand, Tom, another human resources manager with a security clearance record with HR-3 has full control over the salary report in the secure file and may copy, modify, or redistribute the secure file according to the rules in the security directive record 1410 for SALARY.

If an authorized individual determines that Bob should access to the salary report, a variety of techniques can provide Bob with this ability. One option is to give the identity record 1510 of Bob a clearance record 1570 with HR-3, which would allow him full control of the salary report in the secure file 1240 as well additional authorization on other secure files 1240 which include a payload 1320 with a security label 1336 of HR-3. Another option is to add a rule in the security directive record 1410 for SALARY that permits printing by all individuals with a general clearance record 1570 of level 4. Yet another option is to add a rule in the security directive record 1410 for SALARY that allows anyone in the company with the title of Vice-President or above to print secure files having a security label 1336 of SALARY.

If Bob intentionally or unintentionally attempts to forward the secure file 1240 with the salary report to a colleague, Joe, at another company, Joe may not receive the secure file 1240. For example, the rules 1416 of the security directive record 410 for SALARY would likely not allow sharing such information with external entities. If Joe did receive the secure file 1240, Joe is unable to access the salary report. If Joe does not have the invention (i.e., enforcement agent 1262 and security policy broker 384) running on his information system, the received secure file 1240 would be unintelligible to his information system 200. If Joe does have the invention running on his information system 200, it is unlikely that he would have a security level 1574 of 4 for a security clearance record 1570 from Bob's company. Additionally, a hacker who managed to pilfer the secure file 1240 from Alice, Bob, Marie, or Joe would be unable to access the salary report of the secure file without being able to break the encryption and structure of the secure file 1240.

In this example, all users are interacting only with their applications 374, such as Microsoft Excel for manipulating spreadsheets and Microsoft Outlook e-mail client. The users do not need to leave their familiar environments. In Alice's case, an additional step is required to assign the security label 1460 of SALARY to the salary report. She does not need to understand the complexities of the data classification scheme in the company and only needs to know that she must label secure files 1240 containing salary data as SALARY. The recipients, such as Bob and Marie, of the email with attached secure file of the salary report open the attachment in the same manner as all other attachments are opened. If Bob uses a different spreadsheet program than Alice, for example OpenOffice or Microsoft Works, the embodiment behaves in an identical manner and enforces the security directive 1400 of SALARY.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for secure, role-based exchange of information between a client and at least one provider of services to the client, said system comprising:
a client device comprising a memory, said memory including data relating to the client, at least a portion of the data controlled by the client, a user access component, a queuing application, a routing application, and an enforcement agent stored therein;
a central server comprising an authentication method, a queuing application, a routing application, and a roles server running thereon, said central server including the data relating to the client; and
an interface device capable of communications with said central server and capable of communicative coupling with said client device, said system operable to:
upon a communicative coupling between said interface device and said client device, activate said user access component, in conjunction with said authentication method, to ensure that the client is the proper holder of said client device;
said enforcement agent operable with said roles server and user interface input from the client to define and maintain access rights to the data relating to the client for the at least one provider of services to the client, the provider of services to the client having access to said central server, the provider of services able to update said memory of said client device, and the data at said central server, based on the access rights defined by the client and contained within said enforcement agent.

2. A system according to claim 1 wherein said interface device comprises a personal computer.

3. A system according to claim 1 wherein said client device comprises a USB interface operable for connection to said interface device.

4. A system according to claim 1 wherein said enforcement agent interacts with said roles server to enforce any roles defined for the at least one provider of services by restricting access to only the data that is defined as accessible to that provider of services within said enforcement agent.

5. A system according to claim 1 wherein accessibility to the portion of the data relating to the client and stored on the client device is defined by the client via a user interface when said client device is communicatively coupled to a machine hosting the user interface.

6. A system according to claim 1 wherein a portion of the authentication method comprises an electronic key exchanged between said interface device and said central server, the electronic key originating from said client device.

7. A system according to claim 1 wherein the data relating to the patient is encrypted.

8. A system according to claim 1 wherein, based on roles defined by said roles server, at least one of the providers of service to the client is able to update at least some of the data relating to the client within said client device.

9. A system according to claim 8 wherein the updating of the data relating to the client within said client device is written directly to said client device via said interface device.

10. A system according to claim 8 wherein the updating of the data relating to the client within said client device is written to said client device via said interface device through instructions received from said server by said interface device.

11. A system according to claim 8 wherein said central server is configured to queue data to be written to said client device, until said client device is communicatively coupled to said interface device and to said central server.

12. A system according to claim 1 wherein said client device comprises a photograph of the client printed thereon and a barcode, both of which are utilized in authenticating the client to said system.

13. A system according to claim 1 wherein at least a portion of the data relating to the client stored within said client device comprises medical records.

14. A system according to claim 1 wherein said roles server comprises roles for the client and each of the providers of services to the client, said roles server programmed with a time limitation for at least one of the defined roles.

15. A system according to claim 1 wherein said interface device comprises a magnetic strip reader and said client device comprises a magnetic strip, said magnetic strip reader and said magnetic strip utilized in authenticating the client to said system.

16. A system according to claim 1 further comprising at least one provider device capable of interfacing to said interface device, said provider device comprising a memory, said memory including at least a portion of the data relating to the provider, a user access component, and an enforcement agent stored therein.

17. A method for providing controlled access by various providers of services to data related to a client, a portion of the data maintained within a client device, another portion of the data maintained at a central server, the providers of services and the client device communicatively coupled to the central server that includes an authentication method and a roles server running thereon, said method comprising:
authenticating that the holder of the client device is the client using a user access method stored within the client device in conjunction with the authentication method running at the central server;
providing a level of access to the data by the client, the level of access based on a role defined for the client within the roles server, the level of access enforced by an enforcement agent running on the client device; and
providing a level of access to the data for the various providers, the level of access for each provider based on a role defined for each provider within the roles server, the level of access for each provider enforced by an enforcement agent running on the client device, the client capable of defining, within the enforcement agent, at least a portion of the level of access to the data for at least one of the providers.

18. A method according to claim 17 wherein authenticating that the holder of the client device is the client using a user access method comprises exchanging an electronic key between the client device and the central server, the electronic key originating from the client device.

19. A method according to claim 17 wherein providing a level of access to the data for the various providers comprises, based on roles defined by the roles server, allowing at least one of the providers update the data relating to the client within the client device and within the central server.

20. A method according to claim 17 further comprising programming the roles server with a time limitation for at least one of the defined roles stored therein.

21. A method according to claim 17 wherein providing a level of access to the data for the various providers comprises interfacing a provider device to the central server, the provider device including a memory having data relating to the provider, a user access component, and an enforcement agent stored therein.

22. A method according to claim 17 further comprising routing a message from the central server to a third party device for at least one of payment, records update, and records confirmation.

23. A method according to claim 17 further comprising queuing data relating to a partially completed transaction, until conditions are such that the transaction may be completed.

24. A method for securing communications between a portable memory device and a server, said method comprising:
starting a client application when the portable memory device is connected to an interface capable of capable of communications with a server;
establishing a secure channel between the client application and the server;
authenticating a user of the portable memory device by:
encrypting, at the server, a sessionID and sequence number using a public key associated with the portable memory device;
encrypting, the encrypted sessionID and sequence number using a private key associated with the server to form an authentication transaction;
sending, the sessionID and sequence number, encrypted with both the public key and the private key to the client application;
decrypting, with the client application, the authentication transaction with a public key associated with the server;
decrypting, with the client application, the sessionID and sequence number using a private key associated with the portable memory device; and
using the sessionID and sequence number in transactions between the portable memory device and the server.

25. A method according to claim 24 further comprising verifying, with the client application, the public key associated with the server against a certificate authority stored on the portable memory device to determine if the server is a trusted entity.

26. A method according to claim 24 further comprising authorizing, at the server, the public key associated with the portable memory device against a certificate authority stored on the server to establish the portable memory device is a trusted device.

27. A portable device for secure storage of personal records, said portable device comprising:
a physical interface for communicative coupling to an external device; and
a memory accessible via said physical interface, said memory comprising:
a data section operable for storage of the personal records;
a user access component operable to provide an interface to records stored in said data section via the external device; and
a security component, said security component activated upon communicative coupling of said physical interface to an external device, said security component operable with a roles server running external to said portable device to provide restricted access to portions of the personal records to a plurality of authorized users, the accessible portions for such authorized users based on roles for the authorized users as defined within said user access component by a person to whom said portable device has been allocated.

28. A portable device according to claim 27 wherein personal records within said data section are encrypted and digitally signed.

29. A portable device according to claim 27 wherein said user access component comprises a password protection mechanism such that a password has to be entered into the external device prior to access of the personal records.

30. A portable device according to claim 27 further comprising printed material thereon, said printed material useful for verifying that a holder of the portable device is the owner of the device.

31. A portable device according to claim 27 wherein said portable device comprises a body having dimensions substantially similar to a financial transaction card, said device comprising a UBS interface to said memory.

32. A portable memory device according to claim 27 wherein said memory comprises an audit trail describing which authorized users had access to which portion of the personal records.

33. A portable memory device according to claim 27 wherein the personal records are encrypted, the encryption defining a time limited access to the portions of the personal records by authorized users.

34. A method for maintaining personal record data on a portable memory device, said device allocated to a first user, the personal record data relating to the first user, said method comprising:
authenticating the first user;
authenticating that a second user has access to the personal record data;
granting access to the second user, upon authentication, to an application operable to provide a user interface for accessing the personal record data;
allocating a role to the second user, the second user role defined by the first user; and
providing access and update privileges to the second user, to at least a portion of the personal record data relating to the first user, the privileges restricted based on the role allocated to the second user, the restricted privileges and allocated role enforced by an enforcement agent application resident on the portable memory device.

35. A method according to claim 34 wherein authenticating that a second user has access to the personal record data comprises:
verifying a password assigned to the second user is correctly entered into the user interface;
querying the enforcement agent on the portable memory device;
extracting information from the portable memory device that identifies both the portable memory device and the first user; and
validating a relationship between the first user and the second user.

36. A method according to claim 35 wherein verifying a password comprises verifying the password entered into the user interface against a password stored within an embedded application stored within a second portable memory device allocated to the second user.

37. A method according to claim 34 wherein authenticating that a second user has access to the personal record data relating to the first user comprises verifying, at a server, credentials received from an embedded application stored within a second portable memory device allocated to the second user.

38. A method according to claim 34 wherein authenticating the first user comprises at least one of
validation of portable memory device credentials to identify the first user;
portable memory device-based authentication against a set of credentials stored on the portable memory device; and
online authentication against a server-based credential store.
